(19) United States
(12) Patent Application Publication
(10) Pub. No.: US 2005/0180606 A1
(43) Pub. Date: Aug. 18, 2005

(54) Optical sensing apparatus to navigate position and a navigation method thereof

(76) Inventors: Keun-Woo Park, Kyunggi-do (KR); Won-Tae Choi, Kyunggi-do (KR); Kyoung-Joong Min, Kyunggi-do (KR); Byoung-Won Hwang, Kyunggi-do (KR); Kang-ju Kim, Kyunggi-do (KR)

Correspondence Address: GOTTLIEB RACKMAN & REISMAN PC, 270 MADISON AVENUE, 8TH FLOOR, NEW YORK, NY, 100160601, US

(21) Appl. No.: 10/897,211

(22) Filed: Jul. 22, 2004

(30) Foreign Application Priority Data
Feb. 16, 2004 (KR) 2004-10053

(51) Int. Cl. G06K 9/00

(52) U.S. Cl. 382/107

(57) ABSTRACT

An optical sensing apparatus and method includes calculating an accurate motion vector coordinate value of a current preprocessed image by partial-searching a particular coordinate axis corresponding to a predetermined direction determining coefficient, a predetermined speed determining coefficient, and/or a predetermined direction and/or speed determining coefficient according to a history of a motion vector coordinate values with respect to a past preprocessed image, calculating the motion vector coordinate value of a future according to a history of a motion vector coordinate value of the current preprocessed image, and performing a position navigation with respect to current or future preprocessed image.

### CROSS-REFERENCE TO RELATED APPLICATIONS

This application claims the benefit of Korean Patent Application No. 2004-10053 filed with the Korea Industrial Property Office on Feb. 16, 2004, the disclosure of which is incorporated herein by reference.

### BACKGROUND OF THE INVENTION

1. Field of the Invention

The present invention relates to an optical sensing apparatus to navigate a position and a method of navigating a position, and more particularly, to an optical sensing apparatus and a method of calculating a motion vector coordinate value of a current preprocessed image by partial-searching a particular coordinate axis corresponding to a predetermined direction determining coefficient, a predetermined speed determining coefficient, and/or a predetermined direction and/or speed determining coefficient according to a history of motion vector coordinate values, and navigating a precise position by calculating a direction and/or speed determining coefficient with respect to a future preprocessed image according to a history of the motion vector coordinate value.

2. Description of the Related Art

An optical mouse is a computer peripheral indicating a position using a cursor displayed on a computer display apparatus. The optical mouse processes a signal corresponding to a reflected light beam reflected by a bottom surface made of a predetermined material, on which the optical mouse is placed, from light beams emitted from a light emitting diode installed in the optical mouse to detects an amount of a position movement of the optical mouse with respect to X and Y axes of the optical mouse, and causes the cursor to move in X and Y directions through the computer display apparatus according to the detected position movement amount.

The above described optical mouse is normally operated when the optical mouse is placed on a general mouse pad having a very clear pattern and a less reflexibility as shown in FIG. 1A. However, the optical mouse has a problem in that the optical mouse unstably operates when the optical mouse is placed on a bottom surface, such as a yellow gel pad, on which the light beam is scattered (dispersed), as shown in FIG. 1B.

In an effort to solve the above-mentioned problem, there has been used a method of determining a moving direction of the optical mouse by converting into a digital voltage value (ADC) of 4-8 bits incident light beams which are reflected from the bottom surface, on which the optical mouse is placed, and incident to respective pixels of the optical mouse.

However, in the above-described method of controlling the optical mouse, a noise element is included in the digital voltage value (ADC) due to noise generated from an analog circuit and a minute change of the intensity of radiation with respect to the respective pixels. This noise element prevents the optical mouse from effectively determining the direction of the optical mouse.

In another effort to solve the above-mentioned problem, there has been also used a method of determining a moving direction of the optical mouse by converting into the digital voltage value (ADC) of 4-8 bits incident light beams which are reflected from the bottom surface, on which the optical mouse is placed, and incident to respective pixels of the optical mouse as shown in FIGS. 2A and 2B, and by comparing brightness and darkness, which are converted to have predetermined bit values, between the respective pixels to set up as 1 bit value a bit value with respect to the respective pixels.

In the above-described optical mouse, a moving characteristic of the optical mouse in a one direction is improved depending on which surrounding pixel is compared with a current pixel in brightness and dimension. However, the above-described optical mouse has problems in that the moving characteristic of the optical mouse in the one direction deteriorates while the moving characteristic of the optical mouse in the other direction is improved.

### SUMMARY OF THE INVENTION

In order to solve the above and/or other problems, it is an aspect of the present invention to provide an optical sensing apparatus and a method of calculating an accurate motion vector coordinate value (moving coordinate value) of a current or future preprocessed image by partial-searching a particular coordinate axis corresponding to a predetermined direction determining coefficient, a predetermined speed determining coefficient, and/or a predetermined direction and/or speed determining coefficient according to a history of motion vector coordinate values with respect to a past preprocessed image.

Additional aspects and advantages of the invention will be set forth in part n the description which follows and, in part, will be obvious from the description, or may be learned by practice of the invention.

In order to achieve the foregoing and/or other aspects of the present invention, there is provided an optical sensing apparatus to navigate a position, the optical sensing apparatus including an image pixel array having a plurality of pixels to convert light energy into an analog voltage value; an A/D converter unit to the analog voltage value received from respective pixel into a digital voltage value; a preprocessing unit to preprocess the digital voltage value to generate a current preprocessed image constituted of a pixel array having the digital voltage value of a predetermined number of bits; a movement coordinate calculating unit to perform a full search by overlapping a predetermined reference image with an entire area of the current preprocessed image to generate a first motion vector coordinate value, to perform a partial search with respect to the a certain coordinate value corresponding to a predetermined direction determining coefficient to generate a second motion vector coordinate value, to output one of the first and second motion vector coordinate values as a final motion vector coordinate value, and to generate a direction determining coefficient of a future preprocessed image according to a history of the final motion vector coordinate value; and an interface unit to accumulate the final motion vector coordinate value inputted from the movement coordinate calculating unit for a predetermined period of time, and to output the accumulated coordinate value to an external apparatus.

According to another aspect of the present invention, the movement coordinate calculating unit generates the second motion vector coordinate value by performing the partial search with respect to certain coordinate values corresponding to a predetermined speed determining coefficient according to a history of the motion vector coordinate of a past preprocessed image.

According to yet another aspect of the present invention, the movement coordinate calculating unit generates the second motion vector coordinate value by performing the partial search with respect to common coordinate values corresponding to a predetermined speed determining coefficient and the direction determining coefficient according to a history of the motion vector coordinate of a past preprocessed image

In order to achieve the foregoing and/or other aspects of the present invention, there is provided an optical sensing method of navigating a position, the method including extracting a current preprocessed image and a current preprocessed center image in a movement coordinate calculating member; generating a first motion vector coordinate value by performing a full search with respect to the current preprocessed image in the movement coordinate calculating member; generating a second motion vector coordinate value by performing a partial search with respect to the current preprocessed image corresponding to a predetermined direction determined coefficient using a reference image in the movement coordinate calculating member; generating one of the first and second motion vector coordinate values as a final motion vector coordinate value in the movement coordinate calculating member; determining a direction determining coefficient of a future preprocessed image according to a history of the final motion vector coordinate value in the movement coordinate calculating member; and resetting the reference image according to an amount of movement of the final motion vector coordinate value in the movement coordinate calculating member.

### BRIEF DESCRIPTION OF THE DRAWINGS

These an/or other aspects and advantages of the present invention will become apparent and more readily appreciated from the following description of the embodiments, taken in conjunction with the accompanying drawings of which:

FIG. 1A and 1B are views showing a point trajectory of an optical mouse using a general mouse pad type and specific mouse pad type;

FIG. 2A and 2B are views showing a bottom image on which an optical mouse having a one directional characteristic formed by preprocessed is placed;

FIG. 3 is a block diagram showing an optical sensing apparatus to navigate a position according to an embodiment of the present invention;

FIG. 4 is a block diagram showing an image comparing unit to form a moving coordinate unit of the optical sensing apparatus shown in FIG. 3;

FIG. 5 is a view showing a process of full-searching a current preprocessed image in the optical sensing apparatus shown in FIG. 3;

FIG. 6 is a view showing a process of partial-searching a current preprocessed image with respect to an X axis according to a negative (−) direction determining coefficient in the optical sensing apparatus shown in FIG. 3;

FIG. 7 is a view showing a process of partial-searching a current preprocessed image with respect to an X axis according to a positive (+) direction determining coefficient in the optical sensing apparatus shown in FIG. 3;

FIG. 8 is a view showing a process of partial-searching a current preprocessed image with respect to a Y axis according to a positive (+) direction determining coefficient in the optical sensing apparatus shown in FIG. 3;

FIG. 9 is a view showing a process of partial-searching a current preprocessed image with respect to a Y axis according to a negative (−) direction determining coefficient in the optical sensing apparatus shown in FIG. 3;

FIG. 10 is a view showing an internal structure of a motion vector unit to form a movement coordinate calculating unit of the optical sensing apparatus shown in FIG. 3;

FIG. 11 is a flow chart showing a position navigating process using an optical sensing apparatus shown in FIG. 3 to navigate a position according to another embodiment of the present invention;

FIG. 12 is a flow chart showing a process of receiving a current preprocessed image and a current preprocessed center image from a preprocessor unit in a moving coordinate unit of the optical sensing image in the position navigating process shown in FIG. 11;

FIG. 13 is a flow chart showing a process of calculating first motion vector coordinate values (VX1, VY1) in the navigating process shown in FIG. 11;

FIG. 14A is a flow chart showing a process of calculating an X axis motion vector coordinate value VX2 of a second motion vector coordinate value (VX2, VY2) using a partial search according to a predetermined X axis direction determining coefficient in the position navigating process shown in FIG. 11;

FIG. 14B is a flow chart showing a process of calculating an Y axis motion vector coordinate value VY2 of a second motion vector coordinate value (VX2, VY2) using a partial search according to a predetermined Y axis direction determining coefficient in the position navigating process shown in FIG. 11;

FIG. 15 is a flow chart showing a process of calculating a final motion vector coordinate value (VX, VY) of a preprocessed image in the navigating process shown in FIG. 13;

FIG. 16A is a flow chart showing a process of calculating a predetermine X axis direction determining coefficient of a future preprocessed image according to a history of a final X axis vector coordinate value VX in the process shown in FIG. 13;

FIG. 16B is a flow chart showing a process of calculating a predetermine Y axis direction determining coefficient of a future preprocessed image according to a history of a final Y axis vector coordinate value VY in the process shown in FIG. 13;

FIG. 17 is a flow chart showing a process of resetting up a reference image of an X channel and/or Y channel reference unit according to a amount of movement of the final motion vector coordinate value (VX, VY) in the navigating process shown in FIG. 13;

FIG. 18 is a block diagram showing an optical sensing apparatus to navigate a position according to another embodiment of the present invention;

FIG. 19 is a view showing a process of partial-searching a current preprocessed image in an X axis direction according to a low speed determining coefficient in the optical sensing apparatus shown in FIG. 18;

FIG. 20 is a view showing a process of partial-searching a current preprocessed image in an X axis direction according to a high speed determining coefficient in the optical sensing apparatus shown in FIG. 18;

FIG. 21 is a view showing a process of partial-searching a current preprocessed image in an X axis direction according to a middle speed determining coefficient in the optical sensing apparatus shown in FIG. 18;

FIG. 22 is a view showing a process of partial-searching a current preprocessed image in a Y axis direction according to a low speed determining coefficient in the optical sensing apparatus shown in FIG. 18;

FIG. 23 is a view showing a process of partial-searching a current preprocessed image in a Y axis direction according to a high speed determining coefficient in the optical sensing apparatus shown in FIG. 18;

FIG. 24 is a view showing a process of partial-searching a current preprocessed image in a Y axis direction according to a middle speed determining coefficient in the optical sensing apparatus shown in FIG. 18;

FIG. 25 is a block diagram showing a motion vector unit to form a movement coordinate calculating unit of the optical sensing apparatus shown in FIG. 18;

FIG. 26 is a flow chart showing a position navigating process using an optical sensing apparatus shown in FIG. 18 to navigate a position according to another embodiment of the present invention

FIG. 27A is a flow chart showing a process of calculating an X axis motion vector coordinate value VX2 of a second motion vector coordinate value (VX2, VY2) using a partial search according to a predetermined X axis speed determining coefficient in the position navigating process shown in FIG. 26;

FIG. 27B is a flow chart showing a process of calculating an Y axis motion vector coordinate value VY2 of a second motion vector coordinate value (VX2, VY2) using a partial search according to a predetermined Y axis speed determining coefficient in the position navigating process shown in FIG. 26;

FIG. 28 is a flow chart showing a process of calculating a final motion vector coordinate value (VX, VY) of a preprocessed image in the navigating process shown in FIG. 26;

FIG. 29A is a flow chart showing a process of calculating a predetermine X axis direction determining coefficient of a future preprocessed image according to a history of a final X axis vector coordinate value VX in the process shown in FIG. 26;

FIG. 29B is a flow chart showing a process of calculating a predetermine Y axis direction determining coefficient of a future preprocessed image according to a history of a final Y axis vector coordinate value VY in the process shown in FIG. 26;

FIG. 30 is a block diagram showing an optical sensing apparatus to navigate a position according to an embodiment of the present invention;

FIG. 31 is a block diagram showing an image comparing unit to form a moving coordinate unit of the optical sensing apparatus shown in FIG. 30;

FIG. 32 is a flow chart showing a position navigating process using an optical sensing apparatus shown in FIG. 30 to navigate a position according to another embodiment of the present invention

FIGS. 33A and 33B are flow charts showing a process of calculating an X axis motion vector coordinate value VX2 of a second motion vector coordinate value (VX2, VY2) using a partial search according to a predetermined X axis direction and speed determining coefficient in the position navigating process shown in FIG. 32;

FIGS. 34A and 34B are flow charts showing a process of calculating an Y axis motion vector coordinate value VY2 of a second motion vector coordinate value (VX2, VY2) using a partial search according to a predetermined Y axis direction and speed determining coefficient in the position navigating process shown in FIG. 32;

FIG. 35 is a flow chart showing a process of calculating a final motion vector coordinate value (VX, VY) of a preprocessed image in the navigating process shown in FIG. 32; and

FIG. 36 is a flow chart showing a process of calculating a predetermined X axis direction and speed determining coefficient of a future preprocessed image according to a history of a final X axis vector coordinate value VX in the process shown in FIG. 32.

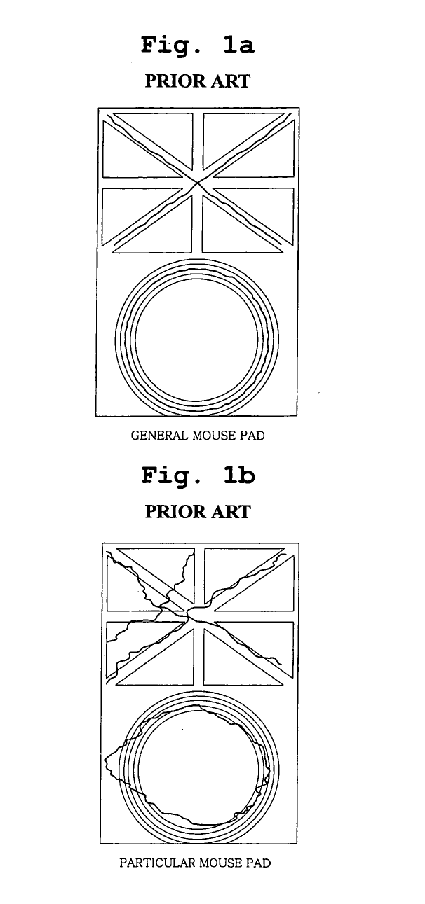

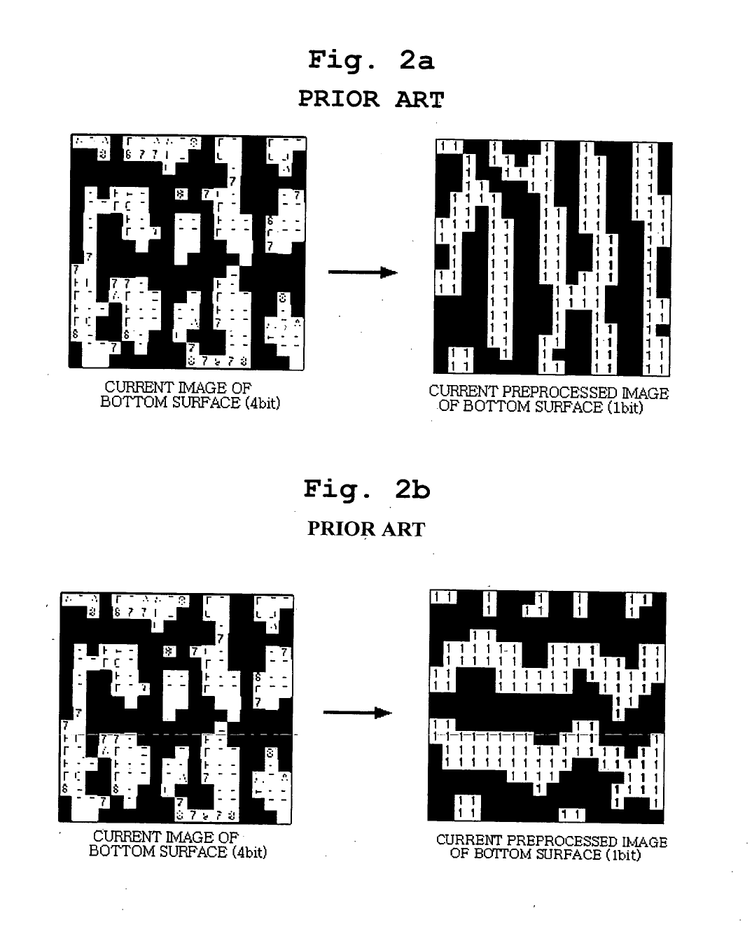

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

Hereinafter, an optical sensing apparatus to navigate a position and a method thereof will be described in detail with reference to the attached drawings.

FIGS. 3 through 17 describe an optical sensing apparatus to navigate a position and-a method using the optical sensing apparatus according to an embodiment of the present invention.

As shown in FIG. 3, the optical sensing apparatus includes an image pixel array 100, A/D converter unit 200, a preprocessing unit 300, a movement coordinate calculating unit 400, and interface unit 500. The image pixel array 100 receives a reflected light beam reflected from a bottom surface, on which an optical mouse is placed, from light beams emitted from a light emitting diode installed in the optical mouse.

In the image pixel array 100, the energy of the received light beam is converted into an analog voltage value according to intensity of the received light beam, and the converted analog voltage value is outputted to the A/D converter unit 200.

Here, the image pixel array 100 may be a structure having an 18×18 pixel array according to an aspect of the present invention. However, the present invention is not limited thereto. That is, the image pixel array 100 may have any of various pixel array structures. The A/D converter unit 200 receives the analog voltage of each pixel, generates a current image of the bottom surface by converting the analog voltage value of the each pixel into a predetermined digital voltage value, for example, 4-8 bits, and outputs the digital voltage value to the preprocessing unit 300.

The preprocessing unit 300 sequentially receives digital voltage values of respective pixels from the A/D converter unit 200 according to a predetermined timing signal and stores the sequentially received digital voltage values in a memory (not shown).

Here, in the memory, the digital voltage values, i.e., 4-8 bits, of the respective pixels of the image pixel array are not simultaneously inputted into the memory from the A/D converter unit 200 but transmitted from the A/D converter unit 200 to the memory through 4-8 lines since the memory has a line buffer structure. The line buffer structure includes 3×18 of a 4-8 bits memory structure.

Accordingly, when the digital voltage values of 4-8 bits are inputted from the A.D converter unit 200 to the memory of the preprocessing unit 300, the previously inputted digital voltage values are shifted to be stored in next memory structures of the memory, and a last digital voltage value stored in a last portion of a line buffer is discarded.

The preprocessing unit 300 preprocesses the digital voltage values, which correspond to a current image of the bottom surface, sequentially inputted from the A/D converter unit 200 to form a current preprocessed image of predetermined bit values, that is, a pixel array having digital voltage values each having at least one bit or more than one bit.

Here, the current preprocessed image has the pixel array having the digital voltage values of two bits according to an aspect of the present invention. However, the present invention is not limited thereto. That is, the digital voltage values may have at least one bit or more than one bit as mentioned above.

Hereinafter, a structure and an operation of the preprocessing unit 300 are described in detail. In a case that the preprocessing unit 300 receives from the A/D converter unit 200 predetermined bits, that is, digital voltage values (ADCs) of the respective pixels converted into the 4-8 bits to form the current image of the bottom surface, as shown in the following table 1, the preprocessing unit 300 adds the digital voltage values of a pixel to be converted into two bit, i.e., ADC22 pixel, and another pixel disposed adjacent to the ADC22 pixel to be converted into two bits, according to the following formulas 1 and 2.

TABLE 1

| | | | | | |
|---|---|---|---|---|---|
| ADC00 | ADC01 | ADC02 | ADC03 | ADC04 | ADC05 |
| ADC10 | ADC11 | ADC12 | ADC13 | ADC14 | ADC15 |
| ADC20 | ADC21 | ADC22 | ADC23 | ADC24 | ADC25 |

A CURRENT_{—}X=ADC02+ADC12+ADC22, BEFORE_{—}X=ADC00+ADC10+ADC20 (1)
CURRENT_{—}Y=ADC20+ADC21+ADC22, BEFORE_{—}Y=ADC00+ADC01+ADC02 (2)

That is, with respect to the ADC 22 pixel, whether a CURRENT_X is greater than BEFORE_X is determined to be converted into a 1 bit to be stored in COMP_X, and whether a CURRENT_Y is greater than BEFORE_Y is determined to be converted into a 1 bit to be stored in COMP_Y.

The preprocessing unit 300 may apply a weight to a pixel disposed adjacent to a current pixel when the digital voltage value of the current pixel sequentially transmitted from the memory is converted into the two bits.

And then, the current value (CURRENT_X or CURRENT_Y) and the before value (BEFORE_X or BEFORE_Y) are compared. The one bit is 1 if the current value is greater than the before value, and the one bit is 0 if the current value is greater than the before value. If the converted value of the two bits is Image_{—}2bit, each case that the Image_{—}2bit represents a vector value (COMP_X, COMP_Y) is as the following table 2.

TABLE 2

| COMP_X | COMP_Y | Image-2bit | Description of the comparison |
|---|---|---|---|
| 0 | 0 | 0 | CURRENT_X is less than |
| | | | BEFORE_X, |
| | | | CURRENT_Y is less than |
| | | | BEFORE_Y |
| 0 | 1 | 1 | CURRENT_X is less than |
| | | | BEFORE_X, |
| | | | CURRENT_Y is greater than |
| | | | BEFORE_Y |
| 1 | 0 | 2 | CURRENT_X is greater than |
| | | | BEFORE_X, CURRENT_Y |
| | | | is less than BEFORE_Y |
| 1 | 1 | 3 | CURRENT_X is greater than |
| | | | BEFORE_X, CURRENT_Y |
| | | | is greater than BEFORE_Y |

That is, the Image-2 bit converted into the two bits is stored in respective pixels having 4-bit digital voltage value inputted from the memory as shown in the following table 3, according to the above described in the table 2.

TABLE 3

| | | | | | |
|---|---|---|---|---|---|
| X | X | X | X | X | X |
| X | X | X | X | X | X |
| X | X | One of 0, 1, | One of 0, 1, | One of 0, 1, | One of 0, 1, |
| | | 2, and 3 | 2, and 3 | 2, and 3 | 2, and 3 |

Here, a portion indicated with “X” is a “don't care portion” which is ignorable since an object, such as CURRENT value and/or BEFORE value, to be calculated does not exist.

The preprocessing unit 300 generates the current preprocessed image formed by predetermined bit values, that is, the digital voltage values of more than one bit, and extracts a current preprocessed center image formed by a predetermined pixel array from the current preprocessed image.

For example, in a case that the current image of the bottom surface is formed with a 18×18 pixel array having a first bit of four bits, the current image of the bottom surface is preprocessed using the formulas 1 and 2 to form the current preprocessed image having a 16×16 pixel array each pixel having a predetermined bit value, such as at least one bit value.

That is, when the current image includes a n×n pixel array, the current preprocessed image of the current image has a (n-2)×(n-2) pixel array structure.

As described above, after the current preprocessed image having the predetermined pixel array structure is formed from the current image, the preprocessing unit 300 extracts the current preprocessed center image having a predetermined pixel array structure, such as a 10×10 pixel array structure, corresponding to a predetermined position of the current preprocessed image, and outputs the current preprocessed center image to the movement coordinate calculating unit 400.

The movement coordinate calculating unit 400 performs a full search to overlap a predetermined reference image with an entire area of the current preprocessed image or performs a partial search on a particular coordinate value corresponding to a predetermined direction determining coefficient to generate a motion vector coordinate value of the current preprocessed image.

Here, the predetermined direction determining coefficient is calculated by a history of the motion vector coordinate value of a past preprocessed image to be used for predicting and/or determining a moving direction of the current preprocessed image.

The movement coordinate calculating unit 400 includes an image comparing unit 410, a motion vector unit 420, an X channel reference unit 430, and a Y channel reference unit 440, as shown in FIG. 3, to calculate (generate) the direction determining coefficient used for determining a moving direction of a future preprocessed image according to a history of the motion vector coordinate value calculated by the partial or full search.

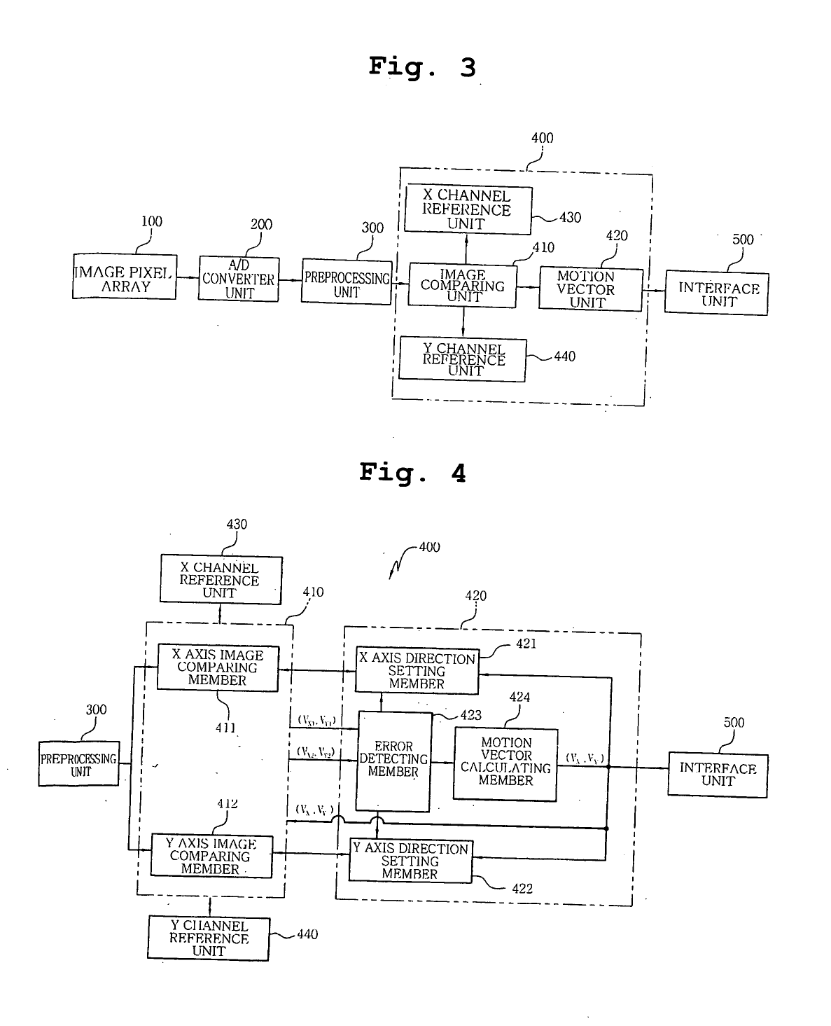

The image comparing unit 410 performs the full search or the partial search with respect to the current preprocessed image inputted from the preprocessing unit 300 according to a predetermining timing signal and includes an X axis image comparing member 411 and a Y axis image comparing member 412 as shown in FIG. 4.

That is, when the current preprocessed image is inputted from the image preprocessing unit 300 to the image comparing unit 410, the image comparing unit 410 performs the full search to overlap the predetermined reference image and coordinate values with respect to the entire area of the current preprocessed image, for example, 49 cases of (−3, +3), (−2, +3), (−1, +3), (0, +3), (1, +3), (+2, +3), (+3, +3), . . . , (−3, −3), (−2, −3), (−1, −3), (0, −3), (+1, −3), (+2, −3), and (+3, −3), and calculates (generates) a first motion vector coordinate value (VX1, VY1) to be outputted to the motion vector unit 420.

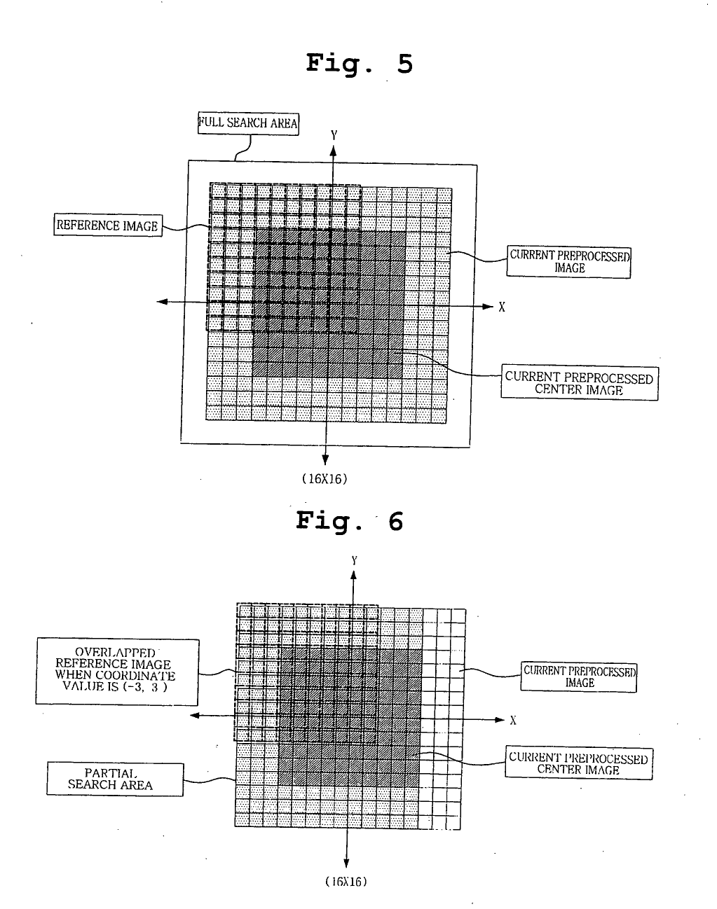

The X axis image comparing member 411 performs the full search to overlap the predetermined reference image determined by the X channel reference unit 430 with respect to the X axis coordinate values, such as the seven cases including the X axis coordinate value of −3 through +3, as shown in FIG. 5.

The X axis image comparing member 411 calculates the X axis coordinate value in a case that the number of pixels identical to pixels forming the predetermined reference image is greater, as an X axis motion vector coordinate value VX1 with respect to the current preprocessed image, and outputs the calculated X axis coordinate value to the motion vector unit 420 as the X axis motion vector coordinate value VX1.

At this time, the Y axis image comparing member 412 performs the full search to overlap the predetermined reference image determined by the Y channel reference unit 440 with respect to the Y axis coordinate values, such as the X axis coordinate values of −3 through +3 and outputs a Y axis motion vector coordinate value VY1 calculated by using the full search to the motion vector unit 420.

In a case that the predetermined direction determining coefficient is inputted from the motion vector unit 420 according to a history of the motion vector coordinate values with respect to the past preprocessed image, the image comparing unit 410 performs the partial search to overlap the current preprocessed image and the predetermined reference image with respect to the coordinate axis corresponding to the direction determining coefficient, thereby calculating a second motion vector coordinate value (VX2, VY2) and outputting a result of the partial search, such as the second motion vector coordinate value (VX2, VY2), to the motion vector unit 420.

That is, if the predetermined X axis direction determining coefficient inputted from the motion vector unit 420 is a negative (−) value, which indicates that the past motion vector coordinate value is disposed on the left side of the X coordinate, the X axis image comparing member 411 performs the partial search with respect to coordinate values disposed on the left side of the X coordinate, such as coordinate values of −1, −2, −3 including the origin of the coordinates, to generate the X axis motion vector coordinate value VX2, as shown in FIG. 6.

To the contrary, if the predetermined X axis direction determining coefficient inputted from the motion vector unit 420 is a positive (+) value, which indicates that the past motion vector coordinate value is disposed on the right side of the X coordinate, the X axis image comparing member 411 performs the partial search with respect to coordinate values disposed on the right side of the X coordinate, such as coordinate values of 1, 2, and 3 including the origin of the coordinates, to generate the X axis motion vector coordinate value VX2, as shown in FIG. 7.

In addition, when a default signal or an error signal is inputted from the motion vector unit 400, the X axis image comparing member 411 performs the full search on the predetermined reference image with respect to the entire area of the current preprocessed image to calculate the X axis motion vector coordinate value VX2, as shown in FIG. 5.

Here, that the X axis direction determining coefficient is set to the default value indicates that the entire searched area and the partial search area with respect to the X axis are set to the same.

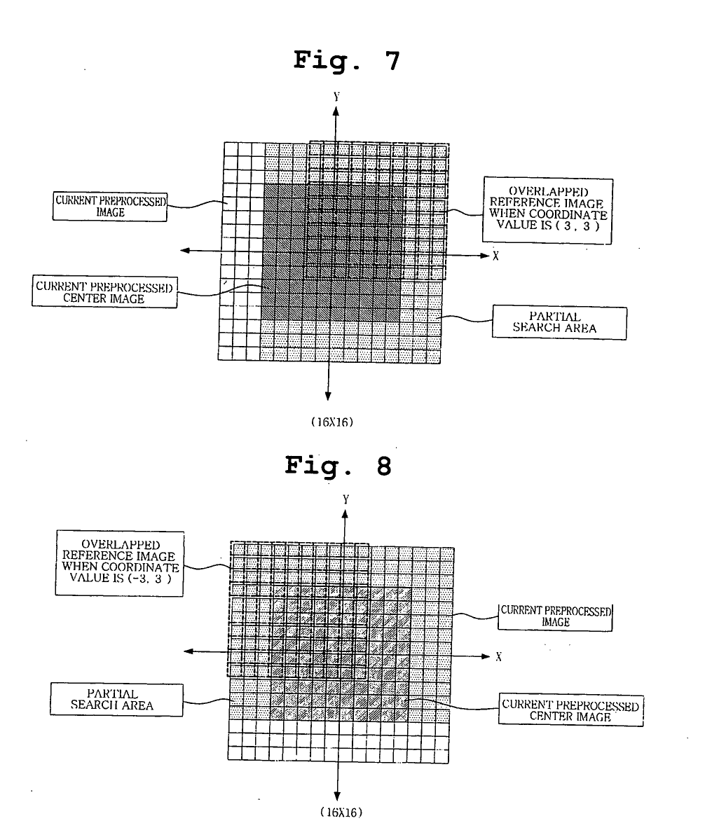

If the predetermined Y axis direction determining coefficient inputted from the motion vector unit 420 is a positive (+) value, which indicates that the past motion vector coordinate value is disposed on the upper side of the Y coordinate, the Y axis image comparing member 412 performs the partial search with respect to coordinate values disposed on the upper side of the Y coordinate, such as coordinate values of 1, 2, and 3 including the origin of the coordinates, to generate the Y axis motion vector coordinate value VY2, as shown in FIG. 8.

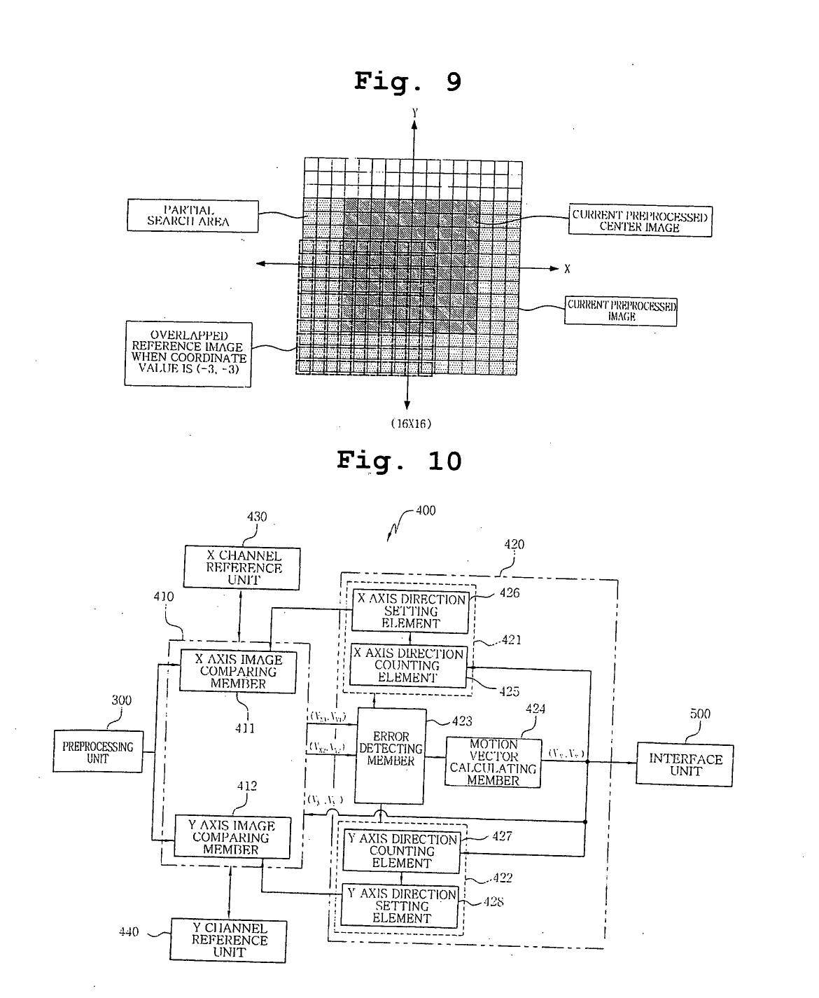

To the contrary, if the predetermined X axis direction determining coefficient inputted from the motion vector unit 420 is a negative (−) value, which indicates that the past motion vector coordinate value is disposed on the lower side of the Y coordinate, the Y axis image comparing member 412 performs the partial search with respect to coordinate values disposed on the lower side of the Y coordinate, such as coordinate values of −1, −2, and −3 including the origin of the coordinates, to generate the Y axis motion vector coordinate value VY2, as shown in FIG. 9.

In addition, when a default signal or an error signal is inputted from the motion vector unit 400, the Y axis image comparing member 412 performs the full search on the predetermined reference image with respect to the entire area of the current preprocessed image to calculate the Y axis motion vector coordinate value VY2, as shown in FIG. 5

Here, that the Y axis direction determining coefficient is set to the default value indicates that the entire searched area and the partial search area with respect to the Y axis are set to the same. In a case that a final motion vector coordinate value (VX, VY) with respect to the current preprocessed image is feedback from the motion vector unit 420, the image comparing unit 410 does not change a reference image predetermined un the X channel/Y channel reference units 430 and 440 when the movement amount of the final motion vector coordinate value is zero. If the amount of movement in the final motion vector coordinate value is not zero, the image comparing unit 410 changes the predetermined reference image to the current preprocessed center image.

The motion vector unit 420 generates one of the first motion vector coordinate value (VX1, VY1) generated by the full search and the second motion vector coordinate value (VX2, VY2) generated by the partial search as the final motion vector coordinate value (VX, VY) with respect to the current preprocessed image, according to the existence of the error signal.

The motion vector unit 420 includes an X direction determining member 421, a Y axis direction determining member 422, an error detecting member 423, and a motion vector calculating member 424, as shown in FIG. 3, to calculate (generate) a direction determining coefficient with respect to a preprocessed image of a future frame according to a history of the motion vector coordinate value (VX, VY) calculated by the partial or full search.

The X axis direction determining member 421 includes an X direction counting element 425 and an X axis direction setting element 426 to calculate the X axis direction determining coefficient according to a history of the motion vector coordinate value (VX) feedback from the motion vector calculating member 422.

Here, the X axis motion vector coordinate value (VX) feedback from the motion vector calculating member 424 is the first X axis motion vector coordinate value (VX1) calculated by the full search when the error signal is detected by the error detecting member 423, or the second X axis motion vector coordinate value (VX2) calculated by the partial search when the error signal is not detected by the error detecting member 423.

The X axis direction counting element 425 accumulates the number of times corresponding to directions of the final X axis motion vector coordinate value (VX) inputted from the motion vector calculating member 424 and outputs the accumulated result to the X axis direction setting element 426.

Here, the X axis direction counting element 426 calculates the direction determining coefficient, such as left, right, and default X axis direction determining coefficient, with respect to the future preprocessed image according to the history of the final X axis motion vector coordinate value (VX) and outputs the calculated direction determining coefficient to the X axis image comparing member 411.

For example, the X axis direction determining element 426 outputs the (+) direction determining coefficient to the X axis image comparing member 411 when a positive value including a zero value is outputted according to the history with respect to the final X axis motion vector coordinate value (VX) to indicate that the final X axis motion vector coordinate value is shifted by more than 6 frames in the right side direction.

And the X axis direction determining element 426 outputs the (−) direction determining coefficient to the X axis image comparing member 411 when a positive value including a zero value is outputted according to the history with respect to the final X axis motion vector coordinate value (VX) to indicate that the final X axis motion vector coordinate value is shifted by more than 6 frames in the left side direction.

In a case that the outputted history with respect to the final X axis motion vector coordinate value (VX) is zero (0) as the X axis coordinate value, or the error detecting member 423 is set to a default mode to input an error signal, the X axis direction setting element 426 outputs the default signal to the X axis image comparing member 411.

Here, when the X axis direction determining coefficient is the (+) direction determining coefficient, the X axis direction determining coefficient indicates that the current preprocessed image moves in the right direction with respect to the X axis, or the future preprocessed image will move in the right direction with respect to the X axis.

When the X axis direction determining coefficient is in the default mode, the X axis direction determining coefficient indicates that the current preprocessed image and the future preprocessed image do not have a clear moving direction with respect to the X axis.

The Y axis direction determining member 422 includes a Y direction counting element 427 and a Y axis direction setting element 428 to calculate the X axis direction determining coefficient according to a history of the motion vector coordinate value (VX) feedback from the motion vector calculating member 422.

The Y axis direction counting element 427 accumulates the number of times corresponding to directions of the final Y axis motion vector coordinate value (VY) inputted from the motion vector calculating member 424 and outputs the accumulated result to the Y axis direction setting element 428.

Here, the Y axis direction counting element 427 calculates the direction determining coefficient, such as an upper direction determining coefficient (+), a lower direction determining coefficient (−), and a default Y axis direction determining coefficient, with respect to the future preprocessed image using the same method performed by the X axis direction determining member 421 according to the history of the final Y axis motion vector coordinate value (VY) and outputs the calculated direction determining coefficient to the Y axis image comparing member 412.

Here, when the Y axis direction determining coefficient is the (+) direction determining coefficient, the Y axis direction determining coefficient indicates that the current preprocessed image moves in the upper direction with respect to the Y axis, or the future preprocessed image will move in the upper direction with respect to the Y axis.

When the Y axis direction determining coefficient is the (−) direction determining coefficient, the Y axis direction determining coefficient indicates that the current preprocessed image moves in the lower direction with respect to the Y axis, or the future preprocessed image will move in the lower direction with respect to the Y axis

When the Y axis direction determining coefficient is in the default mode, the Y axis direction determining coefficient indicates that the current preprocessed image and the future preprocessed image do not have a clear moving direction with respect to the Y axis.

The error detecting member 423 receives the first motion vector coordinate value (VX1, VY1) generated through the full search and the second motion vector coordinate value (VX2, VY2) generated through the partial search according to the predetermined direction determining coefficient in every frame, compares the first motion vector coordinate value (VX1, VY1) with the second motion vector coordinate value (VX2, VY2), and detects the error according to a determination of whether the motion vector coordinate values with respect to a predetermined frame are identical.

When the first motion vector coordinate value (VX1, VY1) generated through the full search is different from the second motion vector coordinate value (VX2, VY2) generated through the partial search in consecutive predetermined times, for example, three times, the error detecting member 423 generates the error signal, simultaneously generates the first motion vector coordinate value (VX1, VY1) generated through the full search as the final motion vector coordinate value (VX, VY) with respect to the current preprocessed image, and sets the Y axis direction setting member 421 and the Y axis direction setting member 422 in the default mode.

However, when the identical motion vector coordinate value is inputted at least once in the predetermined number of the frames, for example, at least one frame among the consecutive three frames in row, the error detecting member 423 generates the error signal, simultaneously generates the second motion vector coordinate value (VX2, VY2) generated through the partial search as the final motion vector coordinate value (VX, VY) with respect to the current preprocessed image, and sets the Y axis direction setting member 421 and the Y axis direction setting member 422 in the operation mode.

In a case that the error signal is not detected in the error detecting member 423, the motion vector calculating member 424 outputs the second motion vector coordinate value (VX2, VY2) generated through the partial search as the final motion vector coordinate value (VX, VY) with respect to the current preprocessed image, to the interface unit 500, and feedbacks the final motion vector coordinate value to the X and Y direction setting member 421 and 422 and the image comparing members 411 and 412.

In a case that the error signal is detected in the error detecting member 423, the motion vector calculating member 424 outputs the first motion vector coordinate value (VX1, VY1) generated through the full search as the final motion vector coordinate value (VX, VY) with respect to the current preprocessed image, to the interface unit 500, and feedbacks the final motion vector coordinate value to the X and Y direction setting member 421 and 422 and the image comparing members 411 and 412.

The x channel reference unit 430 stores the current preprocessed center image including the predetermined pixel array extracted from a center position of the current preprocessed image inputted from the preprocessing unit 300 as an X axis candidate reference image to calculate a motion vector coordinate value of the future preprocessed image.

When the final X axis motion vector coordinate value (VX) of the current preprocessed image feedback from the motion vector unit 420 is not zero, the X channel reference unit 430 determines the current preprocessed center image as the X axis reference image according to a control signal of the image comparing unit 410.

When the final X axis motion vector coordinate value (VX) of the current preprocessed image feedback from the motion vector unit 420 is zero, the X channel reference unit 430 maintains the X axis reference image.

The Y channel reference unit 440 determines the current preprocessed center image as the Y axis reference image when the final Y axis motion vector coordinate value (VY) of the current preprocessed image feedback from the motion vector unit 420 is not zero, and the Y channel reference unit 440 maintains the X axis reference image when the final X axis motion vector coordinate value (VX) of the current preprocessed image feedback from the motion vector unit 420 is zero.

The interface unit 500 accumulates the final motion vector coordinate value (VX, VY) inputted from the motion vector outputting member 424 for a predetermined period of time to transmit the accumulated coordinate values to an external apparatus.

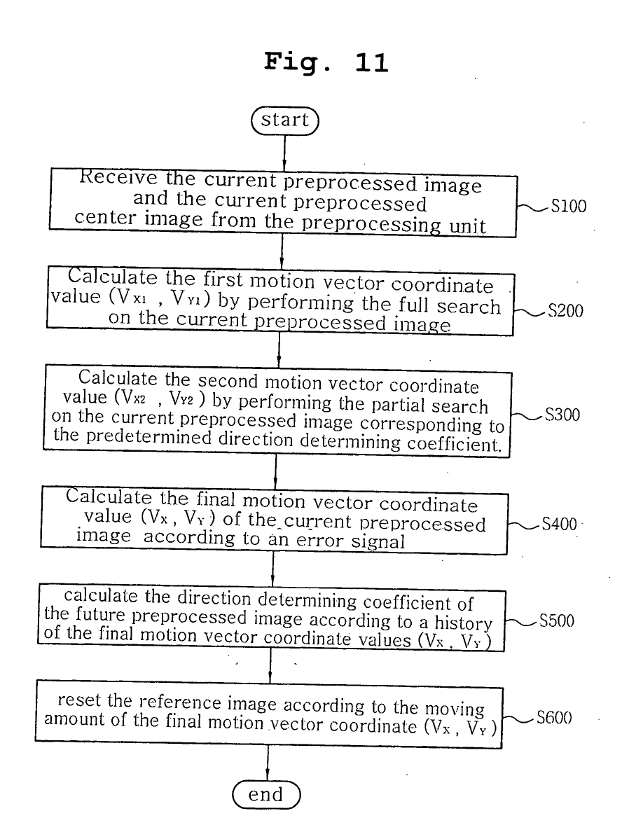

A method of navigating a position in the optical sensing apparatus will be described with reference to FIGS. 11 through 17 according another embodiment of the present invention

The movement coordinate calculating unit 400 receives the current preprocessed image and the current preprocessed center image from the preprocessing unit 300 in operation S100.

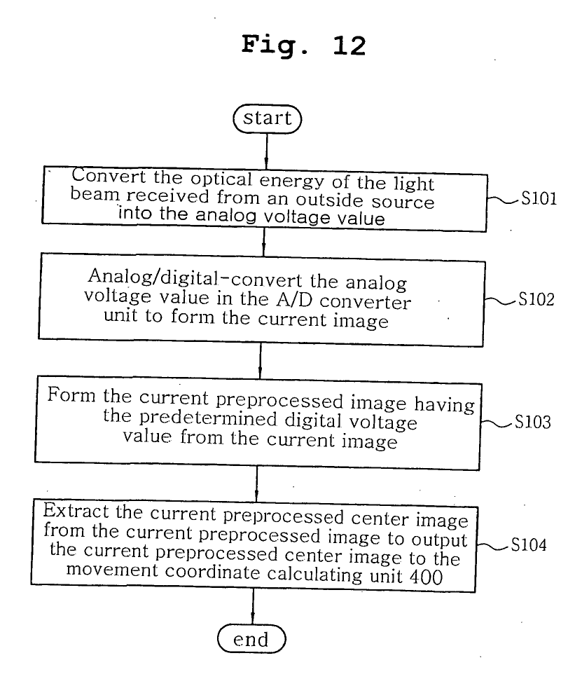

Referring to FIG. 12, the image pixel array 100 converts the optical energy of the light beam received from an outside source (reflected from the bottom surface) into the analog voltage value to be outputted to the A/D converter unit 200 in operation S101.

The A/D converter unit 200 converts the analog voltage value of each pixel into the digital voltage value, for example, digital voltage signal having 4-8 bits, to form the current image, and transmits the current image (digital voltage signal) to the preprocessing unit 300 in operation S102.

The preprocessing unit 300 forms the current preprocessed image having a pixel array of which pixel has the predetermined digital voltage value of one or more bits, from the current image in operation S103.

The operation 103 of forming the current preprocessed image in the preprocessing unit 300 will be explained in more detail.

The preprocessing unit 300 sequentially receives predetermined one bit values, such as the digital voltage values of the pixels having 4-8 bits, of the respective pixels forming the current image to store in the memory according to the timing signal.

When the digital voltage values of respective pixels forming the current image are sequentially inputted from the memory, the preprocessing unit 300 determines a target pixel to be converted into a predetermined bit value among the pixels, and a basic image matrix including pixels disposed around the target pixel.

It is possible that the basic image matrix is a 3×3 matrix structure according to an aspect of the present invention. However, the present invention is not limited thereto. The basic image matrix may be any of various matrix types.

The preprocessing unit 300 performs preprocessing between rows and between columns with respect to the digital voltage values between the pixels included in the basic image matrix using the above described formulas 1 and 2.

The preprocessing unit 300 converts the digital voltage value of the target pixel into the digital voltage value having one or more bits, for example, digital voltage value having one bit or two bits, by performing the above-described preprocessing operation to form the current preprocessed image from the current image and to output the current preprocessed image to the movement coordinate calculating unit 400.

Here, when the current image includes an n×n pixel array before the digital voltage value of the respective pixels is converted into the 2 bit value, the current preprocessed image has a (n-2)×(n-2) pixel array structure.

The preprocessing unit 300 extracts the current preprocessed center image having a predetermined pixel array structure, such as (n-8)×(n-8) pixel array structure, corresponding to a center position of the current preprocessed image, and outputs the current preprocessed center image to the movement coordinate calculating unit 400 in operation S104.

When the current preprocessed image and the current preprocessed center image are inputted from the preprocessing unit 300, the movement coordinate calculating unit 400 calculates the first motion vector coordinate value (VX1, VY2) by performing the full search on the current preprocessed image in operation S200.

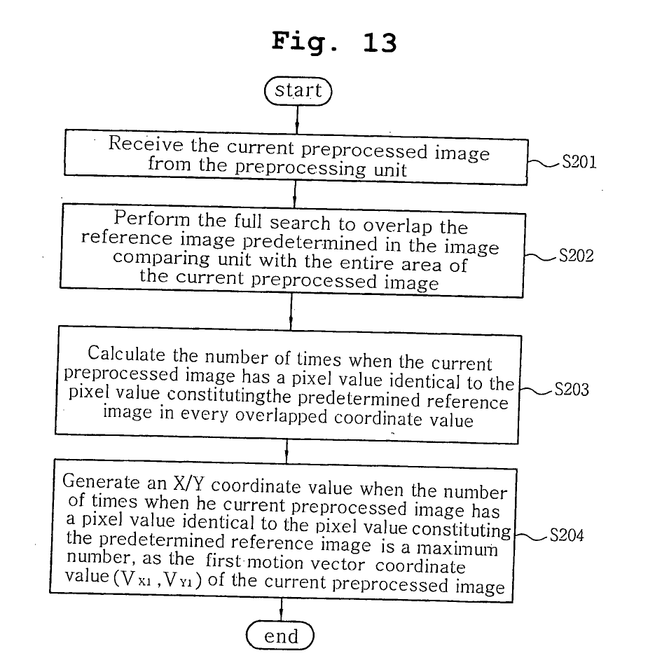

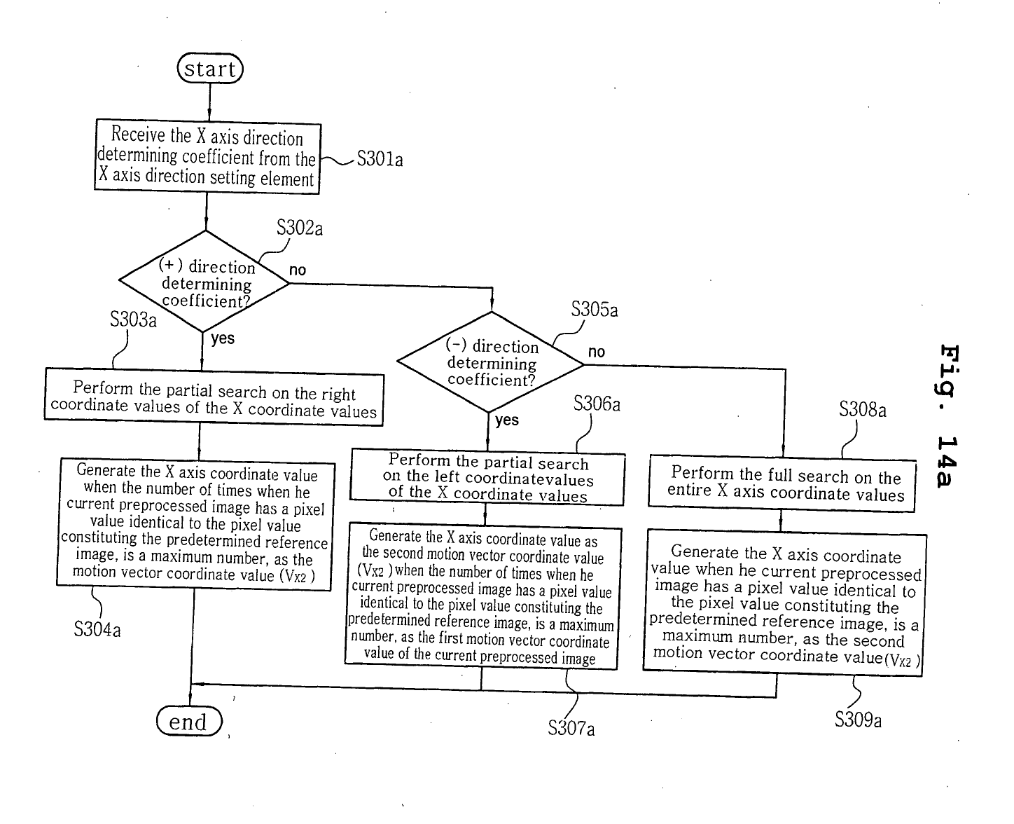

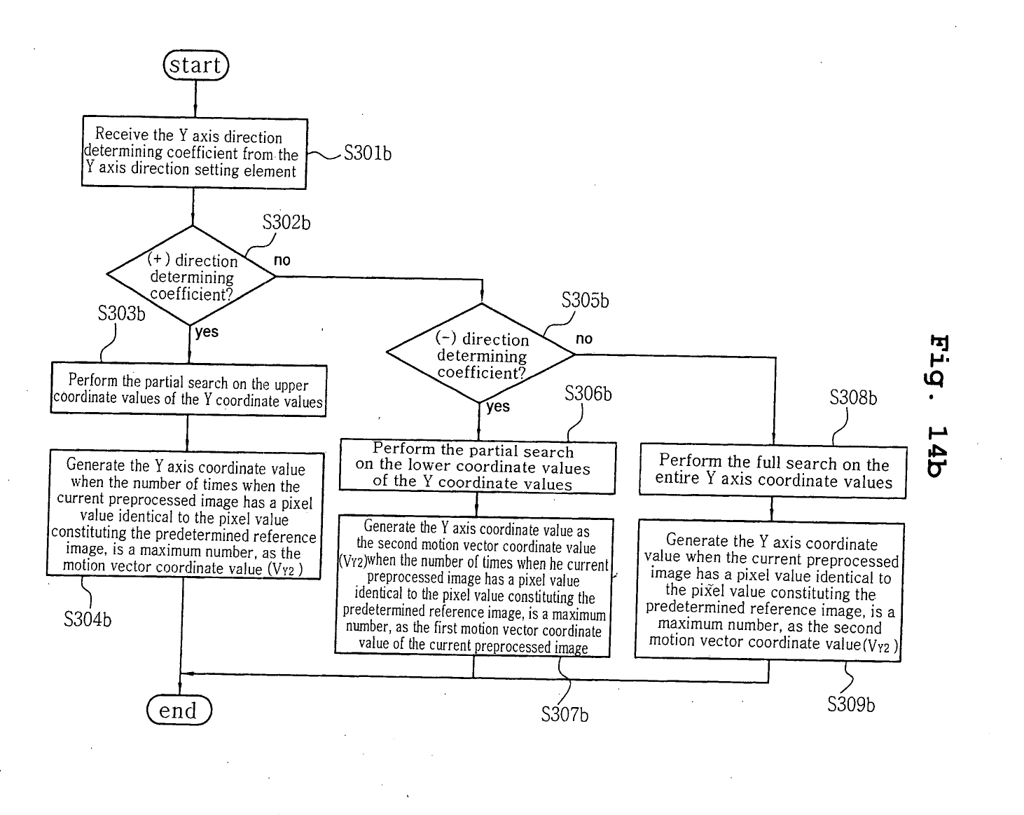

The operation of calculating the first motion vector coordinate value (VX1, VY2) using the full or partial search will be explained with reference to FIG. 13.

In a case that the current preprocessed image is inputted from the preprocessing unit 300 in operation 201, the image comparing unit 410 performs the full search to overlap the predetermined reference image, which is preset in the X/Y channel reference units 430 and 440, and coordinate values with respect to the entire area of the current preprocessed image, for example, 49 cases of (−3, +3), (−2, +3), (−1, +3), (0, +3), (1, +3), (+2, +3), (+3, +3), . . . , (−3, −3), (−2, −3), (−1, −3), (0, −3), (+1, −3), (+2, −3), and (+3, −3) in operation S202.

And then, the image comparing unit 410 calculates the number of times when the current preprocessed image has a pixel value identical to the pixel value constituting the predetermined reference image, in every overlapped coordinate value in operation S203.

The image comparing unit 410 generates an X/Y coordinate when the number of times when the current preprocessed image has a pixel value identical to the pixel value constituting the predetermined reference image, is a maximum number, as the first motion vector coordinate value (VX1, VY1) in operation S204.

The first motion vector coordinate value (VX1, VY1) is calculated using the full search on the current preprocessed image, and simultaneously the movement coordinate calculating unit 400 calculates the second motion vector coordinate value (VX2, VY2) by performing the partial search on the current preprocessed image corresponding to the predetermined direction determining coefficient in operation 300.

The operation of calculating the X axis motion vector coordinate value VX2 using the partial search will be explained with reference to FIG. 14A.

In a case that the predetermined direction determining coefficient is inputted from the X axis direction setting element 426 of the X axis direction setting member 421 in operation S301a, it is determined that in the X axis image comparing member 411, the predetermined direction determining coefficient is one of (+) direction determining coefficient, (−) direction determining coefficient, and a default signal in operation S302a.

When the predetermined direction determining coefficient is the (+) direction determining coefficient according to the determination in the operation S302a, the X axis image comparing member 411 performs the partial search on the right coordinate values including the origin of the X coordinate values in operation S303a.

The X axis image comparing member 411 generates the X axis coordinate value when the number of times when the current preprocessed image has a pixel value identical to the pixel value constituting the predetermined reference image, is a maximum number, as the second motion vector coordinate value VX2 in operation S304a.

When the predetermined direction determining coefficient is not the (+) direction determining coefficient according to the determination in the operation S302a, the X axis image comparing member 411 determines whether the predetermined direction determining coefficient is the (−) direction determining coefficient or the default signal in operation S305a.

If the predetermined direction determining coefficient is the (−) direction determining coefficient according to the determination in the operation S305a, the X axis image comparing member 411 performs the partial search on the left coordinate values including the origin of the X coordinate values in operation S306a.

And then, using the same method performed in operation S304a, the X axis image comparing member 411 generates the X axis coordinate value as the second motion vector coordinate value VX2 in operation S307a.

If the predetermined direction determining coefficient is the default signal according to the determination in the operation S305a, the X axis image comparing member 411 performs the full search on the entire X axis coordinate values in operation S308a and generates the X axis coordinate value when the number of times when the current preprocessed image has a pixel value identical to the pixel value constituting the predetermined reference image, is a maximum number, as the second motion vector coordinate value VX2 in operation S309a.

The operation of calculating the Y axis motion vector coordinate value VY2 using the partial search will be explained with reference to FIG. 14B.

In a case that the predetermined direction determining coefficient is inputted from the Y axis direction setting element 428 of the Y axis direction setting member 422 in operation S301b, it is determined that in the Y axis image comparing member 412, the predetermined direction determining coefficient is one of (+) direction determining coefficient, (−) direction determining coefficient, and a default signal in operation S302b.

When the predetermined direction determining coefficient is the (+) direction determining coefficient according to the determination in the operation S302b, the Y axis image comparing member 412 performs the partial search on the upper coordinate values including the origin of the Y coordinate values in operation S303b.

The X axis image comparing member 412 generates the Y axis coordinate value when the number of times when the current preprocessed image has a pixel value identical to the pixel value constituting the predetermined reference image, is a maximum number, as the second motion vector coordinate value VY2 in operation S304b.

When the predetermined direction determining coefficient is not the (+) direction determining coefficient according to the determination in the operation S302b, the Y axis image comparing member 412 determines whether the predetermined direction determining coefficient is the (−) direction determining coefficient or the default signal in operation S305b.

If the predetermined direction determining coefficient is the (−) direction determining coefficient according to the determination in the operation S305b, the Y axis image comparing member 412 performs the partial search on the lower coordinate values including the origin of the X coordinate values in operation S306a.

And then, using the same method performed in operation S304b, the Y axis image comparing member 412 generates the Y axis coordinate value as the second motion vector coordinate value VY2 in operation S307b.

If the predetermined direction determining coefficient is the default signal according to the determination in the operation S305b, the Y axis image comparing member 412 performs the full search on the entire Y axis coordinate values in operation S308b and generates the Y axis coordinate value when the number of times when the current preprocessed image has a pixel value identical to the pixel value constituting the predetermined reference image, is a maximum number, as the second motion vector coordinate value VY2 in operation S109b.

Accordingly, the movement coordinate calculating unit 400 generates one of the motion vector values calculated using the full/partial search as the final motion vector coordinate value (VX2, VY2) with respect to the current preprocessed image in operation S400 of FIG. 11.

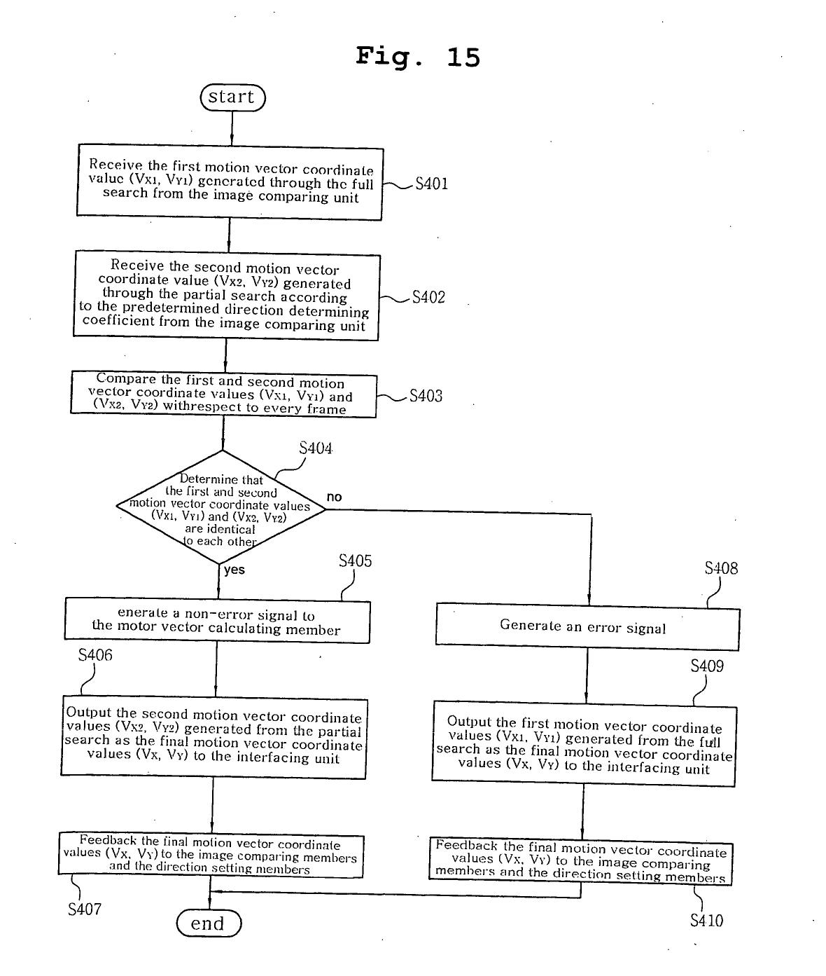

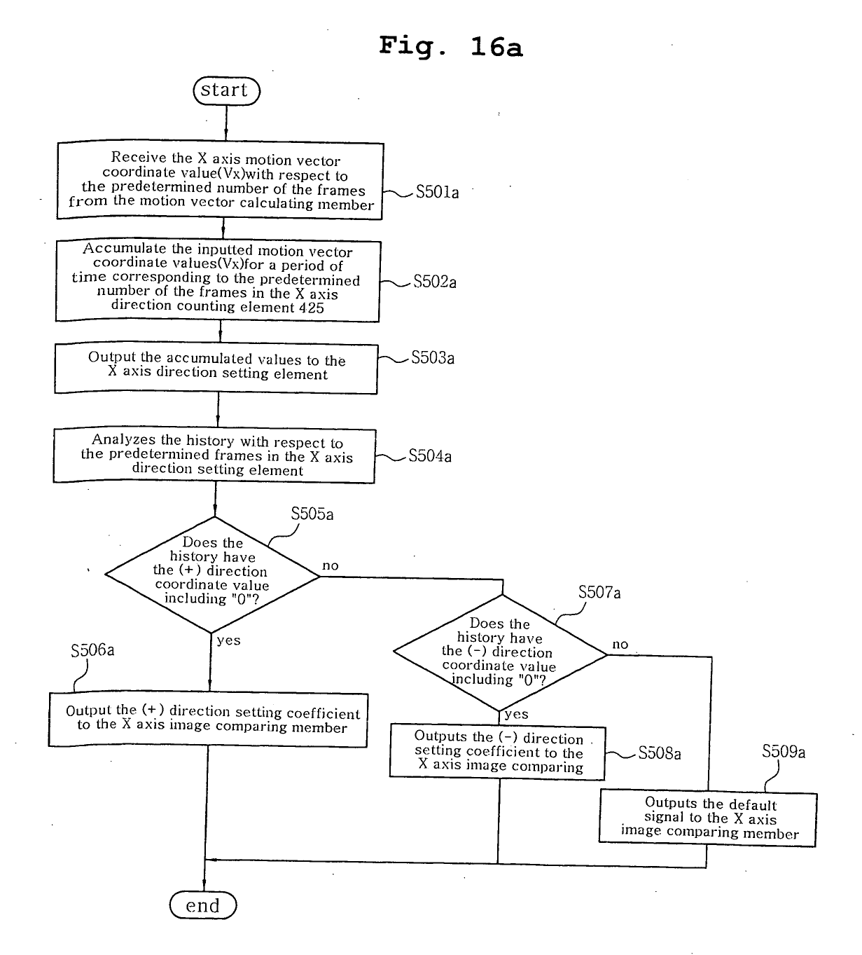

The operation of outputting the final motion vector coordinate value with respect to the current preprocessed image will be explained with reference to FIG. 15.

The error detecting member 423 receives the first motion vector coordinate value (VX1, VY1) generated through the full search with respect to the current preprocessed image from the image comparing unit 410 in operation 401.

At the same time, the error detecting member 423 also receives the second motion vector coordinate value (VX2, VY2) generated according to the predetermined direction determining coefficient through the partial search with respect to the current preprocessed image from the image comparing unit 410 in operation S402.

The error detecting member 423 compares the first and second motion vector coordinate values (VX1, VY1) and (VX2, VY2) with respect to every frame in operation S403 to determine whether the first and second motion vector coordinate values (VX1, VY1) and (VX2, VY2) are identical with respect to a predetermined number of frames in operation S404.

When the error signal is not generated from the error detecting member 423, the motor vector calculating member 424 outputs the second motion vector coordinate values (VX2, VY2) generated from the partial search as the final motion vector coordinate values (VX, VY) to the interfacing unit 400 in operation S406 and feedbacks the final motion vector coordinate values (VX, VY) to the image comparing members 411 and 412 and the direction setting members 421 and 422 in operation S407.

When the motion vector coordinate values are not identical with respect to the predetermined number of frames in operation S404, the error signal is generated from the error detecting member 423 to the motion vector calculating member 424 in operation S408.

When the error signal is generated from the error detecting member 423, the motor vector calculating member 424 outputs the first motion vector coordinate values (VX1, VY1) generated from the full search as the final motion vector coordinate values (VX, VY) to the interfacing unit 400 in operation S409 and feedbacks the final motion vector coordinate values (VX, VY) to the image comparing members 411 and 412 and the direction setting members 421 and 422 in operation S410.

The movement coordinate calculating unit 400 calculates the direction determining coefficient of the future preprocessed image according to a history of the final motion vector coordinate values (VX, VY) in operation S500.

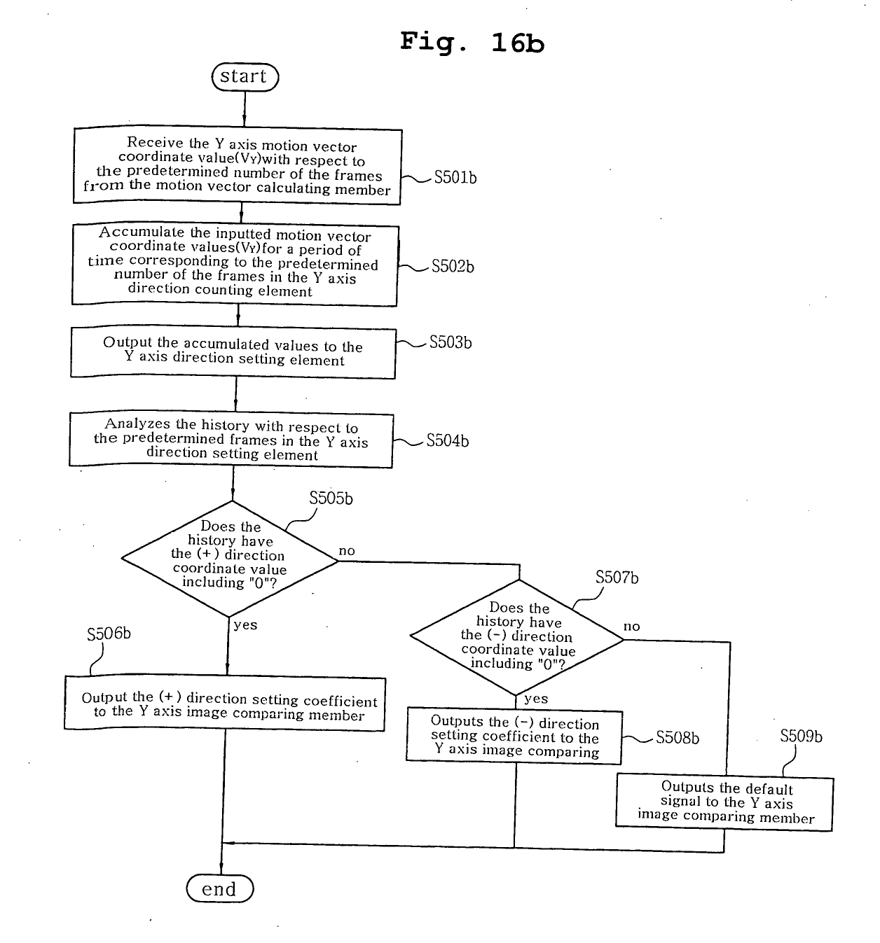

The operation of calculating the X axis direction determining coefficient of the future preprocessed image will be explained with reference to FIG. 16A.

When the X axis motion vector coordinate value VX with respect to the predetermined number of the frames is inputted from the motion vector calculating member 424 in operation S501a, the X axis direction counting element 425 accumulates the inputted motion vector coordinate values VX for a period corresponding to the predetermined number of the frames in operation S502a to output the accumulated values to the X axis direction setting element 426 in operation S503a.

The X axis direction setting element 426 analyzes the history with respect to the predetermined frames in operation S504a and determines whether the history with respect to the motion vector coordinate value VX is the history outputted as the X axis coordinate value in the (+) direction including “0” (the origin of the X coordinates) in the six frames in operation S505a.

When the history shows the (+) direction including the origin of the X coordinates in operation S505a, the X axis direction determining element 426 outputs the (+) direction setting coefficient, which indicates that the future preprocessed image moves in the right direction with respect to the X axis, to the X axis image comparing member 411 in operation S506a.

When the history does not show the (+) direction including the origin of the X coordinates in operation S505a, the X axis direction setting element 426 determines whether the motion vector coordinate value VX forms the history showing the X axis coordinate values in the (−) direction including the origin of the X axis coordinates in more than six frames in operation S507a.

The X axis direction determining element 426 outputs the (+) direction setting coefficient, which indicates that the future preprocessed image moves in the right direction with respect to the X axis, to the X axis image comparing member 411 in operation S508a when the history shows the (−) direction including the origin of the X coordinates in operation S507a, the X axis direction determining element 426 outputs the (−) direction setting coefficient, which indicates that the future preprocessed image moves in the left direction with respect to the X axis, to the X axis image comparing member 411 in operation S508a.

And, the X axis direction setting element 426 outputs to the X axis image comparing member 411 a default control signal indicating the future preprocessed image having no clear directional characteristic with respect to the X axis when the motion vector coordinate value VX is outputted as the X axis coordinate value having “0” for a period of ten consecutive frames in operation S509a.

The operation of calculating the Y axis direction determining coefficient of the future preprocessed image will be explained with reference to FIG. 16B.

When the Y axis motion vector coordinate value VY with respect to the predetermined number of the frames is inputted from the motion vector calculating member 424 in operation S501b, the Y axis direction counting element 427 accumulates the inputted motion vector coordinate values VY for a period corresponding to the predetermined number of the frames in operation S502b to output the accumulated values to the Y axis direction setting element 428 in operation S503b.

The Y axis direction setting element 428 analyzes the history with respect to the predetermined frames in operation S504b and determines whether the history with respect to the motion vector coordinate value VY is the history outputted as the Y axis coordinate value in the (+) direction including “0” (the origin of the Y coordinates) in the six frames in operation S505b.

When the history shows the (+) direction including the origin of the Y coordinates in operation S505b, the Y axis direction determining element 428 outputs the (+) direction setting coefficient, which indicates that the future preprocessed image moves in the upper direction with respect to the Y axis, to the Y axis image comparing member 412 in operation S506b.

When the history does not show the (+) direction including the origin of the Y coordinates in operation S505b, the Y axis direction setting element 428 determines whether the motion vector coordinate value VY forms the history showing the Y axis coordinate values in the (−) direction including the origin of the Y axis coordinates in more than six frames in operation S507b.

The X axis direction determining element 426 outputs the (+) direction setting coefficient, which indicates that the future preprocessed image moves in the right direction with respect to the X axis, to the X axis image comparing member 411 in operation S506b when the history shows the (−) direction including the origin of the Y coordinates in operation S505b, and the X axis direction determining element 428 outputs the (−) direction setting coefficient, which indicates that the future preprocessed image moves in the lower direction with respect to the Y axis, to the Y axis image comparing member 412 in operation S508b.

And, the Y axis direction setting element 428 outputs to the Y axis image comparing member 412 a default control signal indicating the future preprocessed image having no clear directional characteristic with respect to the Y axis in operation S509b when the motion vector coordinate value VY is outputted as the Y axis coordinate value having “0” for a period of ten consecutive frames in operation S507b.

The movement coordinate calculating unit 424 resets the reference image in the X channel/Y channel reference units 430 and 440 according to the moving amount of the final motion vector coordinate (VX, VY) in operation S600.

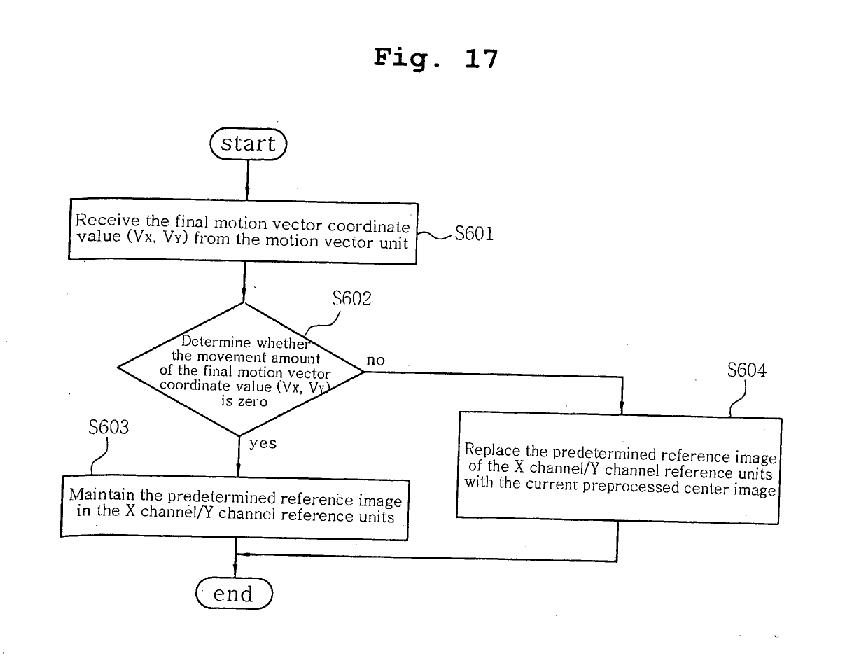

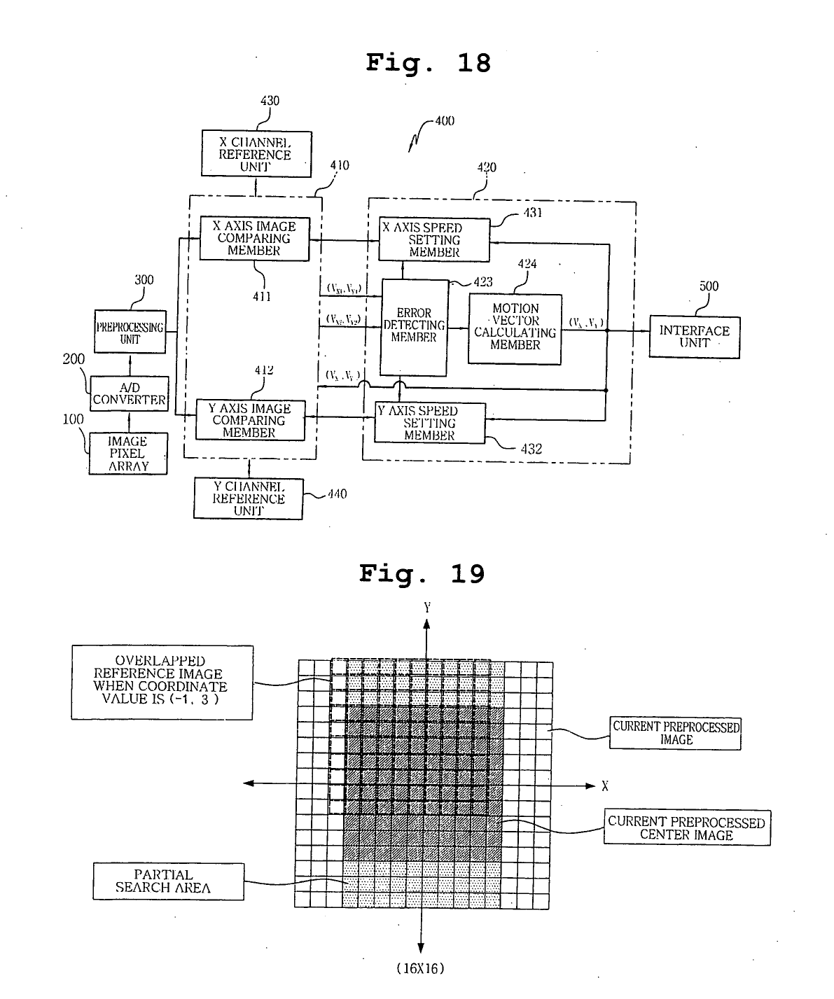

Referring FIG. 17, in a case that the final motion vector coordinate value (VX, VY) accumulated from the motion vector unit 420 is feedback in operation S601, the image comparing unit 410 determines whether the movement amount of the final motion vector coordinate value (VX, VY) becomes zero in operation 602.

When the movement amount of the final motion vector coordinate value (VX, VY) is zero, the image comparing unit 410 maintains the predetermined reference image in the X channel/Y channel reference units 430 and 440 in operation S603.

When the movement amount of the final motion vector coordinate value (VX, VY) is not zero, the image comparing unit 410 converts the predetermined reference image of the X channel/Y channel reference units 430 and 440 into the current preprocessed center image in operation 604.

An optical sensing apparatus and a method to navigate a position according to another embodiment of the present invention are described in more detail with reference to FIGS. 18-29.

Referring to FIG. 18, the optical sensing apparatus to navigate a position according to another embodiment of the present invent will be explained hereinafter.

The optical sensing apparatus includes an image pixel array 100, an A/D converter unit 200, a preprocessing unit 300, a movement coordinate calculating unit 400, and an interface unit 500 to calculate the final motion vector coordinate value (VX, VY) of the current preprocessed image through a partial search according to a predetermined speed determining coefficient and a full search on the current preprocessed image, and to calculate the speed determining coefficient of a future preprocessed image according to a history of the final motion vector coordinate value (VX, VY).

Since the structure and the operation of the image pixel array 100, the A/D converter unit 200, the preprocessing unit 300, and the interface unit 400 of this embodiment are similar to the embodiment shown in FIGS. 3 and 4, detail descriptions will be omitted. Therefore, the structure and the operation of the movement coordinate calculating unit 400 will be described in more detail hereinafter.

The movement coordinate calculating unit 400 performs a full search to overlap a predetermined reference image with an entire area of the current preprocessed image or performs a partial search on a particular coordinate value corresponding to the predetermined speed determining coefficient to generate a motion vector coordinate value of the current preprocessed image.

The movement coordinate calculating unit 400 includes an image comparing unit 410, a motion vector unit 420, an X channel reference unit 430, a Y channel reference unit 440 to calculate the speed determining coefficient of the future preprocessed image According to the history of the calculated motion vector coordinate value. The image comparing unit 410 includes an X axis image comparing member 411 and a Y axis image comparing member 412 as shown in FIG. 18, to perform the full search or the partial search with respect to the current preprocessed image inputted from the preprocessing unit 300 according to a predetermining timing signal.

That is, when the current preprocessed image is inputted from the image preprocessing unit 300 to the image comparing unit 410, the image comparing unit 410 performs the full search to overlap the predetermined reference image and coordinate values with respect to the entire area of the current preprocessed image, for example, 49 cases of x and Y coordinate values to calculates (generates) a first motion vector coordinate value (VX1, VY1) to be outputted to the motion vector unit 420, like as the previous embodiment shown in FIG. 5.

The image comparing unit 410 performs the partial search with respect to coordinate values corresponding to the predetermined speed determining coefficient inputted from the motion vector unit 420 to calculate a second motion vector coordinate value (VX2, VY2) to be outputted to the motion vector unit 420.

The X axis image comparing member 411, as shown in FIG. 19, performs the partial search with respect to an X axis area having a coordinate value of ±1 including the origin of the coordinates among the X axis coordinate values in a case of a low speed mode indicating that the predetermined X axis speed determining coefficient is disposed in an inside of the X axis coordinates according to a history of the past motion vector coordinate value.

The X axis image comparing member 411 calculates the X axis coordinate value in a case that the number of pixels identical to pixels constituting the predetermined reference image is greater than others, as an X axis motion vector coordinate value VX2 with respect to the current preprocessed image, and outputs the calculated X axis coordinate value to the motion vector unit 420 as the X axis motion vector coordinate value VX2.

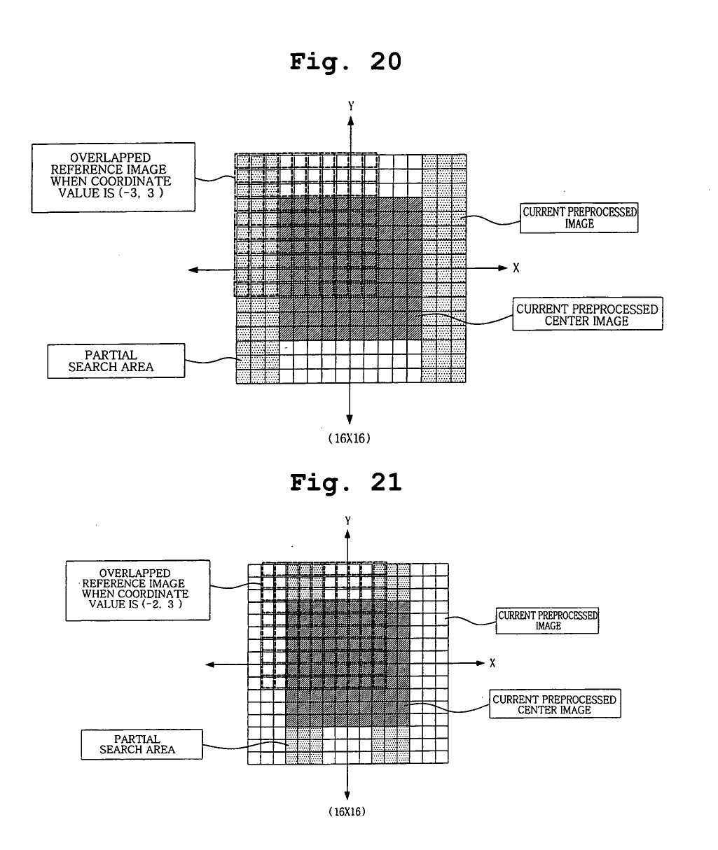

The X axis image comparing member 411, as shown in FIG. 20, performs the partial search with respect to an X axis area having a coordinate value of ±2 and/or ±3, that is, an outside of the X axis coordinates among the X axis coordinate values in a case of a high speed mode indicating that the predetermined X axis speed determining coefficient is disposed in the outside of the X axis coordinates according to a history of the past motion vector coordinate value to calculate the X axis motion vector coordinate value VX2.

The X axis image comparing member 411, as shown in FIG. 21, performs the partial search with respect to an X axis area having a coordinate value excluding the origin and ±3, that is, a middle of the X axis coordinates among the X axis coordinate values in a case of a middle speed mode indicating that the predetermined X axis speed determining coefficient is disposed in the middle of the X axis coordinates according to a history of the past motion vector coordinate value to calculate the X axis motion vector coordinate value VX2.

At this time, if the predetermined X axis speed determining coefficient is a default signal, the X axis image comparing member 411, as shown in FIG. 5, performs the full search with respect to the entire area of the X axis coordinates to calculate the X axis motion vector coordinate value VX2.

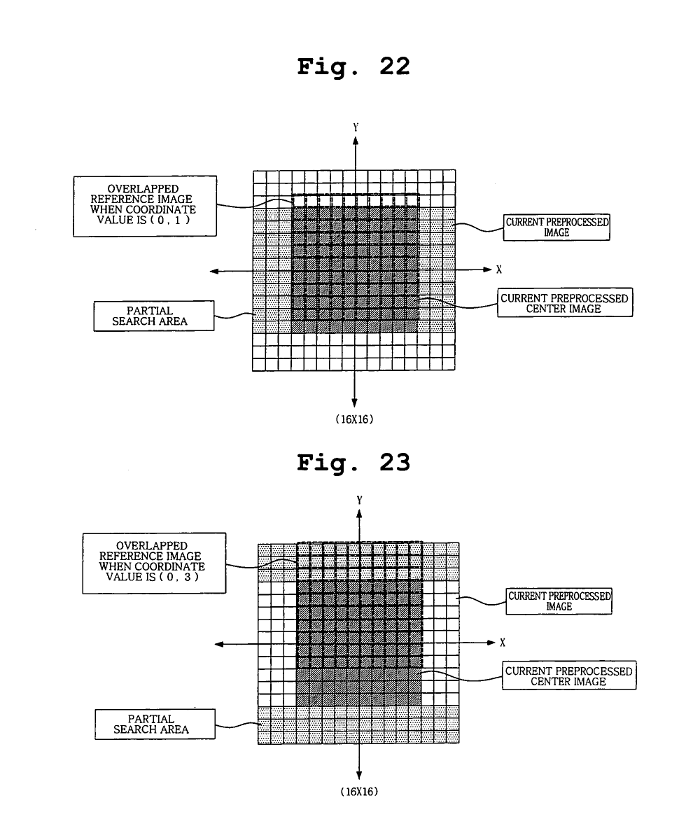

The Y axis image comparing member 412, as shown in FIG. 22, performs the partial search with respect to an Y axis area having a coordinate value of ±1 including the origin of the coordinates among the Y axis coordinate values in a case of a low speed mode indicating that the predetermined Y axis speed determining coefficient is disposed in an inside of the Y axis coordinates according to a history of the past motion vector coordinate value.

The Y axis image comparing member 412 calculates the Y axis coordinate value in a case that the number of pixels identical to pixels constituting the predetermined reference image is greater than others, as an Y axis motion vector coordinate value VY2 with respect to the current preprocessed image, and outputs the calculated Y axis coordinate value to the motion vector unit 420 as the Y axis motion vector coordinate value VY2.

The Y axis image comparing member 412, as shown in FIG. 23, performs the partial search with respect to an Y axis area having a coordinate value of ±2 and/or ±3, that is, an outside of the Y axis coordinates among the Y axis coordinate values in a case of a high speed mode indicating that the predetermined Y axis speed determining coefficient is disposed in the outside of the Y axis coordinates according to a history of the past motion vector coordinate value to calculate the Y axis motion vector coordinate value VY2.

The Y axis image comparing member 412, as shown in FIG. 24, performs the partial search with respect to an Y axis area having a coordinate value excluding the origin and ±3, that is, a middle of the Y axis coordinates among the Y axis coordinate values in a case of a middle speed mode indicating that the predetermined Y axis speed determining coefficient is disposed in the middle of the Y axis coordinates according to a history of the past motion vector coordinate value to calculate the X axis motion vector coordinate value VY2.

At this time, if the predetermined Y axis speed determining coefficient is a default signal, the Y axis image comparing member 412, as shown in FIG. 5, performs the full search with respect to the entire area of the Y axis coordinates to calculate the Y axis motion vector coordinate value VY2.

Here, that the predetermined Y axis speed determining coefficient is a default signal represents that the entire search area and the partial search area are the same.

The motion vector unit 420 generates one of the first motion vector coordinate value (VX1, VY1) generated by the full search and the second motion vector coordinate value (VX2, VY2) generated according to the predetermined speed determining coefficient by the partial search as the final motion vector coordinate value (VX, VY) with respect to the current preprocessed image, according to the existence of the error signal.

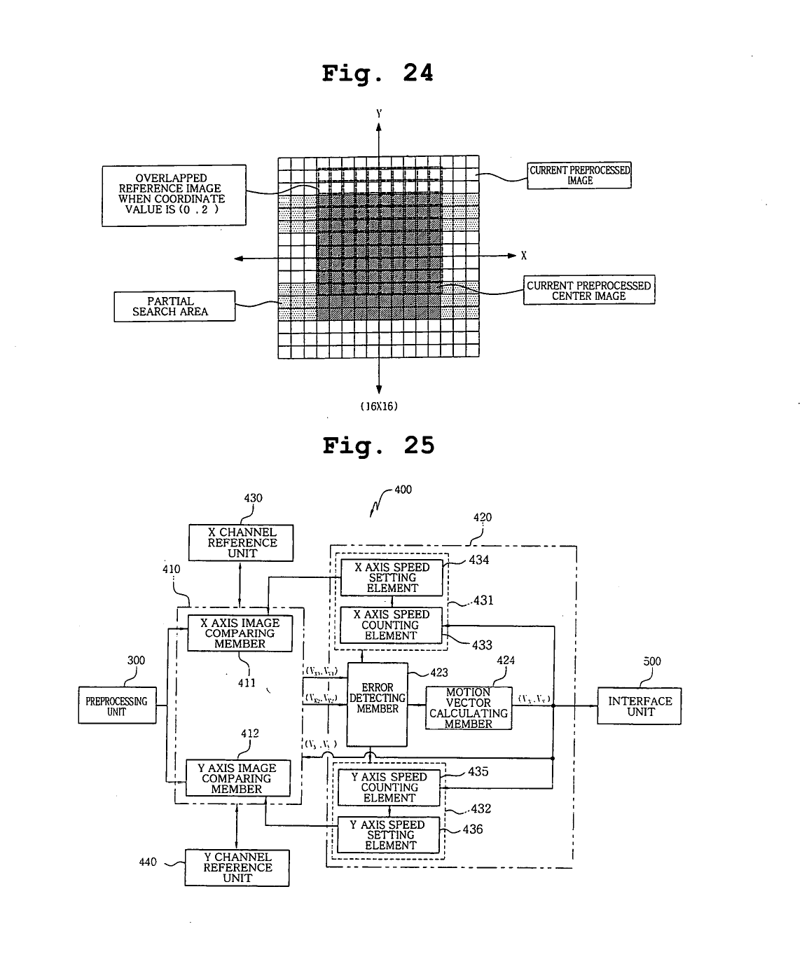

The motion vector unit 420 includes an X speed determining member 431, a Y axis speed determining member 432, an error detecting member 423, and a motion vector calculating member 424, as shown in FIG. 25, to calculate (generate) a speed determining coefficient with respect to a preprocessed image of a future preprocessed image according to a history of the motion vector coordinate value (VX, VY) calculated by the partial or full search.

The X axis speed determining member 431 includes an X speed counting element 433 and an X axis speed setting element 434 to calculate the X axis speed determining coefficient according to a history of the motion vector coordinate value (VX) feedback from the motion vector calculating member 424.

Here, the X axis speed counting element 433 accumulates the number of times corresponding to a speed of the final X axis motion vector coordinate value (VX) inputted from the motion vector calculating member 424 and outputs the accumulated result to the X axis speed setting element 434.

Here, the X axis speed setting element 434 calculates the speed determining coefficient with respect to the future preprocessed image according to the history of the final X axis motion vector coordinate value (VX) and outputs the calculated direction determining coefficient to the X axis image comparing member 411.

That is, when the history shows that the X axis motion vector coordinate value VX is maintained at a speed above a predetermined level for a predetermined period of time, the X axis speed setting element 434 outputs the speed determining coefficient of the high speed mode to the X axis image comparing member 411.

If the history shows that the X axis motion vector coordinate value VX is maintained at a speed below a predetermined level for a predetermined period of time, the X axis speed setting element 434 outputs the speed determining coefficient of the low speed mode to the X axis image comparing member 411.

If the history shows that the X axis motion vector coordinate value VX is maintained at a speed between a high level and a low level for a predetermined period of time, the X axis sped setting element 434 outputs the speed determining coefficient of the middle speed mode to the X axis image comparing member 411.

When the history shows that the X axis motion vector coordinate value VX is not maintained at a speed of a certain level for a predetermined period of time, the X axis speed setting element 434 outputs a default signal to the X axis image comparing member 411.

The Y axis speed determining member 432 includes an Y speed counting element 435 and an X axis speed setting element 436 to calculate the X axis speed determining coefficient according to a history of the motion vector coordinate value (VY) feedback from the motion vector calculating member 424.

Here, the X axis speed counting element 435 accumulates the number of times corresponding to a speed of the final Y axis motion vector coordinate value (VY) inputted from the motion vector calculating member 424 and outputs the accumulated result to the Y axis speed setting element 436.

Here, the Y axis speed setting element 436 calculates the speed determining coefficient with respect to the future preprocessed image according to the history of the final Y axis motion vector coordinate value (VY) and outputs the calculated direction determining coefficient to the Y axis image comparing member 412.

Accordingly, a process of calculating the Y axis speed determining coefficient of the future preprocess image by analyzing of the Y axis motion vector coordinate value VY is the same as the process of calculating the X axis speed determining coefficient of the future preprocess image by analyzing of the X axis motion vector coordinate value VX. Therefore, detail description will be omitted.

As described above, the speed setting members 431 and 432 outputs to the image comparing unit 410 four different speed determining coefficients in the high, low, or middle speed mode or the default signal according to the history of the final motion vector coordinate value (VX, VY) inputted from the motion vector calculating member 424.

The error detecting member 423 receives the first motion vector coordinate value (VX1, VY1) generated through the full search and the second motion vector coordinate value (VX2, VY2) generated through the partial search according to the predetermined speed determining coefficient in every frame, compares the first motion vector coordinate value (VX1, VY1) with the second motion vector coordinate value (VX2, VY2), and detects the error according to a determination of whether the motion vector coordinate values with respect to a predetermined frame are identical.

When the first motion vector coordinate value (VX1, VY1) generated through the full search is different from the second motion vector coordinate value (VX2, VY2) generated through the partial search in consecutive predetermined times, for example, three times, the error detecting member 423 generates the error signal, simultaneously generates the first motion vector coordinate value (VX1, VY1) generated through the full search as the final motion vector coordinate value (VX, VY) with respect to the current preprocessed image, and outputs the default signal to the Y axis speed setting member 431 and the Y axis speed setting member 432.

However, when the identical motion vector coordinate value is inputted at least once in the predetermined number of the frames, for example, at least one frame among the consecutive three frames, the error detecting member 423 outputs the second motion vector coordinate value (VX2, VY2) generated through the partial search as the final motion vector coordinate value (VX, VY) to the Y axis speed setting member 422.

In a case that the error signal is not detected in the error detecting member 423, the motion vector calculating member 424 outputs the second motion vector coordinate value (VX2, VY2) generated through the partial search as the final motion vector coordinate value (VX, VY) with respect to the current preprocessed image, to the interface unit 500.

In a case that the error signal is detected in the error detecting member 423, the motion vector calculating member 424 outputs the first motion vector coordinate value (VX1, VY1) generated through the full search as the final motion vector coordinate value (VX, VY) with respect to the current preprocessed image, to the interface unit 500.

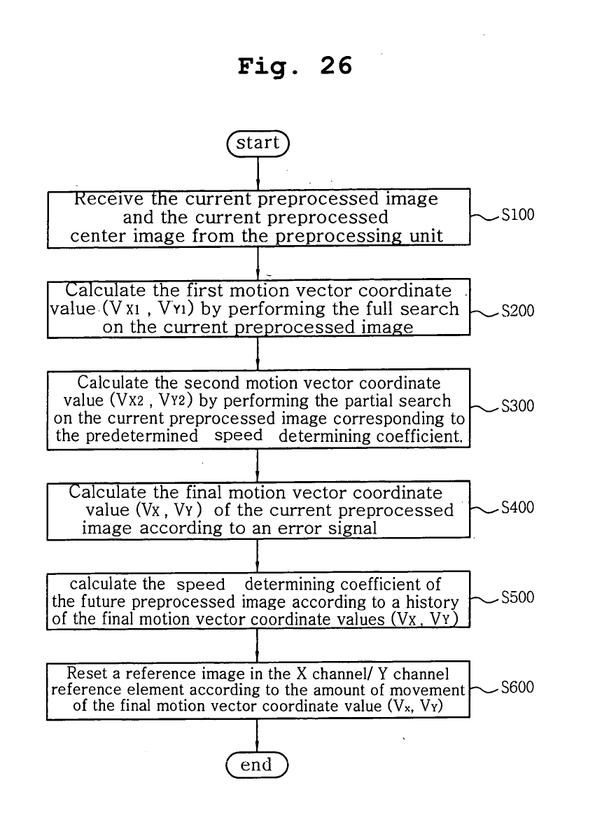

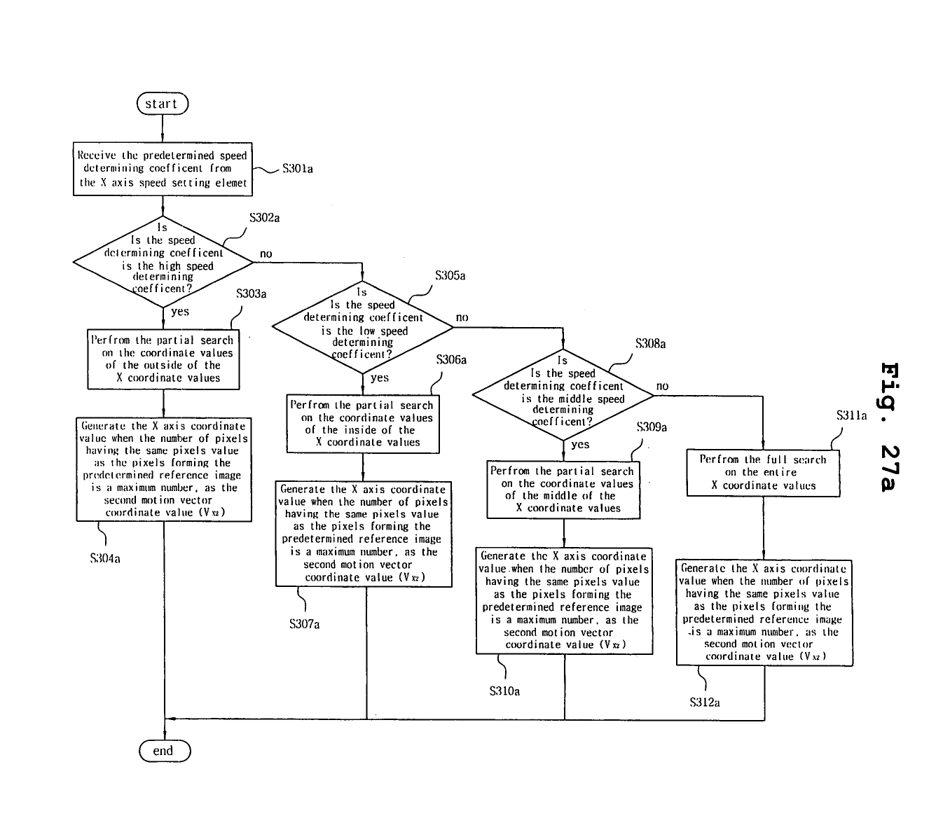

Hereinafter, a method of navigating a position using a partial search algorithm will be explained in accordance with FIGS. 26 through 29.

The movement coordinate calculating unit 400 receives the current preprocessed image and the current preprocessed center image from the preprocessing unit 300 in operation S100.

Since the operation S100 is similar to the operation shown in FIG. 12, detailed description will be omitted.

When the current preprocessed image and the current preprocessed center image with respect to the bottom surface are inputted from the preprocessing unit 300, the movement coordinate calculating unit 400 calculates the first motion vector coordinate value (VX1, VY2) by performing the full search on the current preprocessed image in operation S200.

The operation of calculating the first motion vector coordinate value (VX1, VY2) using the full or partial search will be omitted since the operation is similar to the operation shown in FIG. 13.

The first motion vector coordinate value (VX1, VY1) is calculated using the full search on the current preprocessed image, and simultaneously the movement coordinate calculating unit 400 calculates the second motion vector coordinate value (VX2, VY2) by performing the partial search on the current preprocessed image corresponding to the predetermined speed determining coefficient in operation 300.

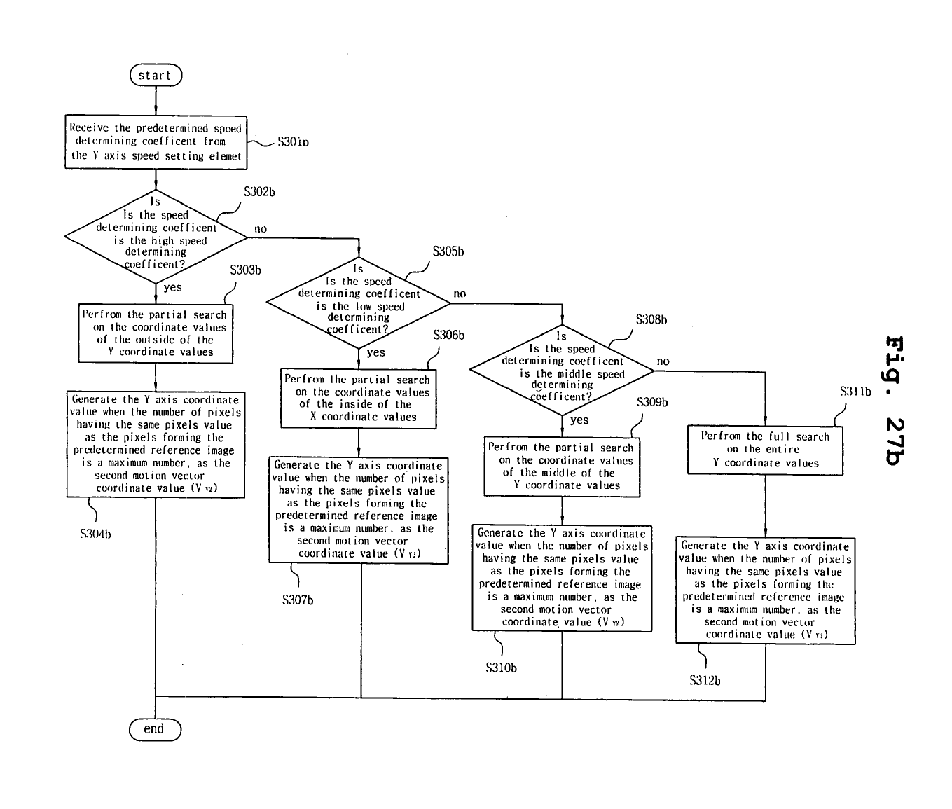

The operation of calculating the X axis motion vector coordinate value VX2 using the partial search will be explained with reference to FIG. 27A.

In a case that the predetermined speed determining coefficient is inputted from the X axis speed setting element 434 of the X axis speed setting member 431 in operation S301a, it is determined that in the X axis image comparing member 411, the predetermined speed determining coefficient is one of the high, low, and middle speed determining coefficient and a fault signal in operation S302a.

When the predetermined speed determining coefficient is in the high speed mode according to the determination in the operation S302a, the X axis image comparing member 411 performs the partial search on the coordinate values including the origin and the outside of the X coordinate values in operation S303a.

The X axis image comparing member 411 generates the X axis coordinate value when the number of pixels having the same pixel value as the pixels forming the predetermined reference image is maximum, as the second motion vector coordinate value VX2 in operation S304a.

When the high speed mode is not inputted according to the determination of the operation S302a, the X axis image comparing member 411 determines which one of the high, low, and middle speed mode and the default signal is inputted in operation S305a.

If the low speed mode is inputted according to the determination of the operation S302a, the X axis image comparing member 411 performs the partial search on the coordinate values including the origin and the inside of the X coordinate values, for example, 0 and ±coordinate values, in operation S306a.

The X axis image comparing member 411 calculates the motion vector coordinate value VX2 with respect to the current preprocessed image using the same operation S307a.

When the low speed mode is not inputted according to the determination of the operation S305a, the X axis image comparing member 411 determines which one of the high, low, and middle speed mode and the default signal is inputted in operation S308a.

The Y axis image comparing member 411 calculates the motion vector coordinate value of the current preprocessed image using the same method in operation S310a.

When the X axis speed determining coefficient is the default signal according to the determination of the operation S308a, the X axis image comparing member 411 performs the full search with respect to the entire coordinate values in operation S311a.

And then, the X axis image comparing member 411 generates the X axis coordinate value when the number of pixels having the same pixel value as the pixels forming the predetermined reference image is maximum, as the second motion vector coordinate value VX2 in operation S312a.

The operation of calculating the X axis motion vector coordinate value VY2 using the partial search will be explained with reference to FIG. 27B.

The y axis image comparing member 412 receives the predetermined speed determining coefficient, such as the high, low, or middle speed determining coefficient or a fault signal, from the Y axis speed setting element of the Y axis speed setting member 432.

The Y axis image comparing member 412 generates the X axis coordinate value when the number of pixels having the same pixel value as the pixels forming the predetermined reference image is maximum, as the second motion vector coordinate value VY2.

Since the operation of calculating the Y axis motion vector coordinate value (VY2) with the current preprocessed image in the Y axis image comparing member 412 is similar to the operation of calculating the X axis motion vector coordinate value (VX2) in the image comparing member 411, the description will be omitted.

As described above, after the motion vector coordinate value is calculated through the full search and partial search, the movement coordinate calculating unit 400 compares the motion vector coordinate values and outputs the final motion vector coordinate value (VX, VY) to the interface unit S400.

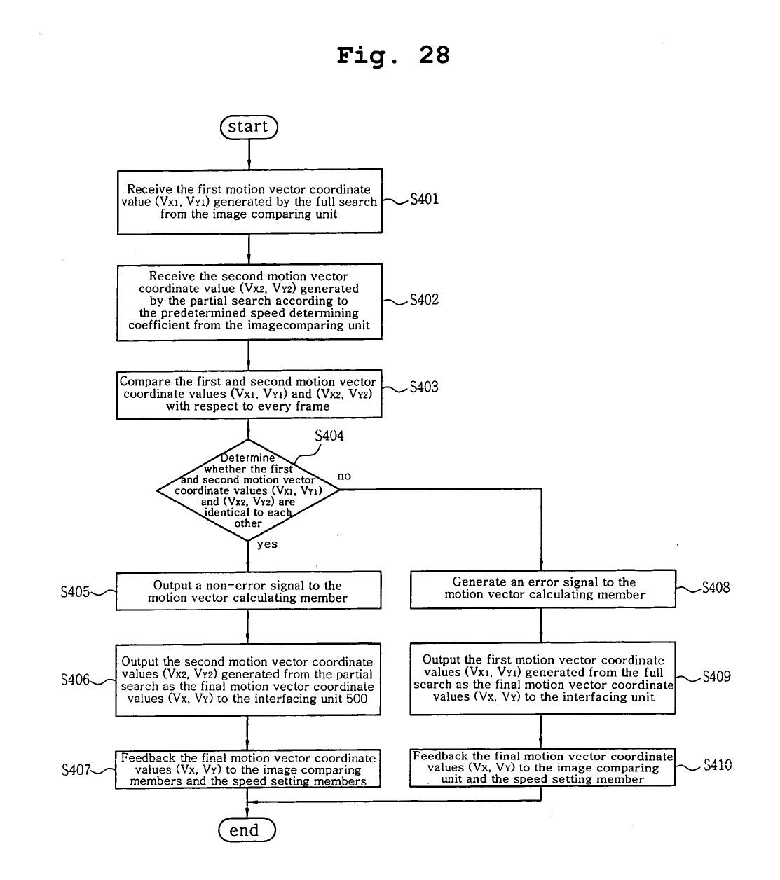

A method of calculating the final motion vector coordinate value (VX, VY) with respect to the current preprocessed image from the movement coordinate calculating unit 400 will be explained with reference to FIG. 28.

The error detecting member 423 receives the first motion vector coordinate value (VX1, VY1) generated through the full search with respect to the current preprocessed image from the image comparing unit 410 in operation 401.

At the same time, the error detecting member 423 also receives the second motion vector coordinate value (VX2, VY2) generated according to the predetermined speed determining coefficient through the partial search with respect to the current preprocessed image from the image comparing unit 410 in operation S402.

The error detecting member 423 compares the first and second motion vector coordinate values (VX1, VY1) and (VX2, VY2) with respect to every frame in operation S403 to determine whether the first and second motion vector coordinate values (VX1, VY1) and (VX2, VY2) are identical to each other with respect to a predetermined number of frames in operation S404.

When the first and second motion vector coordinate values (VX1, VY1) and (VX2, VY2) are identical to each other, and the number of times when the first and second motion vector coordinate values (VX1, VY1) and (VX2, VY2) are not identical to each other is a small number, the error detecting member 423 outputs a non-error signal to the motion vector calculating member 424 in operation S405.

When the non-error signal is generated from the error detecting member 423, the motion vector calculating member 424 outputs the second motion vector coordinate values (VX2, VY2) generated from the partial search as the final motion vector coordinate values (VX, VY) to the interfacing unit 500 in operation S406 and feedbacks the final motion vector coordinate values (VX, VY) to the image comparing members 411 and 412 and the speed setting members 431 and 432 in operation S407.

When the motion vector coordinate values are not identical with respect to the predetermined number of frames in operation S404, the error signal is generated from the error detecting member 423 to the motion vector calculating member 424 in operation 408.

When the error signal is generated from the error detecting member 423, the motion vector calculating member 424 outputs the first motion vector coordinate values (VX1, VY1) generated from the full search as the final motion vector coordinate values (VX, VY) to the interfacing unit 500 in operation S409 and feedbacks the final motion vector coordinate values (VX, VY) to the X axis and Y axis image comparing members 411 and 412 and the speed setting members 431 and 432 in operation S410.

The movement coordinate calculating unit 400 generates the speed determining coefficient of the future preprocessed image according to a history of the final motion vector coordinate values (VX, VY) in operation S500.

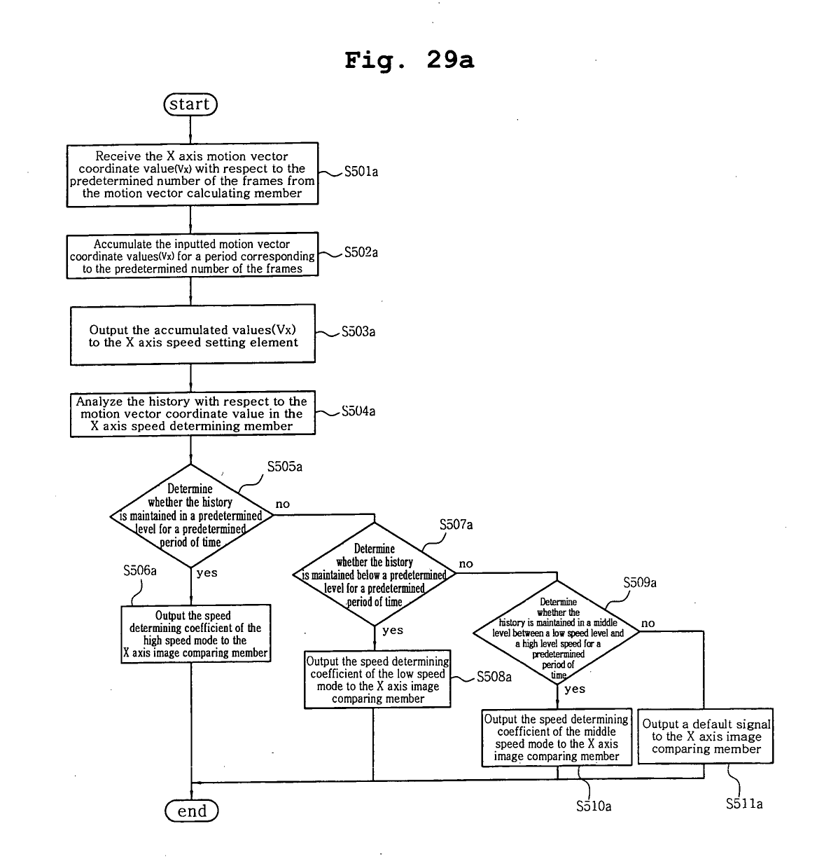

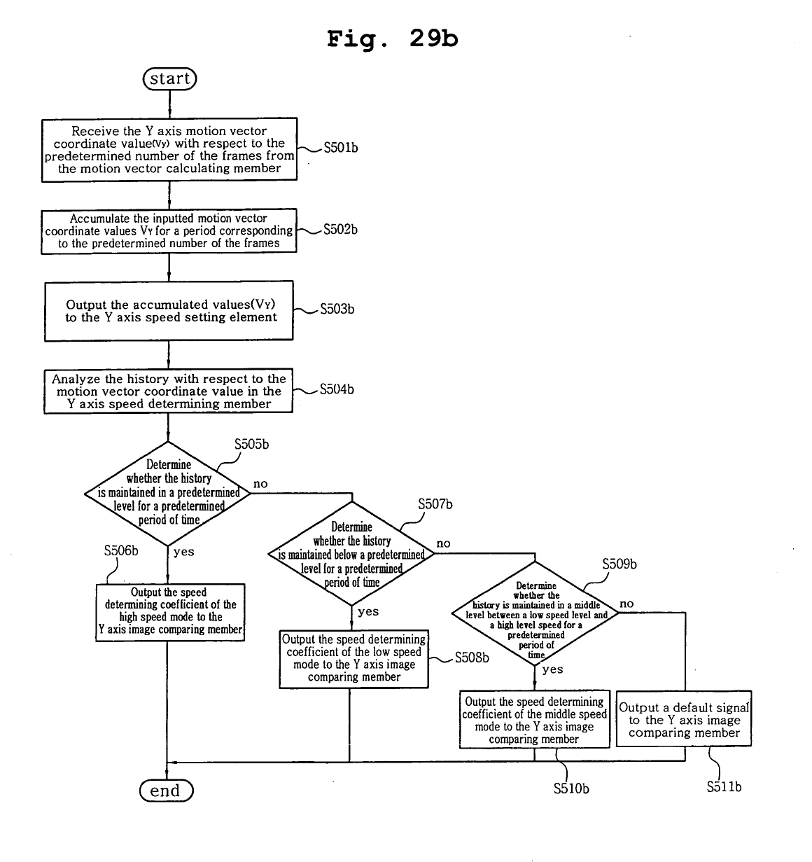

The operation of calculating the X axis speed determining coefficient of the future preprocessed image will be explained with reference to FIG. 29A.

When the X axis motion vector coordinate value VX with respect to the predetermined number of the frames is inputted from the motion vector calculating member 424 in operation S501a, the X axis speed counting element 433 accumulates the inputted motion vector coordinate values VX for a period corresponding to the predetermined number of the frames in operation S502a to output the accumulated values to the X axis speed setting element 434 of the motion vector unit 420 in operation S503a.

The X axis speed setting element 426 analyzes the history with respect to the predetermined frames in operation S504a and determines whether the history is maintained in a predetermined level for a predetermined period of time in operation S505a.

When the history is maintained in the predetermined level for a predetermined period of time in operation S505a, the X axis speed determining element 434 outputs the speed determining coefficient of the high speed mode which indicates that the future preprocessed image will exist in the outside with respect to the X axis, to the X axis image comparing member 411 in operation S506a.

When the history the history is not maintained in the predetermined level for a predetermined period of time in operation S505a, the X axis speed determining element 434 determines whether the history is maintained below a predetermined level for a predetermined period of time in operation S507a.

When the history is maintained below the predetermined level for the predetermined period of time in operation S507a, the X axis speed determining element 434 outputs the speed determining coefficient of the low speed mode which indicates that the future preprocessed image will exist in the inside with respect to the X axis, to the X axis image comparing member 411 in operation S508a.

When the history is not maintained in the predetermined level for a predetermined period of time in operation S507a, the X axis speed determining element 434 determines whether the history is maintained in a middle level between a low speed level and a high level speed for a predetermined period of time in operation S509a.

When the history is maintained in a middle level between a low speed level and a high level speed for a predetermined period of time in operation S509a, the X axis speed determining element 434 outputs the speed determining coefficient of the middle speed mode which indicates that the future preprocessed image will exist in the middle portion with respect to the X axis, to the X axis image comparing member 411 in operation S510a.

And, the X axis speed setting element 434 outputs to the X axis image comparing member 411 a default control signal indicating the future preprocessed image having no clear speed characteristic with respect to the X axis when the accumulated amount of the history is not maintained in a predetermined level for a predetermined period of time in operation S511a.

The operation of calculating the Y axis speed determining coefficient of the future preprocessed image will be explained with reference to FIG. 29B.

The Y axis speed setting element 436 receives the final motion vector coordinate value VY of the current preprocessed image with respect to the predetermined number of the frames from the motion vector counting element 435.

The Y axis speed setting element 436 generates the speed determined coefficient of the future preprocessed image by analyzing the history of the final motion vector coordinate value VY of the current preprocessed image.

Here, since the method of calculating the Y axis speed determining coefficient with respect to the future preprocessed image in the Y axis speed setting element 436 shown in FIG. 29B is similar to the method of calculating the X axis speed determining coefficient with respect to the future preprocessed image in the X axis speed setting element 434 shown in FIG. 29A, the explanation of this method will be omitted.

The movement coordinate calculating unit 400 stores the reference image in the X channel/Y channel reference element according to the amount of movement of the final motion vector coordinate value (VY, VY) in operation 600.

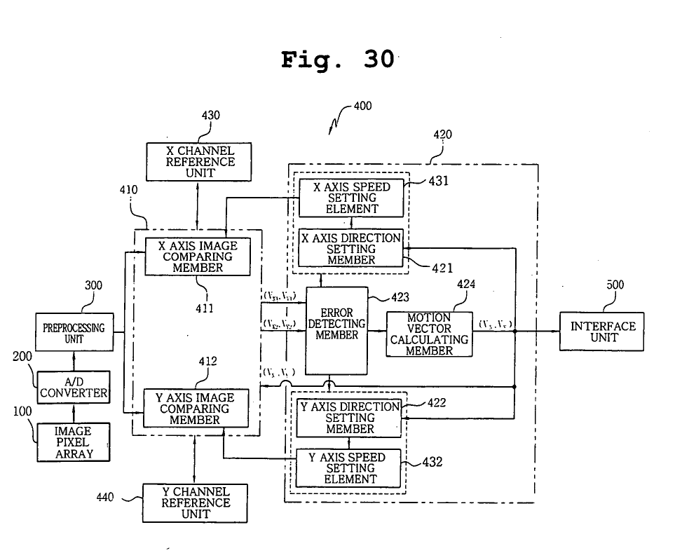

Since the operation 600 of FIG. 29B is similar to the operation shown in FIG. 29A, the explanation of this method will be also omitted. An optical sensing apparatus and a method to navigate a position according to another embodiment of the present invention are described in more detail with reference to FIGS. 30-36.

Referring to FIG. 30, the optical sensing apparatus to navigate a position according to another embodiment of the present invent will be explained hereinafter.

The optical sensing apparatus includes an image pixel array 100, an A/D converter unit 200, a preprocessing unit 300, a movement coordinate calculating unit 400, and an interface unit 500 to calculate the final motion vector coordinate value (VX, VY) of the current preprocessed image through a partial search according to a predetermined direction/speed determining coefficient and a full search on the current preprocessed image, and to calculate the speed/speed determining coefficient of a future preprocessed image according to a history of the final motion vector coordinate value (VX, VY).

Since the structure and the operation of the image pixel array 100, the A/D converter unit 200, the preprocessing unit 300, and the interface unit 400 of this embodiment are similar to the embodiment shown in FIGS. 3, 4, and 18, detail descriptions will be omitted.

The movement coordinate calculating unit 400 performs a full search to overlap a predetermined reference image with an entire area of the current preprocessed image or performs a partial search on a particular coordinate value corresponding to the predetermined speed determining coefficient to generate a first motion vector coordinate value (VX1, VY1) and a second motion vector coordinate value (VX2, VY2), respectively, and to generate a motion vector coordinate value (VX, VY) of the current preprocessed image from the first motion vector coordinate value (VX1, VY1) and the second motion vector coordinate value (VX2, VY2).

The movement coordinate calculating unit 400 includes an image comparing unit 410, a motion vector unit 420, an X channel reference unit 430, a Y channel reference unit 440 to calculate the direction/speed determining coefficient of the future preprocessed image according to the history of the calculated motion vector coordinate value obtained through the full and partial search.

The direction/speed determining coefficient of the future preprocessed image is calculated according to the history of the motion vector coordinate values of a precious preprocessed frame, such as a current preprocessed frame.

The image comparing unit 410 includes an X axis image comparing member 411 and a Y axis image comparing member 412 as shown in FIG. 30, to perform the full search or the partial search with respect to the current preprocessed image by overlapping the predetermined reference image with an entire or partial area of the current preprocessed image. Here, the X axis image comparing member 411 performs the full search of the current preprocessed image with respect to the entire X axis coordinate values to generate the X axis motion vector coordinate values (VX1) of the current preprocessed image.

The X axis image comparing member 411 also performs the partial search with respect to the X axis coordinate values corresponding to the direction and speed determining coefficient inputted from the direction setting member 421 and the speed setting member 431 of the motion vector unit 420 to generate the X axis motion vector coordinate value (VX2).

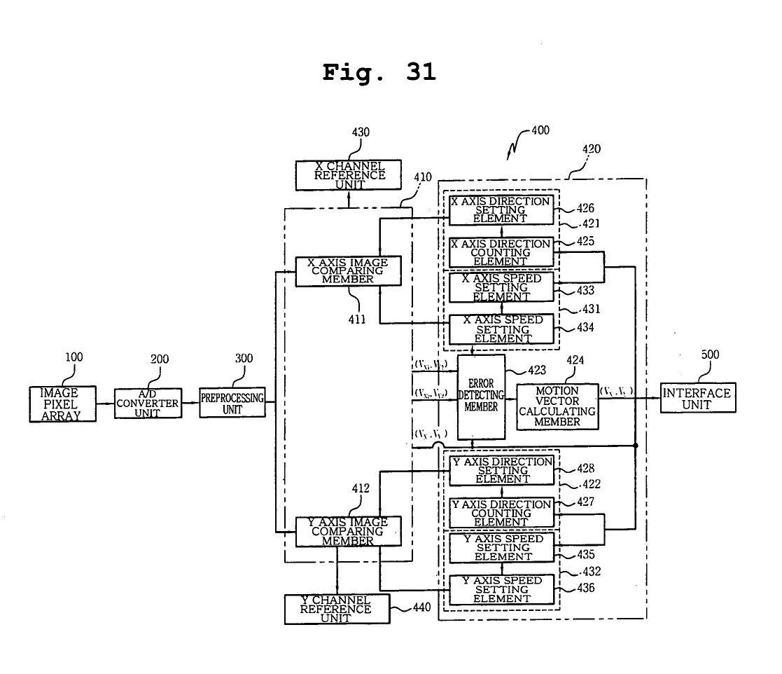

Referring to FIG. 31, when the (+) direction determining coefficient is inputted from the X axis direction setting element 426, the X axis image comparing member 411 performs the partial search with respect to a predetermined portion of the X axis coordinate values according to the speed determining coefficient inputted from the X axis speed setting member 434.

That is, when the speed determining coefficient inputted from the X axis speed setting element 434 is in a high speed mode, The X axis image comparing member 411 generates the X axis motion vector coordinate value (VX2) by performing the partial search with respect to the common coordinate values of right side coordinate values and outside coordinate values along the X axis coordinate values.

In addition, when the speed determining coefficient inputted from the X axis speed setting element 434 is in a low speed mode, the X axis image comparing member 411 generates the X axis motion vector coordinate value (VX2) by performing the partial search with respect to the common coordinate values of the right side coordinate values and inside coordinate values along the X axis coordinate values.

When the speed determining coefficient inputted from the X axis speed setting element 434 is in a middle speed mode, The X axis image comparing member 411 generates the X axis motion vector coordinate value (VX2) by performing the partial search with respect to the common coordinate values of the right side coordinate values and middle coordinate values along the X axis coordinate values.

If the speed determining coefficient inputted from the X axis speed setting element 434 is a default signal of a default mode, The X axis image comparing member 411 generates the X axis motion vector coordinate value (VX2) by performing the partial search with respect to the right side coordinate values along the X axis coordinate values.

When the (−) direction determining coefficient is inputted from the X axis direction setting element 426, the X axis image comparing member 411 performs the partial search with respect to particular X axis coordinate values corresponding to the speed determining coefficient inputted form the X axis speed setting element 434 of the motion vector unit 420.

That is, when the speed determining coefficient inputted from the X axis speed setting element 434 is in the high speed mode, the X axis image comparing member 411 performs the partial search with respect to the common coordinate values of the left side coordinate values and the outside coordinate values along the X axis coordinate values to generate the S axis motion vector coordinate value (VX2).

In contrast, when the, speed determining coefficient inputted from the X axis speed setting element 434 is in the low speed mode, the X axis image comparing member 411 performs the partial search with respect to the common coordinate values of the left side coordinate values and the inside coordinate values along the X axis coordinate values to generate the S axis motion vector coordinate value (VX2).

In addition, when the speed determining coefficient inputted from the X axis speed setting element 434 is in a middle speed mode, the X axis image comparing member 411 generates the X axis motion vector coordinate value (VX2) by performing the partial search with respect to the common coordinate values of the left side coordinate values and the middle coordinate values along the X axis coordinate values.

If the speed determining coefficient inputted from the X axis speed setting element 434 is the default signal of the default mode, The X axis image comparing member 411 generates the X axis motion vector coordinate value (VX2) by performing the partial search with respect to the left side coordinate values along the X axis coordinate values.

If the speed determining coefficient inputted from the X axis speed setting element 434 is the default signal of the default mode, and the direction determining coefficient inputted from the X axis direction setting element 426, the X axis image comparing member 411 generates the X axis motion vector coordinate value (VX2) by performing the full search with respect to the entire X axis coordinate values.

The Y axis image comparing member 412 performs the full search of the current preprocessed image with respect to the entire Y axis coordinate values to generate the Y axis motion vector coordinate values (VY1) of the current preprocessed image.

The Y axis image comparing member 412 also performs the partial search with respect to the Y axis coordinate values corresponding to the direction and speed determining coefficient inputted from the Y axis direction setting element 428 and the speed setting element 436 of the motion vector unit 420 to generate the Y axis motion vector coordinate value (VY2).

Referring to FIG. 31, when the (+) direction determining coefficient is inputted from the Y axis direction setting element 428, the Y axis image comparing member 412 performs the partial search with respect to a predetermined portion of the Y axis coordinate values according to the speed determining coefficient inputted from the Y axis speed setting element 436.

That is, when the speed determining coefficient inputted from the Y axis speed setting element 436 is in the high speed mode, the Y axis image comparing member 412 generates the Y axis motion vector coordinate value (VY2) by performing the partial search with respect to the common coordinate values of upper side coordinate values and outside coordinate values along the Y axis coordinate values.

In addition, when the speed determining coefficient inputted from the Y axis speed setting element 436 is in the low speed mode, the Y axis image comparing member 412 generates the Y axis motion vector coordinate value (VY2) by performing the partial search with respect to the common coordinate values of the upper side coordinate values and inside coordinate values along the Y axis coordinate values.

When the speed determining coefficient inputted from the Y axis speed setting element 436 is in the middle speed mode, the Y axis image comparing member 412 generates the Y axis motion vector coordinate value (VY2) by performing the partial search with respect to the common coordinate values of the upper side coordinate values and middle coordinate values along the Y axis coordinate values.

If the speed determining coefficient inputted from the Y axis speed setting element 436 is the default signal of the default mode, the Y axis image comparing member 412 generates the Y axis motion vector coordinate value (VY2) by performing the partial search with respect to the upper side coordinate values along the Y axis coordinate values.

When the (−) direction determining coefficient is inputted from the Y axis direction setting element 428, the Y axis image comparing member 412 performs the partial search with respect to particular Y axis coordinate values corresponding to the speed determining coefficient inputted from the Y axis speed setting element 436 of the motion vector unit 420.

That is, when the speed determining coefficient inputted from the Y axis speed setting element 436 is in the high speed mode, the Y axis image comparing member 412 performs the partial search with respect to the common coordinate values of the lower side coordinate values and the outside coordinate values along the Y axis coordinate values to generate the Y axis motion vector coordinate value (VY2).

In contrast, when the speed determining coefficient inputted from the Y axis speed setting element 436 is in the low speed mode, the Y axis image comparing member 412 performs the partial search with respect to the common coordinate values of the lower side coordinate values and the inside coordinate values along the Y axis coordinate values to generate the Y axis motion vector coordinate value (VY2).

In addition, when the speed determining coefficient inputted from the Y axis speed setting element 436 is in the middle speed mode, the Y axis image comparing member 412 generates the Y axis motion vector coordinate value (VY2) by performing the partial search with respect to the common coordinate values of the lower side coordinate values and the middle coordinate values along the Y axis coordinate values.

If the speed determining coefficient inputted from the Y axis speed setting element 434 is the default signal of the default mode, the Y axis image comparing member 412 generates the Y axis motion vector coordinate value (VY2) by performing the partial search with respect to the lower side coordinate values along the Y axis coordinate values.

If the speed determining coefficient inputted from the Y axis speed setting element 436 is the default signal of the default mode, and the direction determining coefficient inputted from the Y axis direction setting element 428, the Y axis image comparing member 412 generates the Y axis motion vector coordinate value (VY2) by performing the full search with respect to the entire Y axis coordinate values.

The motion vector unit 420 generates one of the first motion vector coordinate value (VX1, VY1) generated by the full search and the second motion vector coordinate value (VX2, VY2) generated by the partial search as the final motion vector coordinate value (VX, VY) with respect to the current preprocessed image, according to the error signal.

The motion vector unit 42 includes an X direction determining member 421, a Y axis direction determining member 422, an X speed determining member 431, a Y axis speed determining member 432, an error detecting member 423, and a motion vector calculating member 424, as shown in FIG. 31, to calculate (generate) a speed determining coefficient with respect to a preprocessed image of a future preprocessed image according to a history of the motion vector coordinate value (VX, VY) calculated by the partial or full search.

The X axis direction determining member 421 includes an X axis direction counting element 425 and an X axis direction setting element 426 to calculate the X axis direction determining coefficient according to a history of the motion vector coordinate value (VX) feedback from the motion vector calculating member 424.

The X axis direction determining element 426 generates (+) direction determining coefficient when the history of the X axis motion vector coordinate value (VX) accumulated in the X axis direction counting element 425 corresponds to the right side coordinate values including the origin with respect to the X axis coordinates, (−) direction determining coefficient when the history of the X axis motion vector coordinate value (VX) accumulated in the X axis direction counting element 425 corresponds to the left side coordinate values including the origin with respect to the X axis coordinates, and the default signal when there is no particular direction.

The Y axis direction determining member 422 includes a Y axis direction counting element 427 and a Y axis direction setting element 428 to calculate the Y axis direction determining coefficient according to a history of the motion vector coordinate value (VY) feedback from the motion vector calculating member 424.

The Y axis direction determining element 428 generates (+) direction determining coefficient when the history of the Y axis motion vector coordinate value (VY) accumulated in the Y axis direction counting element 427 corresponds to the upper side coordinate values including the origin with respect to the Y axis coordinates, (−) direction determining coefficient when the history of the X axis motion vector coordinate value (VX) accumulated in the X axis direction counting element 425 corresponds to the lower side coordinate values including the origin with respect to the X axis coordinates, and the default signal when there is no particular direction.

The X axis speed determining member 431 includes an X speed counting element 433 and an X axis speed setting element 434 to calculate the X axis speed determining coefficient according to a history of the motion vector coordinate value (VX) feedback from the motion vector calculating member 424.

Here, the X axis speed counting element 434 generates the high speed determining coefficient when the history of the X axis motion vector coordinate value (VX) accumulated in the X axis speed counting element 433 is generated from the outside coordinate values with respect to the X axis coordinates, the low speed determining coefficient in a case of the inside coordinate values, the middle speed determining coefficient in a case of the middle coordinate values, and default signal in a case that the history is not maintained in a predetermined level.

The Y axis speed determining member 432 includes a Y speed counting element 435 and a Y axis speed setting element 436 to calculate the Y axis speed determining coefficient according to a history of the motion vector coordinate value (VY) feedback from the motion vector calculating member 424.

Here, the Y axis speed counting element 436 generates the high speed determining coefficient when the history of the Y axis motion vector coordinate value (VY) accumulated in the Y axis speed counting element 435 is generated from the upper side coordinate values with respect to the Y axis coordinates, the low speed determining coefficient in a case of the lower side coordinate values, the middle speed determining coefficient in a case of the middle coordinate values, and default signal in a case that the history is not maintained in a predetermined level.

The error detecting member 423 receives the first motion vector coordinate value (VX1, VY1) generated through the full search and the second motion vector coordinate value (VX2, VY2) generated through the partial search, compares the first motion vector coordinate value (VX1, VY1) with the second motion vector coordinate value (VX2, VY2) in every frame, and generates an error signal when the motion vector coordinate values with respect to a predetermined frame are not identical to each other at least three times, thereby setting the direction setting members 421 and 422 and the speed setting members 431 and 432 in the default mode.

When the direction determining coefficient and the speed determining coefficient are in the default mode in the error detecting member 423, the image comparing unit 410 performs the full search on the entire coordinates with respect to the current preprocessed image to generate the final motion vector coordinate value (VX, VY).

In a case that the error signal is not detected in the error detecting member 423, the motion vector calculating member 424 outputs the second motion vector coordinate value (VX2, VY2) generated through the partial search as the final motion vector coordinate value (VX, VY) with respect to the current preprocessed image, to the interface unit 500.

In a case that the error signal is detected in the error detecting member 423, the motion vector calculating member 424 outputs the first motion vector coordinate value (VX1, VY1) generated through the full search as the final motion vector coordinate value (VX, VY) with respect to the current preprocessed image, to the interface unit 500

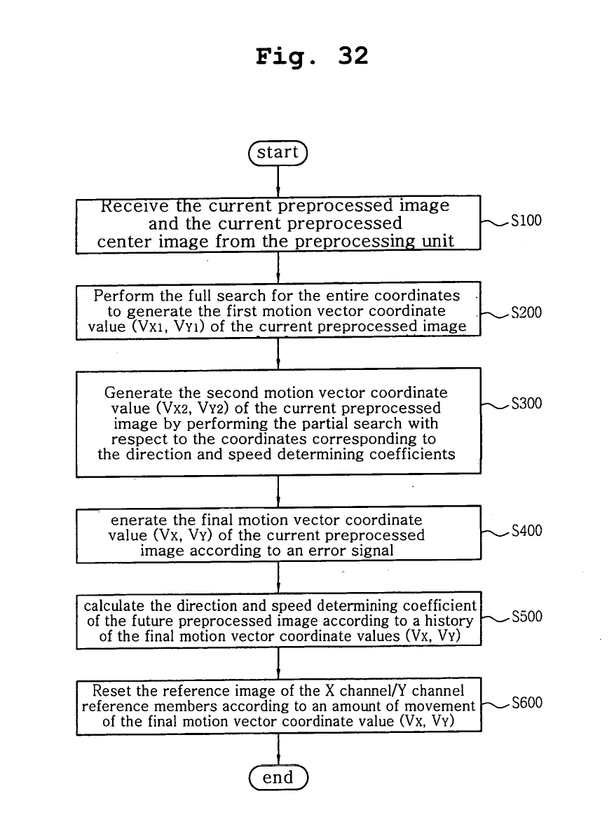

An optical sensing method of navigating a position according to another embodiment of the present invention is described in more detail with reference to FIGS. 32-36.

The movement coordinate calculating unit 400 receives the current preprocessed image and the current preprocessed center image from the preprocessing unit 300 in operation S100.

The operation S100 is similar to the operation shown in FIG. 12. Therefore, detail description of the operation S100 will be omitted.

The movement S100 performs the full search for the entire coordinates to generate the first motion vector coordinate value (VX1, VY1) of the current preprocessed image in operation S200.

The operation S200 is similar to the operation shown in FIG. 13. Therefore, detail description of the operation S200 will be omitted.

As described above, in addition to the first motion vector coordinate value (VX1, VY1) of the current preprocessed image, the movement coordinate calculating unit 400 generates the second motion vector coordinate value (VX2, VY2) of the current preprocessed image by performing the partial search with respect to the coordinates corresponding to the direction and speed determining coefficients of the X axis and the Y axis in the operation S300.

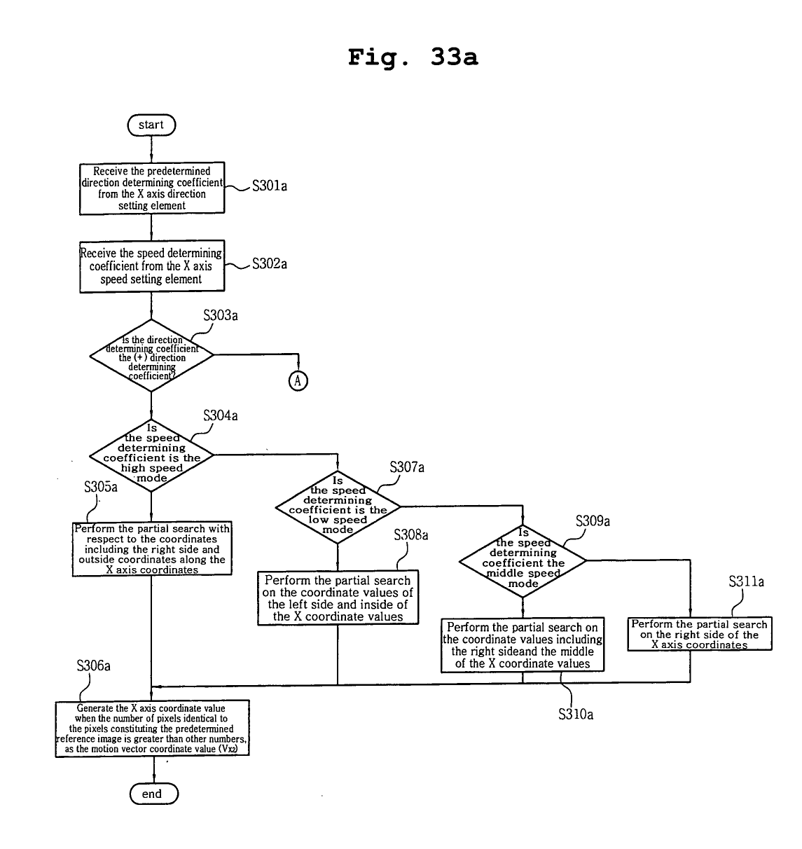

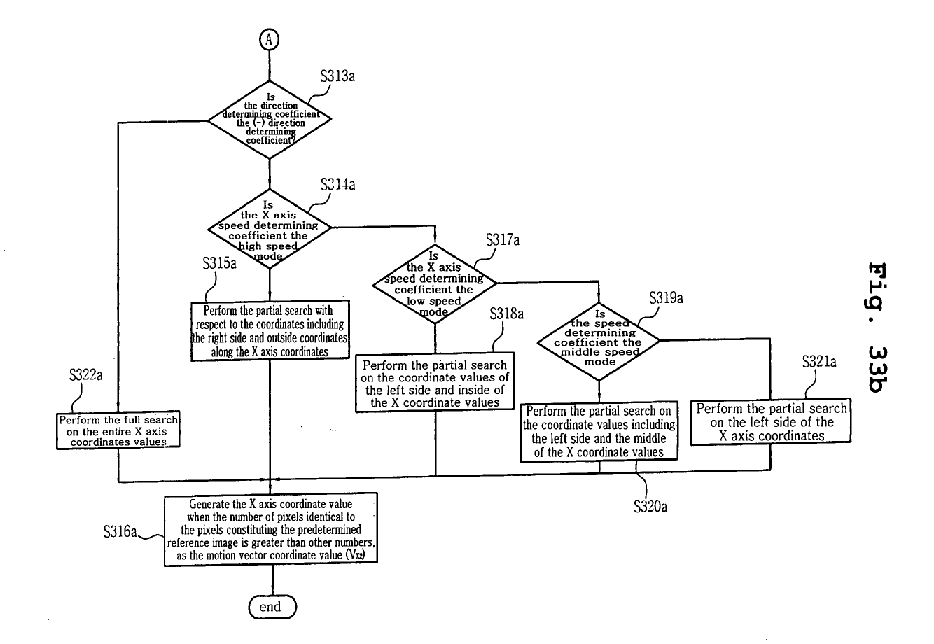

Referring to FIG. 33 (33a and 33b), the operation of calculating the X axis motion vector coordinate value (VX) using the partial search with respect to the common coordinate values of the X axis direction and speed determining coefficients will be explained hereinafter.

The X axis image comparing member 411 receives the predetermined direction determining coefficient from the X axis direction setting element 426 of the motion vector unit 420 in operation S301a.

The X axis image comparing member 411 receives the predetermined direction determining coefficient from the X axis direction setting element 426 and simultaneously receives the speed determining coefficient from the X axis speed setting element 434 in operation S302a.

The X axis image comparing member 411 determines whether the direction determining coefficient is the (+) direction determining coefficient in operation S303a.

When the direction determining coefficient is the (+) direction determining coefficient in operation S303a, the X axis image comparing member 411 determines whether the speed determining coefficient is one of the high speed mode, the low speed mode, the middle speed mode, and the default mode in operation S304a.

When the speed determining coefficient is the high speed mode, the X axis image comparing member 411 performs the partial search with respect to the coordinates including the right side coordinates and the outside coordinates along the X axis coordinates in operation S305a.

And then, the X axis image comparing member 411 generates the X axis coordinate value when the number of pixels identical to the pixels constituting the predetermined reference image is greater than other number, as the motion vector coordinate value (VX2) in operation S306a.

When the high speed mode is not inputted according to the determination of the operation S304a, the X axis image comparing member 411 determines whether the speed determining coefficient is one of the low speed mode, the middle speed mode and the default signal in operation S307a.

If the low speed mode is inputted according to the determination of the operation S307a, the X axis image comparing member 411 performs the partial search on the coordinate values including the origin and the left side and inside of the X coordinate values in operation S308a.

The X axis image comparing member 411 generates the motion vector coordinate value VX2 with respect to the current preprocessed image using the same method as the operation S306a in operation S310a.

When the low speed mode is not inputted according to the determination of the operation S307a, the X axis image comparing member 411 determines whether the speed determining coefficient is one of the middle speed mode and the default signal in operation S309a.

When the speed determining coefficient is one of the middle speed mode and the default signal in operation S309a, the X axis image comparing member 411 performs the partial search on the coordinate values including the right side and the middle of the X coordinate values in operation S310a.

The X axis image comparing member 411 generates the motion vector coordinate value of the current preprocessed image using the same method as the operation S304a.

When the speed determining coefficient is the default signal in operation S309a, the X axis image comparing member 411 performs the partial search on the right side including the origin of the X axis coordinates in operation S311a.

And then, the X axis image comparing member 411 generates the X axis coordinate value when the number of pixels identical to the pixels constituting the predetermined reference image is greater than other number, as the motion vector coordinate value (VX).

If the direction determining coefficient is not the (+) direction determining coefficient in operation S303a, the X axis image comparing member 411 determines whether the X axis direction determining coefficient is the (−) direction determining coefficient in operation S313a.

When the X axis direction determining coefficient is the (−) direction determining coefficient in operation S313a, the X axis image comparing member 411 determines whether the speed determining coefficient inputted from the X axis speed setting element 434 is one of the high speed mode, the low speed mode, the middle speed mode, and the default mode in operation S314a, as shown in FIG. 33b.

When the speed determining coefficient is the high speed mode in the operation S314a, the X axis image comparing member 411 performs the partial search with respect to the coordinates including the left side coordinates and the outside coordinates along the X axis coordinates in operation S315a.

And then, the X axis image comparing member 411 generates the X axis coordinate value when the number of pixels identical to the pixels constituting the predetermined reference image is greater than other number, as the motion vector coordinate value (VX2) in operation S316a.

When the high speed mode is not inputted according to the determination of the operation S314a, the X axis image comparing member 411 determines whether the speed determining coefficient is the low speed mode in operation S317a.

If the low speed mode is inputted according to the determination of the operation S317a, the X axis image comparing member 411 performs the partial search on the coordinate values including the origin and the left side and inside of the X coordinate values in operation S318a.

The X axis image comparing member 411 generates the motion vector coordinate value VX2 with respect to the current preprocessed image using the same method as the operation S316a.

When the low speed mode is not inputted according to the determination of the operation S317a, the X axis image comparing member 411 determines whether the speed determining coefficient is the middle speed mode in operation S319a.

When the speed determining coefficient is the middle speed mode in operation S319a, the X axis image comparing member 411 performs the partial search on the coordinate values including the right side and the middle of the X coordinate values in operation S320a.

The X axis image comparing member 411 generates the motion vector coordinate value VX2 of the current preprocessed image using the same method as the operation S316a.

When the speed determining coefficient is the default signal in operation S319a, the X axis image comparing member 411 performs the partial search on the right side including the origin of the X axis coordinates in operation S321a.

The X axis image comparing member 411 generates the motion vector coordinate value VX2 of the current preprocessed image using the same method as the operation S316a.

If the direction determining coefficient is the default signal, the X axis image comparing member 411 performs the full search on the entire X axis coordinate values in operation S323a.

And then, the X axis image comparing member 411 generates the X axis coordinate value when the number of pixels identical to the pixels constituting the predetermined reference image is greater than other number, as the motion vector coordinate value (VX2).

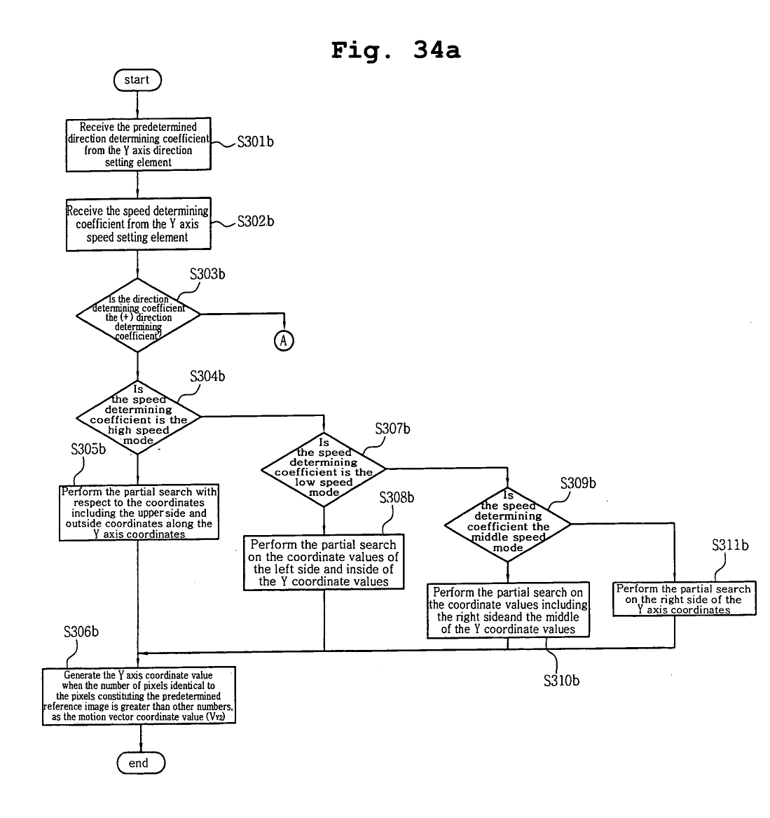

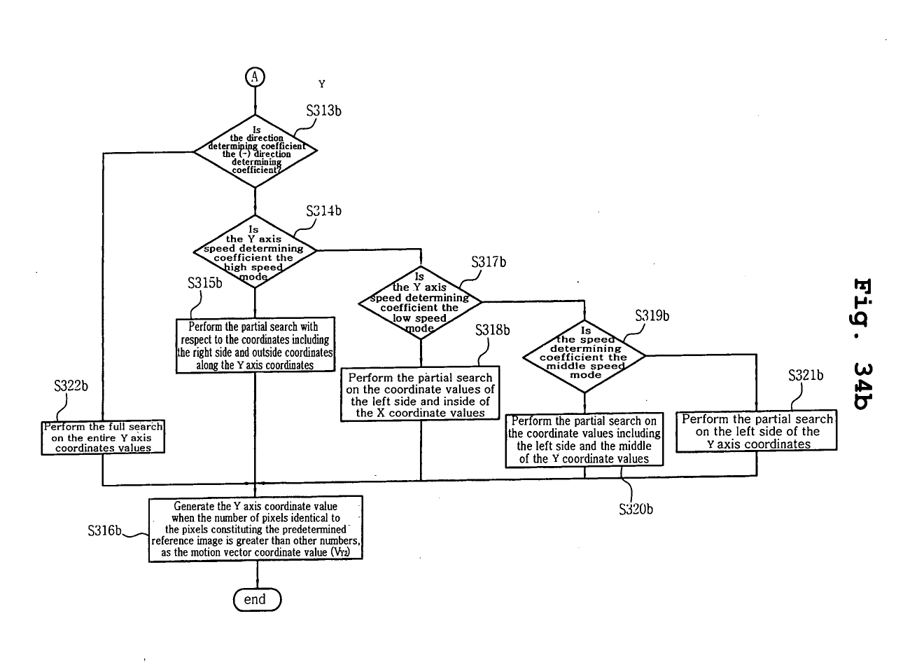

The operation of generating the Y axis motion vector coordinate value VY2 through the partial search on the common coordinate values of the Y axis direction and speed determining coefficients will be explained with-reference to FIG. 34 (34a and 34b).

The Y axis image comparing member 412 receives the predetermined direction determining coefficient from the Y axis direction setting element 428 of the motion vector unit 420 in operation S301b.

The Y axis image comparing member 412 receives the direction determining coefficient from the Y axis direction setting element 428 and the speed determining coefficient from the Y axis speed determining coefficient from the Y axis speed setting element 436 in operation S302b.

The Y axis image comparing member 412 determines whether the direction determining coefficient is the (+) direction determining coefficient in operation S303b.

When the direction determining coefficient is the (+) direction determining coefficient in operation S303b, the Y axis image comparing member 412 determines whether the speed determining coefficient is one of the high speed mode, the low speed mode, the middle speed mode, and the default mode in operation S304b.

When the speed determining coefficient is the high speed mode, the Y axis image comparing member 412 performs the partial search with respect to the coordinates including the upper side coordinates and the outside coordinates along the Y axis coordinates in operation S305b.

And then, the Y axis image comparing member 412 generates the Y axis coordinate value when the number of pixels identical to the pixels constituting the predetermined reference image is greater than other number, as the motion vector coordinate value (VY2) in operation S306b.

When the speed determining coefficient is not the high speed mode according to the determination of the operation S304b, the Y axis image comparing member 412 determines whether the speed determining coefficient is one of the low speed mode, the middle speed mode and the default signal in operation S307b.

If the speed determining coefficient is the low speed mode according to the determination of the operation S307b, the Y axis image comparing member 412 performs the partial search on the coordinate values including the origin and the lower side and inside of the Y coordinate values in operation S308b.

The Y axis image comparing member 412 generates the motion vector coordinate value VY2 with respect to the current preprocessed image using the same method as the operation S306b in operation S310b.

When the speed determining coefficient is not the low speed mode according to the determination of the operation S307b, the Y axis image comparing member 412 determines whether the speed determining coefficient is one of the middle speed mode and the default signal in operation S309b.

When the speed determining coefficient is one of the middle speed mode and the default signal in operation S309b, the Y axis image comparing member 412 performs the partial search on the coordinate values including the upper side and the middle of the Y coordinate values in operation S310b.

The Y axis image comparing member 412 generates the motion vector coordinate value of the current preprocessed image using the same method as the operation S304b.

When the speed determining coefficient is the default signal in operation S309b, the Y axis image comparing member 412 performs the partial search on the upper side including the origin of the Y axis coordinates in operation S311b.

And then, the Y axis image comparing member 412 generates the Y axis coordinate value when the number of pixels identical to the pixels constituting the predetermined reference image is greater than other number, as the motion vector coordinate value (VY).

If the direction determining coefficient is not the (+) direction determining coefficient in operation S303a, the X axis image comparing member 411 determines whether the X axis direction determining coefficient is the (−) direction determining coefficient in operation S313a.

When the Y axis direction determining coefficient is the (−) direction determining coefficient in operation S313b, the Y axis image comparing member 412 determines whether the speed determining coefficient inputted from the Y axis speed setting member 432 is one of the high speed mode, the low speed mode, the middle speed mode, and the default mode in operation S314b, as shown in FIG. 34b.

When the speed determining coefficient is the high speed mode in the operation S314b, the X axis image comparing member 412 performs the partial search with respect to the coordinates including the lower side coordinates and the outside coordinates along the Y axis coordinates in operation S315b.

And then, the Y axis image comparing member 412 generates the Y axis coordinate value when the number of pixels identical to the pixels constituting the predetermined reference image is greater than other number, as the motion vector coordinate value (VY2) in operation S316b.

When the high speed mode is not inputted according to the determination of the operation S314b, the Y axis image comparing member 412 determines whether the speed determining coefficient is the low speed mode in operation S317b.

If the low speed mode is inputted according to the determination of the operation S317b, the Y axis image comparing member 412 performs the partial search on the coordinate values including the origin and the lower side and inside of the X coordinate values in operation S318b.

The Y axis image comparing member 412 generates the motion vector coordinate value VY2 with respect to the current preprocessed image using the same method as the operation S316b.

When the low speed mode is not inputted according to the determination of the operation S317b, the Y axis image comparing member 412 determines whether the speed determining coefficient is the middle speed mode in operation S319b.

When the speed determining coefficient is the middle speed mode in operation S319b, the Y axis image comparing member 412 performs the partial search on the coordinate values including the lower side and the middle of the Y coordinate values in operation S320b.

The Y axis image comparing member 412 generates the motion vector coordinate value VY2 of the current preprocessed image using the same method as the operation S316b.

When the speed determining coefficient is the default signal in operation S319b, the Y axis image comparing member 412 performs the partial search on the upper side including the origin of the Y axis coordinates in operation S321b.

The Y axis image comparing member 412 generates the motion vector coordinate value VY2 of the current preprocessed image using the same method as the operation S316b.

If the direction determining coefficient is the default signal, the X axis image comparing member 412 performs the full search on the entire Y axis coordinate values in operation S322b.

And then, the Y axis image comparing member 412 generates the Y axis coordinate value when the number of pixels identical to the pixels constituting the predetermined reference image is greater than other number, as the motion vector coordinate value (VY2).

As described above, after the motion vector coordinate value of the current preprocessed image is obtained by performing the full and partial search with respect to the current preprocessed image, the movement coordinate calculating unit 40 generates the final motion vector coordinate value (VX, VY) of the current preprocessed image by comparing the motion vector coordinate values with each other in operation 400.

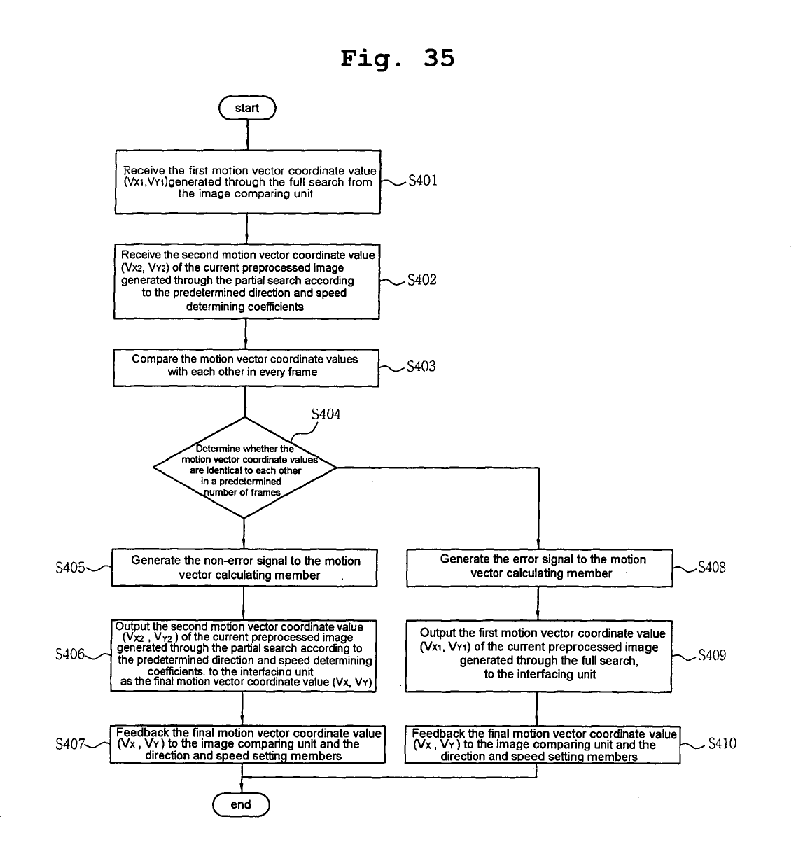

Referring to FIG. 35, the error detecting member 423 receives the first motion vector coordinate value (VX1, VY1) generated through the full search with respect to the current preprocessed image in operation S401.

The error detecting member 423 also receives the second motion vector coordinate value (VX2, VY2) of the current preprocessed image generated through the partial search according to the predetermined direction and speed determining coefficients in operation S402.

The error detecting member 423 compares the motion vector coordinate values with each other in every frame in operation S403, the error detecting member 423 determines whether the motion vector coordinate values are identical to each other in a predetermined number of frames in operation S404.

If the motion vector coordinate values are identical to each other, or if the number of times when the motion vector coordinate values are not identical to each other is less than a reference number, the error detecting member 423 generates the non-error signal to the motion vector calculating member 424 in operation S405.

When the non-error signal is inputted from the error detecting element 434, the motion vector calculating member 424 outputs the second motion vector coordinate value (VX2, VY2) of the current preprocessed image generated through the partial search according to the predetermined direction and speed determining coefficients, to the interfacing unit 500 as the final motion vector coordinate value (VX, VY) in operation S406, and simultaneously feedbacks the final motion vector coordinate value (VX, VY) to the image comparing unit 410 and the direction and speed setting members 421 and 422 in operation S407.

If the number of times when the motion vector coordinate values are not identical to each other is more than the reference number, the error detecting member 423 generates the error signal to the motion vector calculating member 424 in operation S408.

When the error signal is inputted from the error detecting element 434, the motion vector calculating member 424 outputs the first motion vector coordinate value (VX1, VY1) of the current preprocessed image generated through the full search, to the interfacing unit 500 as the final motion vector coordinate value (VX, VY) in operation S406, and simultaneously feedbacks the final motion vector coordinate value (VX, VY) to the image comparing unit 410 and the direction and speed setting members 421 and 422 in operation S409.

After the final motion vector coordinate value (VX, VY) of the current preprocessed image is calculated, the movement coordinate calculating unit 400 analyzes the history of the final motion vector coordinate value (VX, VY) to the direction and speed determining coefficients for the future preprocessed image in operation 500.

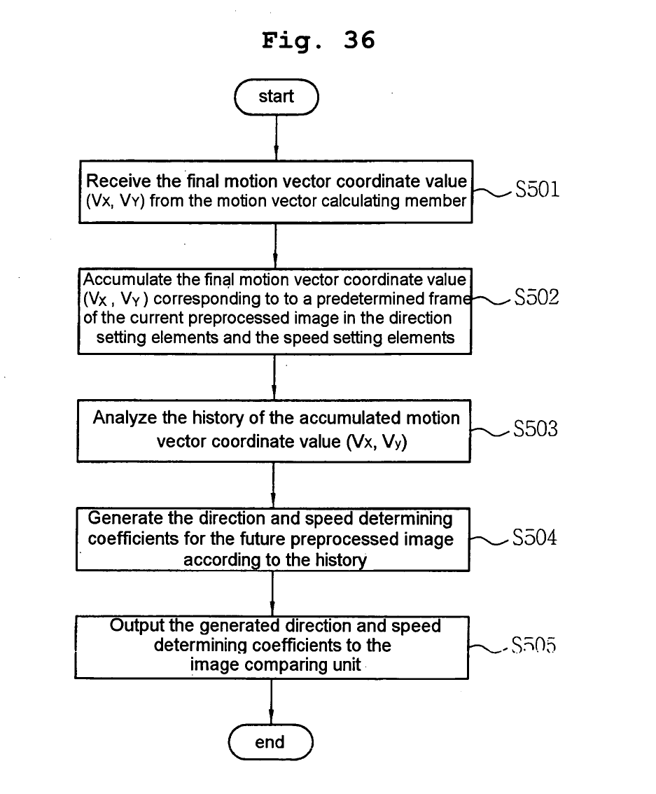

Referring FIG. 36, when the final motion vector coordinate value (VX, VY) of the current preprocessed image is inputted from the motion vector calculating member 424 in operation S501, the direction counting elements 425 and 427 and the speed counting elements 426 and 428 accumulate the final motion vector coordinate value (VX, VY) and outputs the accumulated results to the direction setting elements 426 and 428 and the speed setting elements 434 and 436 in operation 502.

The direction setting elements 426 and 428 and the speed setting elements 434 and 436 analyze the history of the accumulated motion vector coordinate value VX or Vy in operation S503, generate the direction and speed determining coefficients for the future preprocessed image according to the history in operation S504, and output the generated direction and speed determining coefficients to the image comparing unit 410 in operation S505.

The operation S504 of calculating the direction determining coefficient is the same as the operation shown in FIGS. 16a and 16b. Also, the operation S504 of calculating the speed determining coefficient is the same as the operation shown in FIGS. 29a and 29b. When the final motion vector coordinate value (VX, VY) of the current preprocessed image is feedback to the motion vector unit 400, the image comparing unit 410 sets the reference image in the X channel/Y channel reference unit according to the movement amount of the motion vector coordinate value (VX, VY).

The operation S600 is similar to the operation shown in FIG. 17. Therefore, detailed description will be omitted.

As described above, according to the optical sensing apparatus to navigate a position and a method using the same according to embodiments of the present invention, the motion vector coordinate value for the current and future preprocessed images is calculated by performing the full search to overlap the predetermined reference image and the entire area of the current preprocessed image and by performing the partial search with respect to the particular coordinate values corresponding to the direction and speed determining coefficients, thereby reducing the error generating possibility to accurately navigate a position with respect to the current and future preprocessed images.

Although a few embodiments of the present invention have been shown and described, it will be appreciated by those skilled in the art that changes may be made in these embodiments without departing from the principles and spirit of the invention, the scope of which is defined in the appended claims and equivalents thereof.

1. An optical sensing apparatus to navigate a position, comprising:
an image pixel array having a plurality of pixels to convert light energy into an analog voltage value;
an A/D converter unit to the analog voltage value received from respective pixel into a digital voltage value;
a preprocessing unit to preprocess the digital voltage value to generate a current preprocessed image constituted of a pixel array having the digital voltage value of a predetermined number of bits;
a movement coordinate calculating unit to perform a full search by overlapping a predetermined reference image with an entire area of the current preprocessed image to generate a first motion vector coordinate value, to perform a partial search with respect to the a certain coordinate value corresponding to a predetermined direction determining coefficient to generate a second motion vector coordinate value, to output one of the first and second motion vector coordinate values as a final motion vector coordinate value, and to generate a direction determining coefficient of a future preprocessed image according to a history of the final motion vector coordinate value; and
an interface unit to accumulate the final motion vector coordinate value inputted from the movement coordinate calculating unit for a predetermined period of time, and to output the accumulated coordinate value to an external apparatus.

2. The optical sensing apparatus of claim 1, wherein the movement coordinate calculating unit comprises:
an image comparing unit to perform a full search with respect to an entire area of the current preprocessed image to generate a first motion vector coordinate value, and to perform a partial search with respect to the a certain area corresponding to a predetermined direction determining coefficient to generate a second motion vector coordinate value; and
a motion vector unit to compare the first and second motion vector coordinate values with each other with respect to a predetermined number of consecutive frames or fields for a predetermined times to determine an error, to generate the second motion vector coordinate value as the final motion vector coordinate value when the error is not detected, to generate the first motion vector coordinate value as the final motion vector coordinate value when the error is detected, and to generate the direction determining coefficient of the future preprocessed image according to a history of the final motion vector coordinate value.

3. The optical sensing apparatus of claim 2, wherein the image comparing unit comprises:
an X axis image comparing member to generate an X axis coordinate value of the first motion vector coordinate value by performing the full search with respect to an entire area of X axis coordinates of the current preprocessed image, and to generate another X axis coordinate value of the second motion vector coordinate value by performing the partial search with respect to certain coordinate values corresponding to a predetermined X axis direction determining coefficient; and
a Y axis image comparing member to generate a Y axis coordinate value of the first motion vector coordinate value by performing the full search with respect to an entire area of Y axis coordinates of the current preprocessed image, and to generate another Y axis coordinate value of the second motion vector coordinate value by performing the partial search with respect to certain coordinate values corresponding to a predetermined Y axis direction determining coefficient.

4. The optical sensing apparatus of claim 3, wherein the X axis image comparing member performs the partial search with respect to a right side coordinate values of the X axis coordinate values including the origin when the X axis direction determining coefficient is positive (+), performs the partial search with respect to a left side coordinate values of the X axis coordinate values including the origin when the X axis direction determining coefficient is negative (−), and performs the full search with respect to the X axis coordinate values when the X axis direction determining coefficient is a default signal, to generate an X axis coordinate value of the second motion vector coordinate value.

5. The optical sensing apparatus of claim 3, wherein the Y axis image comparing member performs the partial search with respect to an upper side coordinate values of the Y axis coordinate values including the origin when the Y axis direction determining coefficient is positive (+), performs the partial search with respect to a lower side coordinate values of the Y axis coordinate values including the origin when the Y axis direction determining coefficient is negative (−), and performs the full search with respect to the Y axis coordinate values when the Y axis direction determining coefficient is a default signal, to generate a Y axis coordinate value of the second motion vector coordinate value.

6. The optical sensing apparatus of claim 2, wherein the motion vector unit comprises:
an error detecting member to compare the first and second motion vector coordinate values with each other in a unit of frame, and to generate an error signal when the first and second motion vector coordinate values are different from each other in a predetermined number of frames;
a motion vector calculating member to output the second motion vector coordinate value as the final motion vector coordinate value when the error signal is not inputted, and to output the first motion vector coordinate value as the final motion vector coordinate value when the error signal is inputted; and
a direction setting member to output a predetermined direction determining coefficient according to a history of the motion vector coordinate value with respect to a past preprocessed image and a direction determining coefficient of the future preprocessed image generated according to a history of the final motion vector coordinate value inputted from the motion vector calculating member, to the comparing unit.

7. The optical sensing apparatus of claim 6, wherein the motion vector calculating member comprises:
an X axis direction setting member having an X axis direction counting element to accumulate the number of times corresponding to the direction of the X axis coordinate value of the final motion vector coordinate value inputted from the motion vector calculating member in every frame, and having an X axis direction setting element to generate the X axis direction determining coefficient with respect to the future preprocessed image by analyzing the history of a direction of the X axis coordinate value; and
a Y axis direction setting member having a Y axis direction counting element to accumulate the number of times corresponding to the direction of the Y axis coordinate value of the final motion vector coordinate value inputted from the motion vector calculating member in every frame, and having a Y axis direction setting element to generate the Y axis direction determining coefficient with respect to the future preprocessed image by analyzing the history of a direction of the Y axis coordinate value.

8. The optical sensing apparatus of claim 6, wherein the X axis direction setting element generates a (+) direction determining coefficient when a direction history with respect to the X axis coordinate value of the final motion vector coordinate value shows a right side coordinate value with respect to the X axis coordinates, a (−) direction determining coefficient when the direction history with respect to the X axis coordinate value of the final motion vector coordinate value shows a left side coordinate value with respect to the X axis coordinates, and a default signal when the direction history with respect to the X axis coordinate value of the final motion vector coordinate value does not show any particular directional characteristic.

9. The optical sensing apparatus of claim 6, wherein the Y axis direction setting element generates a (+) direction determining coefficient when a direction history with respect to the Y axis coordinate value of the final motion vector coordinate value shows an upper side coordinate value with respect to the Y axis coordinates, a (−) direction determining coefficient when the direction history with respect to the Y axis coordinate value of the final motion vector coordinate value shows a lower side coordinate value with respect to the Y axis coordinates, and a default signal when the direction history with respect to the Y axis coordinate value of the final motion vector coordinate value does not show any particular directional characteristic.

10. An optical sensing apparatus to navigate a position, comprising:
an image pixel array having a plurality of pixels to convert light energy into an analog voltage value;
an A/D converter unit to the analog voltage value received from respective pixel into a digital voltage value;
a preprocessing unit to preprocess the digital voltage value to generate a current preprocessed image constituted of a pixel array having the digital voltage value of a predetermined number of bits;
a movement coordinate calculating unit to perform a full search by overlapping a predetermined reference image with an entire area of the current preprocessed image to generate a first motion vector coordinate value, to perform a partial search with respect to the a certain coordinate value corresponding to a predetermined speed determining coefficient to generate a second motion vector coordinate value, to output one of the first and second motion vector coordinate values as a final motion vector coordinate value, and to generate a speed determining coefficient of a future preprocessed image according to a history of the final motion vector coordinate value; and
an interface unit to accumulate the final motion vector coordinate value inputted from the movement coordinate calculating unit for a predetermined period of time, and to output the accumulated coordinate value to an external apparatus.

11. The optical sensing apparatus of claim 10, wherein the movement coordinate calculating unit comprises:
an image comparing unit to perform a full search with respect to an entire area of the current preprocessed image to generate a first motion vector coordinate value, and to perform a partial search with respect to the a certain area corresponding to a predetermined speed determining coefficient to generate a second motion vector coordinate value; and
a motion vector unit to compare the first and second motion vector coordinate values with each other with respect to a predetermined number of consecutive frames or fields for a predetermined times to determine an error, to generate the second motion vector coordinate value as the final motion vector coordinate value when the error is not detected, to generate the first motion vector coordinate value as the final motion vector coordinate value when the error is detected, and to generate the speed determining coefficient of the future preprocessed image according to a history of the final motion vector coordinate value.

12. The optical sensing apparatus of claim 11, wherein the image comparing unit comprises:
an X axis image comparing member to generate an X axis coordinate value of the first motion vector coordinate value by performing the full search with respect to an entire area of X axis coordinates of the current preprocessed image, and to generate another X axis coordinate value of the second motion vector coordinate value by performing the partial search with respect to certain coordinate values corresponding to a predetermined X axis speed determining coefficient; and
a Y axis image comparing member to generate a Y axis coordinate value of the first motion vector coordinate value by performing the full search with respect to an entire area of Y axis coordinates of the current preprocessed image, and to generate another Y axis coordinate value of the second motion vector coordinate value by performing the partial search with respect to certain coordinate values corresponding to a predetermined Y axis speed determining coefficient.

13. The optical sensing apparatus of claim 14, wherein the X axis image comparing member performs the partial search with respect to outside coordinate values of the X axis coordinate values including the origin when the X axis direction determining coefficient is a high speed determining coefficient, performs the partial search with respect to inside coordinate values of the X axis coordinate values including the origin when the X axis speed determining coefficient is a low speed determining coefficient, performs the partial search with respect to middle coordinate values of the X axis coordinate values including the origin when the X axis speed determining coefficient is a low speed determining coefficient, and performs the full search with respect to the X axis coordinate values when the X axis speed determining coefficient is a default signal, to generate an X axis coordinate value of the second motion vector coordinate value.

14. The optical sensing apparatus of claim 12, wherein the Y axis image comparing member performs the partial search with respect to upper side coordinate values of the Y axis coordinate values including the origin when the Y axis speed determining coefficient is a high speed determining coefficient, performs the partial search with respect to lower side coordinate values of the Y axis coordinate values including the origin when the Y axis speed determining coefficient is a low speed determining coefficient, performs the partial search with respect to middle coordinate values of the Y axis coordinate values including the origin when the Y axis speed determining coefficient is a low speed determining coefficient, and performs the full search with respect to the Y axis coordinate values when the Y axis speed determining coefficient is a default signal, to generate a Y axis coordinate value of the second motion vector coordinate value.

15. The optical sensing apparatus of claim 11, wherein the motion vector unit comprises:
an error detecting member to compare the first and second motion vector coordinate values with each other in a unit of frame, and to generate an error signal when the first and second motion vector coordinate values are different from each other in a predetermined number of frames;
a motion vector calculating member to output the second motion vector coordinate value as the final motion vector coordinate value when the error signal is not inputted, and to output the first motion vector coordinate value as the final motion vector coordinate value when the error signal is inputted; and
a speed setting member to output a predetermined speed determining coefficient according to a history of the motion vector coordinate value with respect to a past preprocessed image and a speed determining coefficient of the future preprocessed image generated according to a history of the final motion vector coordinate value inputted from the motion vector calculating member, to the comparing unit.

16. The optical sensing apparatus of claim 15, wherein the motion vector calculating member comprises:
an X axis speed setting member having an X axis direction counting element to accumulate the number of times corresponding to the direction of the X axis coordinate value of the final motion vector coordinate value inputted from the motion vector calculating member in every frame, and having an X axis speed setting element to generate the X axis sped determining coefficient with respect to the future preprocessed image by-analyzing the history of-a speed of the X axis coordinate value; and
a Y axis speed setting member having a Y axis speed counting element to accumulate the number of times corresponding to a speed of the Y axis coordinate value of the final motion vector coordinate value inputted from the motion vector calculating member in every frame, and having a Y axis speed setting element to generate the Y axis speed determining coefficient with respect to the future preprocessed image by analyzing the history of the speed of the Y axis coordinate value.

17. The optical sensing apparatus of claim 16, wherein the X axis speed setting element generates a high speed determining coefficient when a speed history with respect to the X axis coordinate value of the final motion vector coordinate value shows an outside coordinate value with respect to the X axis coordinates, a low speed determining coefficient when the speed history with respect to the X axis coordinate value of the final motion vector coordinate value shows an inside coordinate value with respect to the X axis coordinates, a middle speed determining coefficient when the speed history with respect to the X axis coordinate value of the final motion vector coordinate value shows a middle coordinate value with respect to the X axis coordinates, and a default signal when the speed history with respect to the X axis coordinate value of the final motion vector coordinate value does not show any particular speed characteristic.

18. The optical sensing apparatus of claim 16, wherein the Y axis speed setting element generates a high speed determining coefficient when a speed history with respect to the Y axis coordinate value of the final motion vector coordinate value shows an upper side coordinate value with respect to the Y axis coordinates, a low speed determining coefficient when the speed history with respect to the Y axis coordinate value of the final motion vector coordinate value shows an lower side coordinate value with respect to the Y axis coordinates, a middle speed determining coefficient when the speed history with respect to the Y axis coordinate value of the final motion vector coordinate value shows a middle coordinate value with respect to the Y axis coordinates, and a default signal when the speed history with respect to the Y axis coordinate value of the final motion vector coordinate value does not show any particular speed characteristic.

19. An optical sensing apparatus to navigate a position, comprising:
an image pixel array having a plurality of pixels to convert light energy into an analog voltage value;
an A/D converter unit to the analog voltage value received from respective pixel into a digital voltage value;
a preprocessing unit to preprocess the digital voltage value to generate a current preprocessed image constituted of a pixel array having the digital voltage value of a predetermined number of bits;
a movement coordinate calculating unit to perform a full search by overlapping a predetermined reference image with an entire area of the current preprocessed image to generate a first motion vector coordinate value, to perform a partial search with respect to the a certain coordinate value corresponding to a predetermined direction determining coefficient and a predetermined speed determining coefficient to generate a second motion vector coordinate value, to output one of the first and second motion vector coordinate values as a final motion vector coordinate value, and to generate a direction determining coefficient and a speed determining coefficient of a future preprocessed image according to a history of the final motion vector coordinate value; and
an interface unit to accumulate the final motion vector coordinate value inputted from the movement coordinate calculating unit for a predetermined period of time, and to output the accumulated coordinate value to an external apparatus.

20. The optical sensing apparatus of claim 19, wherein the movement coordinate calculating unit comprises:
an image comparing unit to perform a full search with respect to an entire area of the current preprocessed image to generate a first motion vector coordinate value, and to perform a partial search with respect to the a certain area corresponding to the predetermined direction determining coefficient and the predetermined speed determining coefficient to generate a second motion vector coordinate value; and
a motion vector unit to compare the first and second motion vector coordinate values with each other with respect to a predetermined number of consecutive frames or fields for a predetermined times to determine an error, to generate the second motion vector coordinate value as the final motion vector coordinate value when the error is not detected, to generate the first motion vector coordinate value as the final motion vector coordinate value when the error is detected, and to generate the direction determining coefficient and the speed determining coefficient of the future preprocessed image according to a history of the final motion vector coordinate value.

21. The optical sensing apparatus of claim 20, wherein the image comparing unit comprises:
an X axis image comparing member to generate an X axis coordinate value of the first motion vector coordinate value by performing the full search with respect to an entire area of X axis coordinates of the current preprocessed image, and to generate another X axis coordinate value of the second motion vector coordinate value by performing the partial search with respect to certain coordinate values corresponding to a predetermined X axis direction determining coefficient and a predetermined X axis speed determining coefficient; and
a Y axis image comparing member to generate a Y axis coordinate value of the first motion vector coordinate value by performing the full search with respect to an entire area of Y axis coordinates of the current preprocessed image, and to generate another Y axis coordinate value of the second motion vector coordinate value by performing the partial search with respect to certain coordinate values corresponding to a predetermined Y axis direction determining coefficient and a predetermined Y axis speed determining coefficient.

22. The optical sensing apparatus of claim 21, wherein:
when the X axis direction determining coefficient is a (+) direction determining coefficient, the X axis image comparing member performs the partial search with respect to right side and outside coordinate values of the X axis coordinate values including the origin when the X axis direction determining coefficient is a high speed determining coefficient, performs the partial search with respect to right side and inside coordinate values of the X axis coordinate values including the origin when the X axis speed determining coefficient is a low speed determining coefficient, performs the partial search with respect to right side and middle coordinate values of the X axis coordinate values including the origin when the X axis speed determining coefficient is a low speed determining coefficient, and performs the partial search with respect to right side coordinate values of the X axis coordinate values including the origin when the X axis speed determining coefficient is a default signal, to generate an X axis coordinate value of the second motion vector coordinate value, and
when the X axis direction determining coefficient is a (−) direction determining coefficient, the X axis image comparing member performs the partial search with respect to left side and outside coordinate values of the X axis coordinate values including the origin when the X axis direction determining coefficient is a high speed determining coefficient, performs the partial search with respect to left side and inside coordinate values of the X axis coordinate values including the origin when the X axis speed determining coefficient is a low speed determining coefficient, performs the partial search with respect to left side and middle coordinate values of the X axis coordinate values including the origin when the X axis speed determining coefficient is a low speed determining coefficient, and performs the partial search with respect to the left side coordinate values of the X axis coordinate values including the origin when the X axis speed determining coefficient is a default signal, to generate an X axis coordinate value of the second motion vector coordinate value.

23. The optical sensing apparatus of claim 21, wherein:
when the Y axis direction determining coefficient is a (+) direction determining coefficient, the Y axis image comparing member performs the partial search with respect to upper side and outside coordinate values of the Y axis coordinate values including the origin when the Y axis speed determining coefficient is a high speed determining coefficient, performs the partial search with respect to upper side and inside coordinate values of the Y axis coordinate values including the origin when the Y axis speed determining coefficient is a low speed determining coefficient, performs the partial search with respect to upper side and middle side coordinate values of the Y axis coordinate values including the origin when the Y axis speed determining coefficient is a low speed determining coefficient, and performs the partial search with respect to the upper side coordinate values of the Y axis coordinate values including the origin when the Y axis speed determining coefficient is a default signal, to generate a Y axis coordinate value of the second motion vector coordinate value, and
when the Y axis direction determining coefficient is a (−) direction determining coefficient, the Y axis image comparing member performs the partial search with respect to lower side and outside coordinate values of the Y axis coordinate values including the origin when the Y axis speed determining coefficient is a high speed determining coefficient, performs the partial search with respect to lower side and inside coordinate values of the Y axis coordinate values including the origin when the Y axis speed determining coefficient is a low speed determining coefficient, performs the partial search with respect to lower side and middle side coordinate values of the Y axis coordinate values including the origin when the Y axis speed determining coefficient is a low speed determining coefficient, and performs the partial search with respect to the lower side coordinate values of the Y axis coordinate values when the Y axis speed determining coefficient is a default signal, to generate a Y axis coordinate value of the second motion vector coordinate value.

24. The optical sensing apparatus of claim 20, wherein the motion vector unit comprises:
an error detecting member to compare the first and second motion vector coordinate values with each other in a unit of frame, and to generate an error signal when the first and second motion vector coordinate values are different from each other in a predetermined number of frames;
a motion vector calculating member to output the second motion vector coordinate value as the final motion vector coordinate value when the error signal is not inputted, and to output the first motion vector coordinate value as the final motion vector coordinate value when the error signal is inputted;
a direction setting member to output a predetermined direction determining coefficient according to a history of the motion vector coordinate value with respect to a past preprocessed image and a direction determining coefficient of the future preprocessed image generated according to a history of the final motion vector coordinate value inputted from the motion vector calculating member, to the comparing unit; and
a speed setting member to output a predetermined speed determining coefficient according to a history of the motion vector coordinate value with respect to a past preprocessed image and a speed determining coefficient of the future preprocessed image generated according to a history of the final motion vector coordinate value inputted from the motion vector calculating member, to the comparing unit.

25. The optical sensing apparatus of claim 24, wherein the motion vector calculating member comprises:
an X axis direction setting member having an X axis direction counting element to accumulate the number of times corresponding to the direction of the X axis coordinate value of the final motion vector coordinate value inputted from the motion vector calculating member in every frame, and having an X axis direction setting element to generate the X axis direction determining coefficient with respect to the future preprocessed image by analyzing the history of a direction of the X axis coordinate value; and
a Y axis direction setting member having a Y axis direction counting element to accumulate the number of times corresponding to _the direction of the Y axis coordinate value of the final motion vector coordinate value inputted from the motion vector calculating member in every frame, and having a Y axis direction setting element to generate the Y axis direction determining coefficient with respect to the future preprocessed image by analyzing the history of a direction of the Y axis coordinate value.

26. The optical sensing apparatus of claim 24, wherein the motion vector calculating member comprises:
an X axis speed setting member having an X axis direction counting element to accumulate the number of times corresponding to the direction of the X axis coordinate value of the final motion vector coordinate value inputted from the motion vector calculating member in every frame, and having an X axis speed setting element to generate the X axis sped determining coefficient with respect to the future preprocessed image by analyzing the history of a speed of the X axis coordinate value; and
a Y axis speed setting member having a Y axis speed counting element to accumulate the number of times corresponding to a speed of the Y axis coordinate value of the final motion vector coordinate value inputted from the motion vector calculating member in every frame, and having a Y axis speed setting element to generate the Y axis speed determining coefficient with respect to the future preprocessed image by analyzing the history of the speed of the Y axis coordinate value.

27. The optical sensing apparatus of claim 26,
wherein the X axis direction setting element generates a (+) direction determining coefficient when a direction history with respect to the X axis coordinate value of the final motion vector coordinate value shows a right side coordinate value with respect to the X axis coordinates, a (−) direction determining coefficient when the direction history with respect to the X axis coordinate value of the final motion vector coordinate value shows a left side coordinate value with respect to the X axis coordinates, and a default signal when the direction history with respect to the X axis coordinate value of the final motion vector coordinate value does not show any particular directional characteristic, and
wherein the Y axis direction setting element generates a (+) direction determining coefficient when a direction history with respect to the Y axis coordinate value of the final motion vector coordinate value shows an upper side coordinate value with respect to the Y axis coordinates, a (−) direction determining coefficient when the direction history with respect to the Y axis coordinate value of the final motion vector coordinate value shows a lower side coordinate value with respect to the Y axis coordinates, and a default signal when the direction history with respect to the Y axis coordinate value of the final motion vector coordinate value does not show any particular directional characteristic.

28. The optical sensing apparatus of claim 26,
wherein the X axis speed setting element generates a high speed determining coefficient when a speed history with respect to the X axis coordinate value of the final motion vector coordinate value shows an outside coordinate value with respect to the X axis coordinates, a low speed determining coefficient when the speed history with respect to the X axis coordinate value of the final motion vector coordinate value shows an inside coordinate value with respect to the X axis coordinates, a middle speed determining coefficient when the speed history with respect to the X axis coordinate value of the final motion vector coordinate value shows a middle coordinate value with respect to the X axis coordinates, and a default signal when the speed history with respect to the X axis coordinate value of the final motion vector coordinate value does not show any particular speed characteristic, and
wherein the Y axis speed setting element generates a high speed determining coefficient when a speed history with respect to the Y axis coordinate value of the final motion vector coordinate value shows an upper side coordinate value with respect to the Y axis coordinates, a low speed determining coefficient when the speed history with respect to the Y axis coordinate value of the final motion vector coordinate value shows an lower side coordinate value with respect to the Y axis coordinates, a middle speed determining coefficient when the speed history with respect to the Y axis coordinate value of the final motion vector coordinate value shows a middle coordinate value with respect to the Y axis coordinates, and a default signal when the speed history with respect to the Y axis coordinate value of the final motion vector coordinate value does not show any particular speed characteristic.

29. A method of navigating a position in an optical sensing apparatus, the-method comprising:
extracting a current preprocessed image and a current preprocessed center image in a movement coordinate calculating unit;
generating a first motion vector coordinate value by performing a full search with respect to the current preprocessed image in the movement coordinate calculating unit;
generating a second motion vector coordinate value by performing a partial search with respect to the current preprocessed image corresponding to a predetermined direction determined coefficient using a reference image in the movement coordinate calculating unit;
generating one of the first and second motion vector coordinate values as a final motion vector coordinate value in the movement coordinate calculating unit;
determining a direction determining coefficient of a future preprocessed image according to a history of the final motion vector coordinate value in the movement coordinate calculating unit; and
resetting the reference image according to an amount of movement of the final motion vector coordinate value in the movement coordinate calculating unit.

30. The method of claim 29, wherein the extracting of the current preprocessed image and the current preprocessed center image comprises:
converting light energy inputted from an image pixel array into an analog voltage value and outputting the analog voltage value to an A/D converter;
converting the analog voltage value received from respective pixels into a digital voltage value in the A/D converter and outputting the digital voltage value to a preprocessing unit;
sequentially receiving the digital voltage value of the respective pixels constituting a current image from the A/D converter in the preprocessing unit;
forming a basic image matrix having a target pixel to be converted into a predetermined bit value among the respective pixels of the current image sequentially inputted from the preprocessing unit, and adjacent pixels disposed adjacent the target pixel;
generating the current preprocessed image with respect to the current image by performing operations between columns, rows, and corresponding column and row of the pixels forming the basic image matrix in the preprocessing unit; and
extracting the current preprocessed center image having a predetermined pixel array from the current preprocessed image in the preprocessing unit.

31. The method of claim 29, wherein the generating of the first motion vector coordinate value comprises:
receiving the current preprocessed image from the preprocessing unit in a image comparing member of the movement coordinate calculating member;
performing the full search by overlapping the reference image with an entire area of the current preprocessed image in the image comparing unit;
generating the number of pixels having the same pixels as the references image among the overlapped current preprocessed image in the image comparing unit; and
generating a coordinate value having the maximum number of the pixels of the current preprocessed image which are identical to the pixels of the reference image in the image preprocessing unit.

32. The method of claim 29, the generating of the second motion vector coordinate value comprises:
receiving the direction determining coefficient from a motion vector unit in an image comparing unit; and
generating the second motion vector coordinate value by performing the partial search with respect to certain coordinate values corresponding to the direction determining coefficient.

33. The method of claim 32, wherein the generating of the second motion vector coordinate value comprises:
generating an X axis coordinate value of the second motion vector coordinate value by the partial search according to an X axis direction determining coefficient in the image comparing unit; and
generating a Y axis coordinate value of the second motion vector coordinate value by the partial search according to a Y axis direction determining coefficient in the image comparing unit, wherein the generating of the X axis coordinate value and the generating of the Y axis coordinate value are simultaneously performed.

34. The method of claim 33, wherein the generating of the X axis coordinate value of the second motion vector coordinate value comprises:
receiving the X axis direction determining coefficient from the motion vector unit in the image comparing unit;
determining a state of the X axis direction determining coefficient in the image comparing unit;
performing the partial search with respect to right side coordinate values of the X axis coordinate values including the origin in the image comparing unit when the X axis direction determining coefficient is a (+) direction determining coefficient;
generating the X axis coordinate value when the number of pixels of the right side coordinate values which are identical to the pixels of the reference image is greater than a reference value, as the final motion vector coordinate value;
performing the partial search with respect to left side coordinate values of the X axis coordinate values including the origin in the image comparing unit when the X axis direction determining coefficient is a (−) direction determining coefficient
generating the X axis coordinate value when the number of pixels of the left side coordinate values which are identical to the pixels of the reference image is greater than a reference value, as the final motion vector coordinate value;
performing the full search with respect to the X axis coordinate values in the image comparing unit when the X axis direction determining coefficient is a default signal; and
generating the X axis coordinate value when the number of pixels of the-X axis coordinate values which are identical to the pixels of the reference image is greater than a reference value, as the final motion vector coordinate value.

35. The method of claim 33, wherein the generating of the Y axis coordinate value of the second motion vector coordinate value comprises:
receiving the Y axis direction determining coefficient from the motion vector unit in the image comparing unit;
determining a state of the Y axis direction determining coefficient in the image comparing unit;
performing the partial search with respect to upper side coordinate values of the Y axis coordinate values including the origin in the image comparing unit when the Y axis direction determining coefficient is a (+) direction determining coefficient;
generating the Y axis coordinate value when the number of pixels of the upper side coordinate values which are identical to the pixels of the reference image is greater than a reference value, as the final motion vector coordinate value;
performing the partial search with respect to lower side coordinate values of the Y axis coordinate values including the origin in the image comparing unit when the Y axis direction determining coefficient is a (−) direction determining coefficient
generating the Y axis coordinate value when the number of pixels of the lower side coordinate values which are identical to the pixels of the reference image is greater than a reference value, as the final motion vector coordinate value;
performing the full search with respect to the Y axis coordinate values in the image comparing unit when the Y axis direction determining coefficient is a default signal; and
generating the Y axis coordinate value when the number of pixels of the Y axis coordinate values which are identical to the pixels of the reference image is greater than a reference value, as the final motion vector coordinate value.

36. The method of claim 29, wherein the generating of the final motion vector coordinate value comprises:
receiving the first motion vector coordinate value generated by performing the full search from the image comparing unit in an error detecting unit;
receiving the second motion vector coordinate value generated by performing the partial search corresponding to a predetermined direction determining coefficient form the image comparing unit in the error detecting unit;
comparing the first and second motion vector coordinate values with each other in every frame in the error detecting unit;
generating an error signal when the first and second vector coordinate values are not identical to each other in a predetermined number of consecutive frames or when a ratio of the number of frames in which the when the first and second vector coordinate values are not identical to each other, with a total number of frames is greater than a reference value;
generating the second motion vector coordinate value generated through the partial search in the motion vector calculating member as the final motion vector coordinate value when the error signal is not generated from the error detecting unit; and
generating the first motion vector coordinate value generated through the full search in the motion vector calculating member as the final motion vector coordinate value when the error signal is generated from the error detecting unit.

37. The method of claim 29, wherein the determining of the direction determining coefficient of the future preprocessed image comprises:
accumulating the number of times when a direction of the final motion vector coordinate value is inputted from a direction counting element of the motion vector calculating member in every frame;
analyzing a history with respect to the final motion vector coordinate value in the direction setting member; and
generating the direction determining coefficient with respect to the future preprocessed image according to the history in the direction setting member.

38. The method of claim 37, wherein the direction determining coefficient comprises an X axis direction determining coefficient to set an X axis moving direction, and a Y axis direction determining coefficient to set a Y axis moving direction.

39. The method of claim 38, wherein the X axis direction determining coefficient comprises a (+) direction determining coefficient to indicate that the future preprocessed image moves in the right direction of the coordinates, a (−) direction determining coefficient to indicate that the future preprocessed image moves in the left direction of the coordinates, and a default direction determining coefficient, and a default method.

40. The method of claim 39, wherein the X axis direction determining coefficient comprises a (+) direction determining a coefficient to indicate that the future preprocessed image moves in the upper direction of the coordinates, a (−) direction determining coefficient to indicate that the future preprocessed image moves in the lower direction of the coordinates, and a default direction determining coefficient, and a default mode.

41. The method of claim 29, wherein the generating of the reference image according to the amount of movement of the final motion vector coordinate value comprises:
receiving the final motion vector coordinate value feedback from the motion vector calculating member in the image comparing unit of the movement coordinate calculating member;
determining whether the amount of movement of the final motion vector coordinate value is zero;
maintaining the predetermined reference image of an X channel/Y channel reference member of the image comparing unit when the amount of movement of the final motion vector coordinate value is zero; and
setting the current preprocessed image as the predetermined reference image of the X channel/Y channel reference member of the image comparing unit when the amount of movement of the final motion vector coordinate value is not zero.

42. A method of navigating a position in an optical sensing apparatus, the method comprising:
extracting a current preprocessed image and a current preprocessed center image in a movement coordinate calculating member;
generating a first motion vector coordinate value by performing a full search with respect to the current preprocessed image in the movement coordinate calculating member;
generating a second motion vector coordinate value by performing a partial search with respect to the current preprocessed image corresponding to a predetermined speed determined coefficient in the movement coordinate calculating member;
generating one of the first and second motion vector coordinate values as a final motion vector coordinate value according to an error signal in the movement coordinate calculating member;
determining a speed determining coefficient of a future preprocessed image according to a history of the final motion vector coordinate value in the movement coordinate calculating member; and
generating a reference image according to an amount of movement of the final motion vector coordinate value in the movement coordinate calculating member.

43. The method of claim 42, the generating of the second motion vector coordinate value comprises:
receiving the speed determining coefficient from a motion vector unit in an image comparing unit; and
generating the second motion vector coordinate value by performing the partial search with respect to certain coordinate values corresponding to the speed determining coefficient.

44. The method of claim 43, wherein the generating of the second motion vector coordinate value comprises:
generating an X axis coordinate value of the second motion vector coordinate value by the partial search according to X axis coordinate values of an X axis speed determining coefficient inputted from a motion vector unit in the image comparing unit; and
generating a Y axis coordinate value of the second motion vector coordinate value by the partial search according to a Y axis speed determining coefficient in the image comparing unit, wherein the generating of the X axis coordinate value and the generating of the Y axis coordinate value are simultaneously performed.

45. The method of claim 44, wherein the generating of the X axis coordinate value of the second motion vector coordinate value comprises:
receiving the X axis speed determining coefficient from the motion vector unit in the image comparing unit;
determining a state of the X axis speed determining coefficient in the image comparing unit;
performing the partial search with respect to outside side coordinate values of the X axis coordinate values in the image comparing unit when the X axis speed determining coefficient is a high speed mode;
generating the X axis coordinate value when the number of pixels of the outside side coordinate values which are identical to the pixels of the reference image is greater than a reference value, as the final motion vector coordinate value;
performing the partial search with respect to inside side coordinate values of the X axis coordinate values in the image comparing unit when the X axis speed determining coefficient is a low speed mode;
generating the X axis coordinate value when the number of pixels of the inside side coordinate values which are identical to the pixels of the reference image is greater than a reference value, as the final motion vector coordinate value;
performing the full search with respect to the X axis coordinate values in the image comparing unit when the X axis speed determining coefficient is a default signal; and
generating the X axis coordinate value when the number of pixels of the X axis coordinate values which are identical to the pixels of the reference image is greater than a reference value, as the final motion vector coordinate value.

46. The method of claim 44, wherein the generating of the Y axis coordinate value of the second motion vector coordinate value comprises:
receiving the Y axis speed determining coefficient from the motion vector unit in the image comparing unit;
determining a state of the Y axis direction determining coefficient in the image comparing unit;
performing the partial search with respect to outside side coordinate values of the Y axis coordinate values in the image comparing unit when the Y axis speed determining coefficient is a high speed mode;
generating the Y axis coordinate value when the number of pixels of the outside side coordinate values which are identical to the pixels of the reference image is greater than a reference value, as the final motion vector coordinate value;
performing the partial search with respect to inside side coordinate values of the Y axis coordinate values in the image comparing unit when the Y axis speed determining coefficient is a low speed mode;
generating the Y axis coordinate value when the number of pixels of the inside side coordinate values which are identical to the pixels of the reference image is greater than a reference value, as the final motion vector coordinate value;
performing the full search with respect to the Y axis coordinate values in the image comparing unit when the Y axis speed determining coefficient is a default signal; and
generating the Y axis coordinate value when the number of pixels of the Y axis coordinate values which are identical to the pixels of the reference image is greater than a reference value, as the final motion vector coordinate value.

47. The method of claim 42, wherein the generating of the final motion vector coordinate value comprises:
receiving the first motion vector coordinate value generated by performing the full search from the image comparing unit in an error detecting unit;
receiving the second motion vector coordinate value generated by performing the partial search corresponding to a predetermined speed determining coefficient form the image comparing unit in the error detecting unit;
comparing the first and second motion vector coordinate values with each other in every frame in the error detecting unit;
generating an error signal when the first and second vector coordinate values are not identical to each other in a predetermined number of consecutive frames or when a ratio of the number of frames in which the when the first and second vector coordinate values are not identical to each other, with a total number of frames is greater than a reference value;
generating the second motion vector coordinate value generated through the partial search in the motion vector calculating member as the final motion vector coordinate value when the error signal is not generated from the error detecting unit; and
generating the first motion vector coordinate value generated through the full search in the motion vector calculating member as the final motion vector coordinate value when the error signal is generated from the error detecting unit.

48. The method of claim 42, wherein the determining of the speed determining coefficient of the future preprocessed image comprises:
accumulating the number of times when a direction of the final motion vector coordinate value is inputted from a speed counting element of the motion vector calculating member in every frame;
analyzing a history with respect to the final motion vector coordinate value in the direction setting member; and
generating the direction determining coefficient with respect to the future preprocessed image according to the history in the speed setting member.

49. The method of claim 48, wherein the speed determining coefficient comprises an X axis speed determining coefficient to set an X axis moving speed, and a Y axis speed determining coefficient to set a Y axis moving speed.

50. The method of claim 49, wherein the X axis speed determining coefficient comprises a high speed mode in which the current and future preprocessed images are maintained at a first speed, a low speed mode in which the current and future preprocessed images are maintained at a second predetermined speed lower than the first speed, a middle speed mode in which the current and future preprocessed images are maintained at a third speed between the first and second speeds, and a default mode in which the current and future preprocessed images are not maintained at a predetermined speed.

51. The method of claim 49, wherein the Y axis speed determining coefficient comprises a high speed mode in which the current and future preprocessed images are maintained at a first speed, a low speed mode in which the current and future preprocessed images are maintained at a second predetermined speed lower than the first speed, a middle speed mode in which the current and future preprocessed images are maintained at a third speed between the first and second speeds, and a default mode in which the current and future preprocessed images are not maintained at a predetermined speed.

52. A method of navigating a position in an optical sensing apparatus, the method comprising:
extracting a current preprocessed image and a current preprocessed center image in a movement coordinate calculating member;
generating a first motion vector coordinate value by performing a full search with respect to the current preprocessed image in the movement coordinate calculating member;
generating a second motion vector coordinate value by performing a partial search with respect to the current preprocessed image corresponding to predetermined direction and speed determined coefficients in the movement coordinate calculating member;
generating one of the first and second motion vector coordinate values as a final motion vector coordinate value in the movement coordinate calculating member;
determining direction and speed determining coefficients of a future preprocessed image according to a history of the final motion vector coordinate value in the movement coordinate calculating member; and
generating a reference image according to an amount of movement of the final motion vector coordinate value in the movement coordinate calculating member.

53. The method of claim 52, the generating of the second motion vector coordinate value comprises:
receiving the direction and speed determining coefficients from a motion vector unit in an image comparing unit; and
generating the second motion vector coordinate value by performing the partial search with respect to certain coordinate values corresponding to the direction and speed determining coefficients.

54. The method of claim 53, wherein the generating of the second motion vector coordinate value comprises:
generating an X axis coordinate value of the second motion vector coordinate value by the partial search according to X axis direction and speed determining coefficients in the image comparing unit; and
generating a Y axis coordinate value of the second motion vector coordinate value by the partial search according to Y axis direction and speed determining coefficients in the image comparing unit, wherein the generating of the X axis coordinate value and the generating of the Y axis coordinate value are simultaneously performed.

55. The method of claim 54, wherein the generating of the X axis coordinate value of the second motion vector coordinate value comprises:
performing the partial search with respect to the X axis coordinate values corresponding to the X axis direction determining coefficient and the X axis speed determining coefficient which is one of a high speed mode, a low speed mode, a middle speed mode, and a default mode, when the X axis direction determining coefficient is a (+) direction determining coefficient to indicate that the X axis direction determining coefficient moves in a right side of the coordinates;
performing the partial search with respect to the X axis coordinate values corresponding to the X axis direction determining coefficient and the X axis speed determining coefficient which is one of a high speed mode, a low speed mode, a middle speed mode, and a default mode, when the X axis direction determining coefficient is a (−) direction determining coefficient to indicate that the X axis direction determining coefficient moves in a left side of the coordinates; and
performing the full search with respect to the X axis coordinate values when the X axis direction determining coefficient is a default mode.

56. The method of claim 54, wherein the generating of the Y axis coordinate value of the second motion vector coordinate value comprises:
performing the partial search with respect to the Y axis coordinate values corresponding to a Y axis direction determining coefficient and the Y axis speed determining coefficient which is one of a high speed mode, a low speed mode, a middle speed mode, and a default mode, when the Y axis direction determining coefficient is a (+) direction determining coefficient to indicate that the Y axis direction determining coefficient moves in an upper side of the coordinates;
performing the partial search with respect to the Y axis coordinate values corresponding to the Y axis direction determining coefficient and the Y axis speed determining coefficient which is one of a high speed mode, a low speed mode, a middle speed mode, and a default mode, when the Y axis direction determining coefficient is a (−) direction determining coefficient to indicate that the X axis direction determining coefficient moves in a lower side of the coordinates; and
performing the full search with respect to the Y axis coordinate values when the Y axis direction determining coefficient is a default mode.

57. The method of claim 52, wherein the generating of the final motion vector coordinate value comprises:
receiving the first motion vector coordinate value generated by performing the full search from the image comparing unit in an error detecting unit;
receiving the second motion vector coordinate value generated by performing the partial search corresponding to predetermined direction and speed determining coefficient from the image comparing unit in the error detecting unit;
comparing the first and second motion vector coordinate values with each other in every frame in the error detecting unit;
generating an error signal when the first and second vector coordinate values are not identical to each other in a predetermined number of consecutive frames or when a ratio of the number of frames in which the when the first and second vector coordinate values are not identical to each other, with a total number of frames is greater than a reference value;
generating the second motion vector coordinate value generated through the partial search in the motion vector calculating member as the final motion vector coordinate value when the error signal is not generated from the error detecting unit; and
generating the first motion vector coordinate value generated through the full search in the motion vector calculating member as the final motion vector coordinate value when the error signal is generated from the error detecting unit.

58. The method of claim 52, wherein the determining of the direction and speed determining coefficients of the future preprocessed image comprises:
accumulating the number of times when a direction of the final motion vector coordinate value is inputted from direction and speed counting elements of the motion vector calculating member in every frame;
analyzing a history with respect to the final motion vector coordinate value in the direction and speed setting members; and
generating the direction and speed determining coefficients with respect to the future preprocessed image according to the history in the direction and speed setting members.

59. The method of claim 58, wherein the direction determining coefficient comprises an X axis direction determining coefficient to set an X axis moving direction, and a Y axis direction determining coefficient to set a Y axis moving direction.

60. The method of claim 59, wherein the X axis direction determining coefficient comprises a (+) direction determining coefficient to indicate that the future preprocessed image moves in the right direction of the coordinates, a (−) direction determining coefficient to indicate that the future preprocessed image moves in the left direction of the coordinates, and a default direction determining coefficient, and a default method.

61. The method of claim 59, wherein the X axis direction determining coefficient comprises a (+) direction determining a coefficient to indicate that the future preprocessed image moves in the upper direction of the coordinates, a (−) direction determining coefficient to indicate that the future preprocessed image moves in the lower direction of the coordinates, and a default direction determining coefficient, and a default mode.

62. The method of claim 58, wherein the speed determining coefficient comprises an X axis speed determining coefficient to set an X axis moving speed, and a Y axis speed determining coefficient to set a Y axis moving speed.

63. The method of claim 62, wherein the X axis speed determining coefficient comprises a high speed mode in which the current and future preprocessed images are maintained at a first speed, a low speed mode in which the current and future preprocessed images are maintained at a second predetermined speed lower than the first speed, a middle speed mode in which the current and future preprocessed images are maintained at a third speed between the first and second speeds, and a default mode in which the current and future preprocessed images are not maintained at a predetermined speed.

64. The method of claim 62, wherein the Y axis speed determining coefficient comprises a high speed mode in which the current and future preprocessed images are maintained at a first speed, a low speed mode in which the current and future preprocessed images are maintained at a second predetermined speed lower than the first speed, a middle speed mode in which the current and future preprocessed images are maintained at a third speed between the first and second speeds, and a default mode in which the current and future preprocessed images are not maintained at a predetermined speed.
